(19) United States
(12) Patent Application Publication
(10) Pub. No.: US 2017/0248118 A1
(43) Pub. Date: Aug. 31, 2017

(54) Novel Applications of the New Wind Power Formula, Novel Movements of Sails, and Novel Sail Turbines, plus Novel Propulsion Systems

(71) Applicant: Henry Ivers, Swampscott, MA (US)

(72) Inventor: Henry Ivers, Swampscott, MA (US)

(21) Appl. No.: 15/441,250

(22) Filed: Feb. 24, 2017

Related U.S. Application Data
(60) Provisional application No. 62/300,117, filed on Feb. 26, 2016.
(60) Provisional application No. 62/300,206, filed on Feb. 26, 2016.
(60) Provisional application No. 62/304,812, filed on Mar. 7, 2016.
(60) Provisional application No. 62/308,713, filed on Mar. 15, 2016.
(60) Provisional application No. 62/311,269, filed on Mar. 21, 2016.
(60) Provisional application No. 62/316,135, filed on Mar. 31, 2016.
(60) Provisional application No. 62/323,312, filed on Apr. 15, 2016.
(60) Provisional application No. 62/355,203, filed on Jun. 27, 2016.
(60) Provisional application No. 62/375,340, filed on Aug. 15, 2016.

(51) Int. Cl. F03D 3/06; F03D 9/25

(52) U.S. Cl. CPC F03D 3/061; F03D 9/25

(57) ABSTRACT

Wind Sail Turbines end the fossil fuel age and supply abundant, clean, and very inexpensive electricity (power). The new Wind Sail Turbines produce roughly 10-Fold to 50-Fold more power than existing wind turbines in the same wind path. This patent has the effect of replacing most of the science that is the basis of current Wind Science and current wind turbines. This patent changes the scientific understanding of how to effectively utilize wind and/or water flows to produce energy. Rotor blades, wings, and sails etc. are not airfoils working primarily from lift. These 3 devices are sails that work due to wind collisions. Therefore, sails are newly defined scientifically by the application of the New Wind Power Formula. This creates a New Wind Science because the 3 fundamental underpinnings of current Wind Science are disproved, 1) the current Wind Power Formula is disproved and nearly every input is changed, 2) the power in the wind is disproved and is determined to have twice the power as currently believed, and 3) lift as applied to sails (rotor blades, sails, and wings) is disproved. All Wind and/or Water Sail Turbines require sails to occupy the flow path versus small sails just spinning within the flow path to effectively utilize energy. Henry Wind Buster 1s and 2s, work with and against the wind. Henry Wind Busters 1s have a linear nature going more directly downwind and upwind. Henry Wind Buster 2s work with an against the wind but rotate around or partially rotate around an axis. Henry Wind Buster 3s are like industrial HAWT wind turbines, rotating perpendicular to the wind. The Water Propulsion Systems uses the novel movement of plates for propulsion.

### RELATED U.S. APPLICATION DATA

Nine Provisional patents: 62/300,117 filed Feb. 26, 2016, 62/300,206 filed Feb. 26, 2016, 62/304,812 filed Mar. 7, 2016, 62/308,713 filed Mar. 15, 2016, 62/311,629 filed Mar. 21, 2016, 62/316,135 filed Mar. 31, 2016, 62/323,312 filed Apr. 15, 2016, 62/355,203 filed Jun. 27, 2016, and, and 62/375,340 filed Aug. 15, 2016.

### CLAIM FOR THE EARLIEST DATE AND CLAIM FOR BENEFITS

This Utility patent claims the benefits of the earliest date of Feb. 26, 2016 and claims all possible benefits from all nine provisional patents in every way and on every level without exception and/or limitation.

### BACKGROUND OF INVENTION

### Defined Terms, Definitions, and Acronyms

The Sail Turbines are most often discussed in terms of wind. “Wind” is defined as air (any gas) flow but every device in this entire document whether described using the word, wind and/or water and/or fluid and/or wind flow and/or water flow and/or fluid flow is defined to always include the use of any of the devices with any gas and/or any gas flow and/or any solid and/or any solid flow and/or any semi-solid and/or any semi-solid flow, and/or any mix of varying states of matters and/or and any mix of material(s) whether any and/or all of the preceding are manmade and/or partially manmade and/or natural to include waves, tides etc. to include all movement of any matter in any state and/or any matter in any state that can be made and/or allowed and/or assisted to move without limitation. Generally, when harvesting energy, Sail Turbines would be utilizing energy from a flow but that flow could temporarily stop and then resume, so, technically Sail turbines may not always be operating in a flow and the Henry Propulsion System is not generally thought of causing thrust in a flow but that condition could often exist. This document claims the most reasonable interpretation of this entire document and associated materials without exception or limitation in context of this entire document and all reasonably associated material and knowledge without exception or limitation. “Power” and/or “energy” and/or electricity and/or force and/or any force is defined to include electricity and/or any other force and/or force and/or power, and/or energy produced, utilized, and/or observed. HWB 1s the acronym for Henry Wind Buster. Wind turbine can be mean current wind turbines or Wind Sail Turbines and it should be interpreted to be one or the other or both based on what makes the most sense. WTOP is made an acronym for Wind Turbine Operating Parts that are described in section, “Detailed Descriptions of Wind Turbines”. The acronym for the New Wind Power Formula is made as NWPF.

All Wind Sail Devices are called Turbines in this patent document. Wind Sail Turbines do not use rotor blades and use sails to utilize wind energy. Some Wind Sail Devices (Turbines) are not technically turbines since they lack primary rotary movement, so Turbines are defined to include all Sail Devices. Wind Sail Turbines are defined to be based on the application of the NWPF to the extent applicable and/or with the necessary adjustments based on the 3 types of Wind Sail Turbines newly invented in this patent, the HWB 1s, 2s, and 3s and when necessary modified to meet any and all the endless variations and/or sub-variations that any of these 3 designs can and will possess. Wherever it makes sense to add without exception or limitation within a sentence or at the end of the sentence, this document is meant to have “without exception or limitation” included without exception or limitation. Sails throughout this entire patent document can be one segment, or comprised of any number of segments made in any way, and sails can be in any number of rows. Sail(s) when talked of as louvered, this document defines louvered as 1 to any number of segments of sail and generally louvered sails being opened and/or closed, generally cause the same result as sails themselves being pivoted and/or rotated to accomplish the same general sail orientation in order to have sails catching wind and/or minimizing wind resistance and partial states of being opened and/or being closed which is the same can have many important functions for all HWBs and louvered sails can be designed in any way, with and without a frame surrounding the segments and/or with a partial frame around the segments but how the segments are held is important to how you expect the sail to act and/or for sails to act and/or interact in every way and/or on every level, so, all types of designs are included without limitation and a row of sail(s) can be referred to as a single sail but that sail could be segmented so that sail could be talked about as a sail and/or sails and/or a segmented sail and/or segmented sails and where that could mean more than 1 thing, the inventor has tried to be clear but has likely failed often to be clear, so, the inventor asks that the information from the entire document and associated material be considered and the most reasonable interpretation be made in context of everything without exception or limitation. Examples are generally using 2 rows. Sails are referred to as singular and/or plural and/or plural and singular, and this becomes difficult to always be accurate in since often you could be thinking of a sail or thinking of sails on a wind turbine or thinking of a sail or sails on more than 1 wind turbine but in the light of the information provided by this entire document and all associated material understanding what is meant should be quite clear and every relevant point as to operation and design is said likely multiple times throughout this document helping to clarify. Descriptions of sail(s) are made with the wind coming from the reader and heading towards the page or screen unless otherwise noted. Sail, and/or sails, and/or sail(s) are used sometimes without regard to strict interpretation as to singularity or plurality and should be interpreted in context to the overall operation of the Wind Sail Turbines or sail or sails discussed. Wherever “and”, “or”, and “and/or” is called for, “and/or” is most often used since it is seemed safest and easiest to the inventor at least at the time of this writing, and if errors exist due to this those are claimed corrected as other errors have been claimed to be interpreted correctly without exception or limitation. A low speed shaft may be called a main shaft, and/or axle, and/or axis. When something is said to be rotating around an axis, it is generally expected that the axis is also rotating but this is referred to as rotating around the low speed shaft, main shaft, axle, and/or axis. Rotor blades, wings, and sails are defined differently scientifically in this document. These 3 devices are believed to be airfoils benefiting primarily from lift, this is incorrect, they are all sails that primarily benefit from wind collisions. Sails therefore are newly defined scientifically as to operation, not by appearance but in how and why sails operate, based on the application of the New Wind Power Formula and the New Wind Science it creates versus the old, current Wind Power Formula and Current Wind Science. Generally, in patent law certain words may be defined to have specific meaning which the inventor would not know, so this patent defines, all undefined word(s) of this patent, to be reasonably defined and interpreted in the context of the entire document and all associated material, and with foremost consideration given to the inventor's intent and when applicable, common language interpretation and/or otherwise with the assumption of the inventor being unaware of any language issues and/or legal language issues and/or any legal issues that would work against the inventor's intent and this request is made with the reminder that the patent office encourages and is geared to facilitate inventors to be able to file patents reasonably on their own and although the inventor knows that this is not a warranty against legal issues, this document requests of any court that this document never suffer a legal, “got you”, and be interpreted in the spirit and intent of the inventor. The inventor has only a business background and is not an engineer, a teacher, a scientist, and/or with any formal technical background of any kind and all of these requests as to interpretation of word(s), and/or sentence(s), and/or paragraph(s) and/or section(s) are requested without exception or limitation.

### APPENDICES

Appendix A—Consists of multiple links to animations and to one video, that reviewers may wish to review to assist in visualizing the operation of the new Wind Sail Turbines. The video link is to Wind Sail Turbines' working prototypes. This video is very long, 4 hours and 45 minutes. In the first 16 minutes and 20 seconds, the operation and proof of power of the prototype(s) is demonstrated. Little is to be gained by watching the additional 4.5 hours of the video. The additional 4.5 hours contain some science errors. The errors relate to discussion of the squirting phenomenon and around the point in the video when 2 screws are shown in a representation of a sail. Around this point in the video, some inaccurate statements about how sails operate were made in and around that part of the video. A website, HenryWindBuster.com, can be visited to view these same links because there the links are active and 1 email will also be found at this website. I acknowledge that I understand that the USPTO may not consider the actual animations and/or video and/or email as part of this filing. However, a court may consider later the animations and/or video, and/or email as part of best evidence so with that in mind the inventor states as follows. The inventor will not change or alter these animations/video and email in the website. If anything, new is added to this website than a current date of that addition will always appear next to that addition. In this website, a copy of an email that will be sent approximately 1 day before the filing of this patent gives a good overview of the new science that may be helpful to understanding this patent. That email is found under the tab at the top right, Science Proof.

Appendix B—Consists of Reference Pages from the Royal Academy of Engineering. To locate from the internet, Google “wind power formula” and print the first 3 pages under www.raeng.org (Royal Academy of Engineering).

Appendix C—Internet information about Aermotor Windmill company's history, brochure about American Eagle Windmills, some photographs that appear when windmills are Googled, and information under windmills and wind turbines from Wikipedia and any material that indicates the current state of wind turbine science and/or current wind science. Everything was printed with its date showing and its origin from the internet during 2016 and very early 2017. The inventor has decided to leave Appendix C out of this document for practical filing reasons because Appendix C became very large since the inventor has added many more documents, comprised of a rough estimate of 300 to 400 pages and this information will be made available at the website, HenryWindBuster.com with the date when added to the website and the material is also dated when originally printed from the internet. This information will be titled Appendix C and/or the 2017 State of Wind Turbine Science and Wind Science and/or something similar that will have it readily locatable. This information is readily available on the internet to anyone and this information is gathered by the inventor to have a general record of the state of the believed wind science for wind turbines, sails, and/or wings.

Appendix D—4 pages of information taken from the internet with the pages' origins that generally show the parts of HAWTs

This patent is ends the fossil fuel age. Power and efficiencies numbers throughout this document are rough approximations. The application of the New Wind Power Formula changes the why and how wind power is calculated. The USPTO reviewers should view the animation/video of operating prototype HAWT (Horizontal Axis Wind Turbine) that produces roughly 1,000% more power than any other wind turbine. In this document, I will say that the prototype has produced 1,000% increased power. The actual produced power is roughly 600%, but 1,000% is used since it is quite likely with minor adjustments, 1,000% is the more approximate number. Producing 25% more power would be revolutionary, so if the number is 600%, 800% or 1,000% is irrelevant. In the first 16 minutes and 20 seconds of the Video, the power is proved. Viewing all the animations will speed the visualization of the detailed descriptions due to their novelty. The application of the New Wind Power Formula shows that rotor blades, sails, and wings are not airfoils working from lift but working due to wind collisions. The false use of lift is due to the power in the wind being determined at 50% of its correct power. The new water propulsion devices work by plate(s) thrusting water in a direction and then the plates orient to minimize resistance as returned to a pre-thrust position. The HAWT designs will produce greater power than current wind turbines in a rough range of 1000% to 2000% including capacity. Some patented wind turbine designs will produce roughly 5,000% greater power (there are two similar animations that have the word “platform” in their title that will show a type of wind turbine that will produce roughly 5,000% greater power. The New Wind Science created by the New Wind Power Formula changes the most fundamental understanding of the why and how wind turbines work, why sail boats sail, and why wings lift an airplane. The likely origin of the errors is explained further in this section. The old, current Wind Power Formula not only has the fundamental input of the power in the wind incorrect but the Wind Power Formula has every other fundamental input incorrect as well. The massive initial errors had to lead to other errors if uncorrected so the Wind Power Formula would produce mathematical calculated results that coincided with actual operational results. The input A (area) is overstated by 1667%. Another input, the Betz Limit (Law), states that only 59.3% of the power in the wind can be harnessed by a wind turbine is incorrect and non-applicable. Another input, the power in the wind is determined to be half of what it correct. The current wind turbine industry for example claims efficiencies of 35% to 52% for wind turbines. Using 45% efficiency for a more specific example, the wind turbine industry then falsely believes that the Betz Limit applies which limits a HAWT to maximally capturing only 59.3% of the wind power, so they tell their clients, that the practical operating efficiencies are (45%%÷59.3%)=75.9% of the possible wind that can be captured. Using the highest claim of 52% efficiency for an example and then assuming 5% additional losses that wind turbines suffer, the wind turbine industry believes that 57% of the wind power was captured. Dividing 57% by 59.3% (Betz Limit)=96.1% or nearly perfect efficiency. This is important to the value of the application of The New Wind Power Formula since it shows the wind turbine industry believes they already have nearly perfect Wind Turbines and shows how unlikely it would be for them to figure any of this out or decide to use giant sails when they believed that much smaller rotor blades were nearly perfectly doing the job by sweeping the area for energy. There are at least two existing types of wind turbine designs that use sails, farm type wind mills and Savonius Wind turbines. Both types of designs are believed less efficient than current industrial HAWTs. The farm type windmill (HAWT) has never had its potential enhanced due to several false beliefs and/or other factors. It is believed if you utilize more than 59.3% (Betz Limit) of the wind energy by a HAWT you lose efficiency. If in a windmill, sail structure or flaps on the downwind edges of the rotor blades' (sails) are used to aggressively catch more wind, because of the use of many rotor blades (sails), you create backpressure on the following rotor blade (sail) on its backside and/or on the structures themselves that will fight the wind power that you are primarily catching and this is unknown. So, blocking more wind to harness more wind power would not work out easily on farm type wind turbine designs and it would take special planning to capture maximum beneficial wind energy while minimizing backpressure. These poor outcomes working with farm type windmills would be attributed to the Betz Limit, reinforcing false beliefs in the application of the Betz Limit (Law). Trying fewer sails where backpressure is easier to mitigate would seem futile, not only because of violating the Betz Limit but other major stumbling blocks that would be present. A stumbling block to using fewer sails that would be larger or using larger sails generally would be that the larger sails would extend back towards the tower due to the sails' diagonal orientation to the wind. The larger the sails, the greater is this obstacle. Solving this, requires cantilevering the nacelle, so where the low speed shaft and the sails meet at the rotor (sail) hub is moved far enough away from the tower so the sails do not collide with the tower. This considerable effort would seem a futile waste since current Wind Science believes due to the Betz Limit nothing would be gained by more aggressively capturing wind and these types of windmills although on a better tract due to the use of sails versus rotor blades did not and would not progress. Another factor is tower construction, really the same obstacle as just prior but showed to be a bigger obstacle and/or divergence to using and/or contemplating using large sails because the towers for farm type windmills, were not only not cantilevered but were the opposite of the needed cantilevered design. The towers were mostly shaped like narrow pyramids, making the use of fewer large sails and/or just larger sails problematic because sails would even more readily collide with the towers. It is accepted if you want a large HAWT, you switch to industrially rotor blades HAWTs that are believed and claimed to be highly efficient. “Swept Area Theory” from the Wind Power Formula believes that rotor blades act as bigger than their physical size to utilize energy from the entire swept area and/or to benefit from lift. It is important to this patent to know that industrial HAWTs are believed and claimed to be highly efficient in utilizing wind energy. Many factors conspired to prevent the wind industry seeing the massive errors in the old current Wind Power Formula. Accidentally stumbling on much more powerful designs would require great work that is by scientific formula (Wind Power Formula) shown to be futile. Industrial producers sell perhaps 350 billion dollars of wind turbines per year claiming efficiencies of 70% to 90% when counting the Betz Limit. They are harnessing roughly 1.5% of the power in the wind. Without counting the Betz Limit, their efficiency claims are roughly 35% to 52% when they are roughly 1.5%. The New Wind Power Formula and its Proof was included in the ninth and possibly eighth provisional patent. Please rely on the latest science provided here when contradictory in respect to the New Wind Power Formula, its Proof and any science. The provisional patents used a belief from sailing theory, the squirting phenomenon. This is removed here and should be disregarded in any earlier filings and/or earlier documents and/or in the excluded portions of the video which are after the first 16 minutes and 20 seconds. The inventor sees a more probable explanation and either way it is of no importance to the patent. The squirting phenomenon will be welcomed if found to exist since it is helpful to wind turbines. The inventor made assertions regarding sails in his first video, in and around the point when the inventor placed two screws into a representation of a sail, that the inventor retracts and says simply that sails work from wind collisions. Any discussions of squirting phenomenon and any discussions of the operation of sails around the point of the use of the 2 screws in the video was contained in the excluded portion of the video which is the portion of the video after the first 16 minutes and 20 seconds.

The New Wind Power Formula and its proof follows. The one document that any reviewer would be aided by would be this: Google “wind power formula” and print the first 3 pages of the document www.raeng.org (Royal Academy of Engineering). (Appendix B) The work on this formula often refers to the first 2 pages of these 3 pages. This work is presented assuming a HAWT with its rotor (sail) blades perfectly diagonal to the wind. In real world, adjustment to inputs can be refined and need to be changed since there will always be design changes even in HAWT designs let alone the many other designs included here, but this certainly establishes what needs to be the components of a corrected New Wind Power Formula.

Wind Engineers, physicists, mathematicians, and all scientists that are reviewing this new corrected wind power formula will first want to read the subsequent proof that explains the enormous errors in the current wind power formula. Wind Engineers will not believe the old Wind Power Formula is incorrect because it predicted results that have worked reasonably. The reasons that this curiously happens becomes evident as one understands that massive errors were offsetting each other.

P=½pAv³C

### is the old Wind Power Formula.

P=½pA2v³C

is the correct New Wind Power formula. Simplified to

P=pAv³C

The three errors in the old formula are;

1) A (area) is not determined by swept area (πR²) nor is it determined by the rotor blades area but by the area of the wind path that the rotor blades occupy as viewed completely stationary which is only approximately 6% of the swept area (πR²).
2) The mass of wind that needs to be used in calculating wind energy is double the literal physical mass of wind in the collision and thus, is pA2v versus pAv in the old Wind Power Formula
3) New components need to be included in C (a constant) and the 1 main old component of C needs to be removed.

Due to the entirely new determinant of A (area), using the correct energy mass for calculating wind energy which is double the literal physical mass of the wind itself that strikes, and changes to the main components of C, the same approximate wind power for current wind turbines will be calculated by the corrected New Wind Power Formula but the efficiencies of current wind turbines will be shown to be roughly 4,700% less than the old Wind Power Formula indicated.

In the following proof section, I have proved that Betz Limit has no application in wind turbines and I have proved that A (area) is not the swept area of rotor blades (πR²) but is the area of the rotor blades not in respect to themselves but the area the rotor blades occupy in the wind path, with the rotor blades viewed as stationary. “Swept area” was perhaps the largest applied physics mistake in the history and cascaded out of a series of follies partly made if not fully made by Albert Betz in 1919. Albert Betz, a German Physicist, did not understand Frederick Lanchester's work of 4 years earlier, and likely took that work and published it, having Lanchester's work inconceivably distorted and named, the Betz Limit. Betz should have taken time to understand how the formula was derived. Had Betz understood Lanchester's work these errors would not have occurred. Albert Betz for reasons that you will understand after reading the following Proof section needed a number near 0.5 and the Betz Limit even though misapplied provided that approximate number (0.593).

The approximate A (area) industrial HAWT rotor blades occupy in the wind path is approximately 6% of the incorrect A. (area using swept area (πR²)). Using the incorrect A versus the correct A caused the single largest error ever in applied science, a 1667% of error (100%÷6%). This was because Betz assumed because Betz did not understand Lanchester's work, that rotor blades can sweep an area 16.67 times larger than the rotor blades occupy in the wind path. This 1667% error was largely offset by not having the mass of the wind for purposes of calculating energy yield at double wind's literal physical mass striking causing a 2-Fold error. This shows in the formula by using pAv when the correct input is pA2v for the energy yielding mass that was needed.

C (a constant) is a number that must make predicted results and actual results match up. C (a constant) is also terribly incorrect and we will cover the correct C (a constant) soon. Since C (a constant) is really a variable and is designed to be the number that will make the old Wind Power Formula have predictive results that match actual results, therefore this entire disaster is possible, since C (a constant) as you will soon see is nothing more than the efficiency factor, so the Wind Power Formula could predict power produced but C which is really just the efficiency is 4,700% overclaimed. C does not require being verified, it is simply taken as the efficiency and was just used to compare to other wind turbines that also had their efficiencies 4,700% overclaimed.

The original derived Newtonian Equation for calculating energy in the wind, that the wind power formula is based;

E=½mv²

Since wind is a mass flow over time, the formula introduced a mass flow equation to each side of the equation. E (energy), became P, which is (joules per second) and m (mass), became a mass flow (kg per second).

P=dE/dt=½v²dm/dt #1

A mass flow is given by:

dm/dt=pAdx/dt

and the rate of change per distance is given by:

dx/dt=v

we get:

dm/dt=pAv

Now substitute pAv in the equation marked #1 and you have:

P=½v²pAv

This simplifies to;

P=½pAv³

Now introduce C (a constant), which is really a variable and which is also always the efficiency of the wind turbine and this is the current Wind Power Formula;

P=½pAv³×C (a constant)

This pAv that was substituted for the m (mass) is broken down as follows. The p is density and A is the area and v is the (velocity). This third v calculated over 1 second is nothing more than a dimension of the volume of the m (mass) which is the m's (mass's) depth or length as you like expressed as v. So, this third v is not changing the original Newtonian formula because it is just a dimension of a mass flow that is supposed to allow for the calculation of a flowing mass. This is an error and pA2v needed to be used and not pAv.

Let us imagine that we have a section (depth or length as you prefer) of wind that has the wind's v (velocity) for 1 second as its depth (length) and for convenience let us use 12 meters per second as the v (velocity). Now please take a ruler and draw a line 12 inches long and make marks at every one-inch point along that line and if we scale every inch to be one meter, then we know that that entire 12-inch ruler length of wind (12 meters) will strike the stationary area in its path over 1 second since the wind is traveling 12 meters per second. When this 12-meter depth (length) of wind first strikes, it has 12 meters of mass and then the strikes reduce over the 1 second, the strikes has progressively less depth (length) and proportionately less mass and therefore, over each one twelfth of one second the depth (length) becomes 11 meters, 10 meters, 9 meters, 8 meters, 7 meters, 6 meters, 5 meters, 4 meters, 3 meters, 2 meters, 1 meter, and finally 0 meters and this also reduces the m (mass) proportionately as this occurs and this is precisely what is measured by mass flow creating one extra v which is a dimension that corresponds exactly with one dimension of the volume of the m (mass) since it is the depth (length) of the m (mass). This would have the average dimension for the volume of m (mass) over that one second be 6 meters versus 12 meters for the calculation of the m (mass) since this v is the dimension used to calculate m. (mass). However, this is not how wind works, which is not a mass flow but is a relative never ending mass flow suffering a complete stop where it strikes. During the 1 second in the last example when over each one twelfth of a second, the depth (length) and the corresponding m (mass) was reduced by a twelfth for each one twelfth of a second is not correct for wind. Harnessed wind is a continuous flow of m (mass) being fully stopped and as the reduction in depth (length) and correspondingly m (mass) was reducing as described above creating progressively less force due to less m (mass); this does not occur in wind because when wind crashes and stops when striking a rotor blade or a Wind Sail because wind at the identical velocity is coming in from behind it, filling the wind depth in completely, then these reductions in depth (length) and most importantly m. (mass) do not ever occur. This keeps the force always full, so when you start at 12 meters it never reduces at all over that second and to account for this you need to double v (2v).

We all know this intuitively since wind has continuous force. If we only had finite wind with a depth (length) of v that would last for 1 second only, then we would be fine with pAv and in that absurd example; we would not need pA2v. To describe the energy yielding mass of a continuous flowing mass to determine the collision mass, the correct mathematical description needs to be, pA2v. When a mass of wind strikes, the mass for purposes of calculating energy yield is double the literal physical mass because wind is constantly nourished and kept at full strength from its source and its source is easiest thought of as everything that is behind the point of impact at every instant.

The New Wind Power Formula is now;

P=½pA2v³×C (a constant)

Which simplifies to;

P=pAv³×C (a constant)

and C (a constant) is entirely incorrect in the old Wind Power Formula and the corrected new C (a constant) eliminates the 1 main component C (a constant) in the old Wind Power Formula because in the old Wind Power Formula, the Betz Limit accounted for the vast majority of C (a constant) and started C (a constant) at 0.593 (59.3%) and using and applying the Betz Limit to C (a constant) was completely absurd because the Betz Limit has zero application for wind turbines as covered in the Proof sub-section of the Background Section and discussing C (a constant) for conventional HAWTs, this is what C (a constant) should be comprised of, in the aggregate first, C (a constant) is simply the percentage of the total wind power utilized, as a percentage of 100% of the energy in the wind path energy, now it must be known that there are inherent difficulties in trying to capture maximum wind energy and as you capture wind by having the wind collide with a rotor blade and/or sail, wind power for any number of reasons hinders itself from being fully captured, there are probably a host of subtle and not so subtle factor(s), and for a few examples of those factors are; angles to the wind, different shapes, different sizes, different types, different numbers, different locations, and endless possible uses flaps of different size, shapes, locations, how does deflected wind and/or slowed wind and/or stopped wind interfere and/or benefit new wind capture at the point of collision and at different distance from the collision, and it may boil out to being very complex and/or relatively less complex and either way it may still be relatively easy to arrive at the near best or best techniques for wind capture without total understanding since just basic testing will provide more than sufficient results to allow for massively powerful wind turbines and fully understanding the subtle factors may take some time and at some point even just be diminishing returns and everything varies based on wind velocity and/or other factors known, to be known, and/or unknown but for purposes of this patent it is sufficient to know that perfect wind capture is not possible but pretty wind capture is available now just with the Application of the New Wind Power Formula using Wind sail Turbines that even without perfection of wind capture, today increases energy production in the same wind path to roughly 1,000% to 5,000% of current conventional HAWTs using rotor blades, ending the fossil fuel age, and conventional HAWTs using rotor blades and HWB 3s using sails suffer the same 2 huge losses that the C (a constant) in the current Wind Power Formula unimaginably misses, there is an initial loss of wind energy of roughly 50% due to the diagonal angle of the rotor blades and/or sails towards the wind and the next enormous loss is because the rotor blades and/or sails must rotate perpendicular to the wind which is an angle 90 degrees off the wind which is roughly 45% of a different angle than the directional force that the wind applies to the rotor blades and/or sails which is a wind force that becomes directed after wind collisions to be at an angle, 135 degrees off the wind because that is the rough angle that the rotor blades and/or sails are oriented to the wind and this results in another roughly 50% loss of the remaining wind energy, and then there are other losses that all wind turbines suffer for all other practical reasons and it is only in these other practical mechanical (gearing etc.), need to be built strong and durable, electrical etc. is the only minor area that C (a constant) is the same in the current Wind Power Formula and the New Wind Power Formula and now HWB 1s are designed very differently than conventional HAWTs and are the most powerful Wind Turbine ever by far because HWB 1s do not suffer these two roughly 50% loss that conventional HAWTs and HWB 3s suffer, but they are multi-fold lesser losses. All losses of wind energy have always been thought and designed so all losses should show up in C (a constant), and C (a constant) is meant to start and should start at 100% of all wind energy in the wind path and then, C (a constant) is reduced by the (% of loss of the 100% starting wind energy) caused by all the loss factors and C (a constant) therefore is supposed to be a wind turbines' efficiencies. The current C (a constant) in the current Wind Power Formula is almost 100% incorrect, it is literally insanity. In HAWTs the primary wind turbine of today, C (a constant) has its dramatically largest component by far as the Betz Limit of 59.3% which has zero application in the formula and the C (a constant), then totally fails to understand and use and account for the 2 massive primary losses of wind energy in conventional HAWTs, first is a loss due to sails and/or rotor blades diagonal angularity to the wind (roughly a 50% loss) and the second loss is due to the rotor blades and/or sails having to rotate in a direction that is roughly 45 degrees different that the directional force that the wind is applying to the rotor blades and/or sails resulting in the loss of the remaining wind energy by roughly another 50% loss. Albert Betz and/or whoever is responsible for developing this current Wind Power Formula has foisted an abomination of the natural laws onto this applied science of wind science by careless work and careless assumptions having made the development of relatively efficient wind turbines relatively non-existent to what is now available from the Application of the New Wind Power Formula and novel devices and novel sail movements of this patent and knowing that losses in a wind turbine are not caused by the Betz Limit is critical since when trying to capture wind aggressively negative results may happen and to look for other causes than believing the losses are due to the Betz Limit is critical and for one example of issues created by catching too much wind is that, backpressure on adjoining sails and/or sails' structures can occur and/or hindrances from captured expended or partially expended wind may interfere with the wind capture, this is just to point out to not to look to the Betz Limit that falsely tells you to not block too much wind or the efficiency decreases, this is not only false but destroys what is the goal, you want to block as much wind as possible in the most effective way that can be overall efficiently utilized and the secret to wind capture is rotor blades and Swept Area Theory and the Betz Limit are total fantasies and fundamentally what utilizing wind is blocking it as full possible consistent with whatever arrangement and/or means being used to convert and utilize the wind energy and Swept Area theory and the Betz Limit born from the delusion of Albert Betz with no understanding of wind and/or sailing has sent the entire science of wind science down a rat hole and to move on to another point, these 2 roughly 50% loses reduce C (a constant) to 0.25. C (a constant) is then C (a constant) reduced by other losses (need to build the wind turbine strong and durable, gearing and other mechanical losses etc.) and let us reduce C (a constant) to (0.2) and, so, you might think that this 20% efficiency would be correct in the New Wind Power Formula but that it is anything but the case, since we now know that C (a constant) is not simply the efficiency as it mistakenly thought to be in the old Wind Power Formula because remember, that we have proved only 6% of the wind path A (Area) is being utilized by the rotor blades versus the 100% of the wind path A (Area) that has been believed to be utilized, so we need to take 100%÷6%=16.67 and we now know that the old Wind Power Formula thought they were utilizing 16.67 times more of the wind path than is the reality of what was being utilized, so we need to take the 20% and divide it by the 16.67 and this equates to 20%÷16.67=1.2% and this is 1.2% efficiency is the correct efficiency for current wind turbines and earlier I had said current Wind Turbines' efficiencies were 1.5%, that is simply because I did not reduce the 25% above by the 5% for general losses to 20% and if the inventor simply used the 25% without an adjustment and divided it by 16.67, it comes out to precisely 1.5% and if the inventor had used 1.2% efficiencies, wind turbine companies are overstating efficiencies by 5903% which is 59.03-Fold (70.83%÷1.2%) and to the extent that there are any errors that comprise the NWPF, claim is still made to the correct and surviving parts of the remaining applications of the NWPF without limitation and the claim for the application of the NWPF is in any way without exception or limitation and for the application of the NWPF improving the development and/or use of wind turbines, sailboats, and wings since now it is known that these 3 devices work from wind collisions and not lift and stand to therefore all greatly benefit from the application of the NWPF and is part of the application of the NWPF and is included without exception or limitation.

All the science in this Utility patent where it conflicts with earlier science from Provisional patents or any document distributed earlier than the Utility patent, this science here is to be the final science beliefs and scientific explanations of the inventor. I have defined C differently in my provisional patents and this C (a constant) defined here is the correct and final C. In earlier work including any earlier Provisional patent, I have spoken of a squirting phenomenon that came from sailing theory used to explain why sailboats and iceboats can sail faster than the wind and applied it to wind turbines. I have moved away from this. Sail boats and ice boats can sail faster than the wind, not because lateral forces are squirted forward but the great speed is due to a low resistance path that is easily seen in the case of ice boats that use ice blades. The great speed is due to a set-up of the sail(s) where due to the sails angularity to the wind, the sail wants to go much faster than the wind since the sails are running away from the wind very sideways, so it allows for a set up for great speed to run away effectively. In the ice boat, the ice blade provides needed resistance for the ice boat to not slip too much sideways but allows the ice boat to race forward with little resistance. Specialized sail boats can do the same, not with the same great speed of ice boats with their ice blades but still much faster sailing than the speed of the wind. Boats obtain great speed ironically as heading nearly into the wind. It is very likely not that lateral forces being unexplainably squirted forward, causing speeds of 5 to 7 times the wind speed in the case of ice boats, it is the speed the boat wants to go because the sails want to run very fast to run away from the wind. It is wondrous that these fastest speeds occur when heading nearly into the wind.

A side issue is Current Wind Turbines as they have been made larger have claimed higher efficiency. As altitude is doubled, wind velocity increases by roughly 10%. If calculations are based on simple mean wind speeds, this would cause inaccuracy in determining the higher efficiencies of ever larger wind turbines. V (velocity) is exponential in the calculations, v³, so the claimed higher efficiencies without careful attention to the benefit that height brings could be misleading.

Betz Limit is by far the largest component of C (a constant) in the old Wind Power Formula and is completely incorrect but since this goes against the wind engineer's bible as to Wind Power Calculations, the author submits this long lengthy explanation of why the Betz Limit does not apply. The author submits that even if one is not convinced by the end of this section that the Betz Limit does not apply, this will have no effect on your conclusions if you conclude the much larger error discussed after the error of the Betz Limit exists. The acceptance of the second error which is much easier to analyze and only involves the application of a Newtonian Formula, if accepted makes the first error involving the application of the Betz Limit totally irrelevant making the use of the Betz Limit completely inapplicable to wind turbines. So even if you continue to believe Betz Limit could apply to a wind turbine if you accept the second error to do with “Swept Area” than Betz Limit cannot apply.

The author first disproves the Betz Law (Limit) since it lays the groundwork for understanding all the contributing factors that led to the most massive errors in an applied science ever. The author also points out that from the authors perspective and his purpose to show the superiority of Wind Sail Turbines, believing that Betz Limit applies to current wind turbines gives Wind Sail Turbines even greater value since Wind Sail Turbines are clearly not limited by it. So, the author gains nothing by disproving the application of Betz Limit but if this junk science is in any part allowed to stand then it will no doubt lead to more bad science and may be a distraction to the entirely new Wind Sail Turbines and New Wind Science that produce roughly 10 to 50 times more power than current wind turbines. The scale and scope of the errors will be eventually viewed as the largest set of scientific mistakes of all time and even more surprisingly has been the ability of these tragic mistakes to persist for over 9 decades undetected.

The application of the Betz Limit creates a nearly 2-Fold error by believing wind turbines can only harness 59.3% of the wind. The Betz Limit along with other inefficiencies show up in C (a constant) but Betz is by far the largest component in C (a constant) in the old Wind Power Formula which is usually in a typical range of 0.35 to 0.5. The other inefficiencies that reduced C (a constant) to 0.35 to 0.5 are the need for strength and durability and other mechanical and electrical losses etc. The erroneous application of the Betz Limit made wind engineers believe that only about 59.3% of the wind could ever be harnessed by a wind turbine before the other losses were applied reducing the 0.593 to the rough range of 0.35 to 0.5.

The second error is a vastly larger error of applying “Swept Area Theory” to a Newtonian Formula. This error is proved here to be perhaps the largest single applied science error ever applied in large scale real world operating systems, that being 10s of thousands of wind turbines. This second error has 2 components, first is a 16.67-Fold error due to believing wind turbine rotor blades are utilizing energy from the entire area the rotor blades sweep (rotate within) rather than based solely on the area the rotor blades occupy in the wind path which is roughly 6% of the entire area (“Swept Area”) (1.00%÷6%=16.67) and then this error of 16.67-Fold needs to be doubled (2) because the diagonal angularity of rotor blades into the wind leads to a further loss of roughly half (50%) of the wind force.

This makes the error 33.34-Fold. So, wind turbine engineers are utilizing 3% (1 divide by 33.34) of the wind energy when they believed it was 100%. Now, of this roughly 3% of the captured wind power, there is a further loss since the directional force that the rotor blades (sails) want to go is diagonal. (135-degrees off the wind) and the HAWT wind turbine rotor blades (sails) are made to rotate perpendicular to the wind (90-degrees off the wind), and this roughly 45-degree differential in the directional force and the allowed rotational direction causes another roughly 50% loss of energy, reducing this 3% to 1.5%. It is not easy to explain why this loss is roughly 50%, other than to oversimplify and to say that half the force is pushing backwards and half the force is pushing sideways and 50% is the roughly expected energy that is utilized. These 2, roughly 50% losses may vary somewhat based on many factors but their use puts us in a roughly accurate range.

Wind turbine companies claim 35% to 52% efficiencies. So, if you divide these claims by the roughly 1.5% actual efficiency, you see how the inventor arrives at stating the wind industries' overclaim of efficiencies of 2333% to 3467%. Now, if you count the fact which is only right to count that the wind industry further incorrectly claims that only 59.3% of the wind can ever be captured by a HAWT wind turbine due the misapplied Betz Limit, then the wind industry is overclaiming efficiencies by (2333%÷0.593) to (3467%÷0.593) which equals 3934% to 5847% overclaim of efficiencies.

The inventor by applying the New Wind Power Formula knows to use sails to try to catch 1.00% of the wind path versus the 6% of the wind the rotor blades catch in HAWTs. Sails as earlier discussed have inherent difficulties achieving near perfect efficiencies. Beyond that, sails in the newly invented HAWT Wind Sails Turbines still lose about 50% of that 100% wind capture (it is less than 100% due to inherent difficulties in wind utilization) due to using sails diagonally into the wind (135-degrees off the wind). Of this roughly 50% utilized wind energy about roughly 50% is lost again due to the rotation of the sails being different than the angle the wind is pushing the sails. This leaves us with 25% of wind capture. Of this roughly 25% wind energy remaining, we know there is less since you can never initially start with utilizing 1.00% of the wind due to inherent difficulties which very simply described is that as you try to capture the wind by effectively blocking the wind with a sail, the wind you capture partially blocks and/or inhibits (hinders) subsequent complete wind capture. This results in losses that we do not attempt to quantify knowing that these inherent difficulties in attempting near perfect wind capture will vary on endless factors along with all the other mechanical and electrical etc. which are all accounted for in C (a constant) in the New Wind Power Formula. The inventor has accomplished 9% efficiency with a HAWT and believes near or around 15% may be possible with minor adjustments that the inventor simply for lack of time has not tried. They are certain to add improvement well above 600%, the question is just how high. This 9% efficiency using a HAWT may not sound that exiting but it is a 600% improvement over any current industrial wind turbines and makes wind power by a many multifold factor the least expensive way to produce abundant, clean, and very low cost electricity. Other wind sailing turbines patented here allow for extremely higher efficiencies but require different engineering.

The history and reasons these errors happened are, as follows. The Betz Limit was meant be applied by its real inventor, Frederick Lanchester, to a Newtonian Fluid or Gas in a closed system, in a pipe using an idealized actuator disc to capture the fluid's energy and as applied that way as intended is correct. The Betz Limit in wind turbines states that you cannot block more than 59.3% or you lose efficiency. To understand the Betz Limit, it is easier to think in terms of flowing fluid than a flowing gas. Water weighs 800 times air, making it so we can disregard normal air pressure when talking fluid flow of water in the following examples. Betz Limit (Law) determined if you slow a fluid flow too much exiting an idealized actuator disc that it would block other fluid from entering the idealized actuator disc but Frederick Lanchester made this determination assuming a closed fluid dynamic flow condition. This makes perfect sense and works in a fluid dynamic flow situation where fluids are expected to be in a normal continuous flow on both sides of the idealized actuator disc. Now let us imagine that the idealized actuator disc was allowing the fluid to just exit into a void of air, just freely spreading out as a wind turbine does to air, then Betz Limit would have no application. You can utilize almost 100% of the energy in a fluid system with an idealized actuator if it is an open system at the exiting side. This is an odd analogy but it works if you think flexibly enough to apply it. Hold a bucket of water up 100 m in altitude and through a very long rope and pulley arrangement attach it to turn a shaft into a generator on the ground. When you let, the bucket drop you will capture almost all the potential gravitational energy as usable kinetic energy turning its kinetic energy to electricity. Now if you had 2 buckets at this 100 m altitude with 1 filled with water and you pour (using very little energy) all the water into the other empty bucket at the same height transferring 100% of the potential gravitational energy to the new bucket and you then let the newly filled bucket fall attached to the generator you produce the same electricity. The energy to transfer the water from one bucket to the other can be ignored since if the distance to fall is significant then the energy to transfer the water becomes insignificant in relationship to the potential energy transferred. There are ways that the water could be transferred using insignificant energy making this a near perfect transfer of potential gravitational energy from one bucket to another bucket. If there had been water in the empty bucket that was idealized to be part of a closed fluid flow system and the water had to be pushed out by the new water being forced into the receiving bucket that was part of a closed fluid flow condition, then Betz Limit would generally apply. Betz Law does not apply in a totally non-confined, unconstrained environment when the water or air can go anywhere. Betz Limit applies only when the water exiting an idealized actuator is applied to a confined dynamic flow on both sides of the actuator. In an unconfined release of water into open air, air poses little limit to the exiting water since water weighs 800 times that of air and it would just follow the paths of least resistance which would be everywhere. Although air weighs only one eight hundredth of the water, the inventor has shown that air exiting wind turbines are for practical purposes entering a barely inhibited, non-confined area and Betz Law is not applicable. If you Google “Wind Power Formula” you will find that MIT and endless other authorities accept that Betz Law applies, so if I do not have you convinced that Betz Limit does not apply yet, you are in good company but please stay with this.

Wind as it relates to Betz Limit is unconfined just like the liquid in the buckets. Another example using wind would be to place a small 12-inch diameter fan on a table while exhausting air and hold an 18-inch or 24-inch diameter of flat material or whatever size sail representation is handy in front of the fan at about 4 feet away with its large sail face toward the fan exhaust. Now move the sail closer and you can tell that there is next to zero effect on the amount of exhausted air from the fan or the effort of the fan. The fan's ability to intake air and exhaust air is not slowed until you are almost on top of the fan virtually wrapping the sail around the fan essentially enclosing it in a closed system such as applies in a closed fluid flow dynamic situation that Frederick Lanchester's analyzed. Betz took that work, completely misunderstanding it or at least completely misapplying it. Further, assume the fan is water proof and place the fan in a 12-inch inner diameter fluid pipe and exhaust the fluid into an area of open air. The fan (current wind turbines) would just throw the fluid everywhere. The fan turbines have no limitation from Betz law. The non-real, perfect idealized actuator that Lanchester used in his calculations had an infinite number of blades that were infinitesimally thin. If we could use a non-real idealized actuator disc that Lanchester imaginarily employed for purposes of his experiments to exhaust fluid or air, almost endless fluid and air could be exhausted into an unconfined environment. If it was a continuous flow of fluid in closed system, the Betz Limit invented by Lanchester would apply. To show how Betz Law is meant to apply, let us imagine that we had a 200-meter-long garden hose with water flowing at 50 mph and we removed the Betz Limit of 59.3% of the energy by use of a make believe (idealized actuator) disc at any distance but use 30 meters from the water supply to the idealized actuator disc in the garden hose. Water exiting the idealized actuator disc would be travelling 50 mph times (1-59.3%) or 40.7% times 50 mph equaling 20.35 mph. Since the water is now traveling less than half the speed of 50 mph, the water entering the idealized actuator would be colliding with the water on the other side of the idealized actuator at 29.65 mph (50 mph-20.35 mph) and the idealized system would start and stop endlessly and would be a useless non-functioning system as we think of dynamic flow systems. What Betz Limit calculated was to have a functioning confined flowing system on both sides of the idealized actuator disc, the area inside the garden hose after the idealized actuator disc removed the kinetic energy would have to be expanded to more than double the inside area of the garden hose prior to the idealized actuator disc. In other words, Betz (really Lanchester) increased the diameter of the garden hose after the idealized actuator disc had taken energy because the water was now moving less than half as fast (20.35 mph) on the exiting side of the idealized actuator disc after the idealized actuator disc took the energy. The inside area of the hose after the idealized actuator had to be made 2.457% (50 mph÷20.35 mph) larger to accommodate the slower flowing equal volume of water (fluid). Betz (really Lanchester) only increased the internal flow area of the garden hose to the extent necessary in this example on the exiting side of the idealized actuator disc to maintain a dynamic (continuous, smooth) flow. Betz (really Lanchester) could have made the hose larger on the exiting side and the system and the fluid would still exit but there would no longer be a continuous smooth dynamic flow on the exiting side of the actuator; it would be erratic and not fully fill the hose (pipe) at least continuously. If Lanchester was asked if the hose on the exiting side of an idealized actuator was unconfined (a practical void), Lanchester would have known the 0.593 does not apply since he understood how and what the formula determined but Betz took Lanchester's discovery and misapplied it. If you take more energy than the 59.3%, the exiting hose would have to be even larger than the 2.47 times the area of the hose prior to the idealized actuator and the slower speed of the fluid exiting would be insufficient to maintain a continuous dynamic flow in the needed larger inside area of the larger hose and that is what Lanchester's Limit determined. To say again, if Lanchester increased the hose's inner diameter to more than 2.47 times on the exiting side, and took more than 59.3% of the energy using the idealized actuator disc, the flow on the exiting side would not be dynamic since there would be too much area inside the house for the slowed moving water to be in a dynamic full flow inside the hose. If at any reasonable distance (30 meters) from the water source, you had this idealized actuator disc that was just discharging into an open void, then the water would just go anywhere and there is no limitation by way of water being blocked from exiting the idealized actuator that was present in the confined dynamic flow experiment that Betz should have taken time to understand. Take a garden hose and turn it to medium force. Do you sense any resistance from the air? Now turn it on full blast, do you sense any resistance from the air? Now, let us take two garden hoses and turn them both on full blast, and hold them 6 inches apart and aim their outflows directly at each other. Now, I know you are getting wet but do you believe there is any substantial reduction in their outflows in this extreme resistance situation? If there is, it is very insignificant since they are essentially in a void. Now if you were superman and could push the nozzles perfectly together, the water flow would stop completely. Granted this is even more extreme than Betz. Betz (really Lanchester) only had water flowing from one direction but it was within a confined dynamic flow situation on both sides of an idealized actuator disc and Betz Law has zero to do with wind turbines operating in a non-confined environment. The absolute simple absurdity of this as we all know intuitively is that the way you harness maximum wind force is by totally blocking the wind. If you put wheels under a sail with structures holding the sail up facing the wind and went across the salt flats, you harness maximum wind force by totally blocking the wind, basically trying to not allow any wind to exit the system. The Betz Limit is absurd for capturing wind power. Treating an open wind system like a closed fluid flow dynamic situation shows that Betz must have really been hurrying when he published Lanchester's work. Wind turbines are Wind Sailing machines, but the science was destroyed by this ridiculous assumption. Subsequent errors had to follow if the first assumption was not discovered and corrected. Applying Betz to a rotor blade that is just a small sail whose goal should be to catch all wind possible from exiting makes no sense. At this point I am going to add some more information about the Betz Limit cut in from another document. It may be redundant but it may help to clarify the ridiculousness of the Betz Limit in Wind Turbines. Now the error in understanding the Betz Limit was related to another error in understanding “Swept Area” but I will include it here although this is a bit disjointed the error of the Betz Limit and “Swept Area” both involved the use of an idealized actuator and even if this is disjointed it is worth getting you familiar with what led to the insanity of Albeit Betz' work.

Rightfully, you would think that a physicist would not ordinarily make these types of simple error, which is true, but Albert Betz was using work borrowed from a British scientist named Frederick Lanchester, who had been working with rotor blades for a different purpose. Frederick Lanchester was using the concept of rotor blades as part of his analysis to obtain a calculated result for a separate factor. Lanchester was “making believe” that the rotor blades could utilize the cumulative energy from the entire area the rotor blades spun within. Frederick Lanchester knew that was impossible and rotor blades could only utilize energy proportionate to the rotor blades' own size as a percentage of the area they physically occupy when viewed stationary. Frederick Lanchester, of course knew he was “making believe” the rotor blades could magically utilize cumulative energy from 100% of the area they spun within versus the actual 6%. This method of analysis is called using an “idealized” device (a device having imaginary properties) as just a technique for analysis that assists in calculating a different real factor that is the goal of the analysis to be determined. The imaginary device happened to be rotor blades magically sweeping an entire area cumulatively for energy. Albert Betz did not realize that the rotor blades in Frederick Lanchester's analysis were totally “make believe” (idealized for analysis only) and Albert Betz, who was likely extremely hurried, must have looked mostly at only the end of Frederick Lanchester's analysis, without looking at the earlier descriptions of the setup for the analysis where Frederick Lanchester explained that he was using a “make believe” (idealized) device (idealized rotor blades) for purposes of the analysis only. Albert Betz did not stop to analyze how actual, real rotor blades, based on basic physics would operate. Albert Betz by this hurried work, missed this basic physics' error that impossibly had matter occupying more than one space at one time. Albert Betz simply mistakenly assumed that rotor blades could do what Frederick Lanchester was only “making believe” (idealizing) the rotor blades could do and this is the origin of the first initial error that led to the entirely incorrect basis of Wind Science. Around 1919, Albert Betz was running very fast, working as a Naval Engineer on ship propellers and also had been ruffled by having less success on improving ship propellers efficiencies than he had hoped. In addition, Betz was also earning his doctorate, completing his thesis on ship propellers, and 1 year later and 6 years later publishing two books on his new interest, Wind Turbine Power.

Wind Sail Turbines should try to catch all the wind to the optimal efficiency only limited by the possibility that at some point over aggressively trying to catch all the wind may obstruct and hinder the catching of new wind. Albert Betz, a German scientist did not discover the Betz Limit, it was discovered by Frederick W. Lanchester, a British Scientist in 1915 who did not publish his work, so it wound up with Betz' name even though he did not develop it. Betz published it in 1919 and the author submits that it is highly likely that Betz did not fully appreciate the formula or even basically grasp the formula that bears his name. Betz graduated as a naval engineer in 1911 and from 1911 to 1919 he worked to improve ships propellers. Ship propellers have slight similarities to wind turbine rotor blades, except rotational force is applied to turn propellers that force water usually backwards to propel a boat forward. Rotor blades are somewhat similar but in reverse where wind turns the rotor blades and the created rotational force is used to generate electricity. The author has simultaneously to patenting these new Wind Sail Turbines has patented a new underwater ship propulsion system that is more efficient than using propellers, using the application of the New Wind Power Formula and adaptation of novel designs used in the Wind Sail Turbines to increase efficiency of water propulsion. The author submits that Betz misapplied the theory that he may have taken from Frederick W. Lanchester. Ship propellers had poorer performance than Betz had hoped to achieve in his work. By applying Lanchester's work, now called the Betz Limit, it made the claimed efficiencies of ships propellers appear much better since it indicated that there was a 59.3% inherent Betz Limit limitation as an aggregate theoretical maximum efficiency to measure efficiency against, thus raising what is thought of as practical efficiency. It is likely that the Betz Limit was misapplied to water propellers or had a substantial impact in propeller engineering and the inventor with little research made that logical assumption that the inventor expects to be correct and based on these assumptions it stood to a likely reason that the application of the same Wind Power Formula along with the all other novel designs had good reason to believe this invention applied to water propulsion might be extraordinarily beneficial. You want the water behind the propeller to block new water, since thrust is obtained by pushing against the blockage, the opposite of what the Betz Limit could lead one to at least in some part to use as critical thinking. After Albert Betz erroneously applied Betz Limit to propellers, Betz published Betz's (possibly Fred W. Lanchester's) Law in 1919 and was awarded his PHD in 1919 for his work, “Ship Propellers with Minimum Loss of Energy”. Albert Betz than went on to misapply the Betz Limit to wind turbines. If you still do not believe that Betz has no application in wind turbines, then if you accept the next section on “swept area” as being correct than Betz cannot apply for the next reason alone.

Betz having irrevocably damaged the two sciences of wind power and water propulsion, as any hard worker would do, Betz published in 1920, “Theoretical Limit For Best Utilization Of Wind By Wind Power” and not satisfied there, he solidified his hand in the wind power formula by his book in 1926 “Wind Energy And Its Use By Windmills”.

“Swept Area” of a circle (πR²) is A (area) in the old Wind Power Formula and this use of A (area) in the old Wind Power Formula is proved here as incorrect. This alone, also results in proving that Betz Limit has no application in wind turbines in addition to all the other previous proof. The inventor has proved in wind turbines, that the rotor blades only block 6% of the wind and because the rotor blades are diagonal, only 50% of that 6% is blocked resulting in only 3% of the wind being blocked. Therefore, it is impossible for this reason alone for the Betz Limit to be a factor, since more than 59.3% of the wind needs to be blocked to invoke the Betz Limit.

Let's move to “Swept Area”, the other error tied to the work that Betz borrowed from Lanchester. If we refer to the Royal Academy of Engineering document, second page on the left, halfway down, equation 4, A (the area) is the largest scientific error ever. Using A (area) as the struck area is fine but the largest applied science error ever, is that with no supporting physics, the old Wind Power Formula equated A. (the area) with A (the swept circle area, πR²). The struck area is not even the rotor blades size, it is just the roughly 6% area the rotor blades occupy in the wind path since the rotor blades are held roughly diagonally to the wind. This is a 1667% (1.00%÷6%) error in calculating A (area).

Rotor Blades if-viewed still would occupy roughly 6% of the wind path in the area of the circle they rotate within. Because rotor blades for example rotate at 5-7 times the speed of the wind entering the rotor blades path, it was just latched on to by Betz because of his lack of spending time to understand Lanchester's work that the rotor blades could utilize all the wind power from the entire circular wind path they were rotating within. Lanchester knew this was impossible but Betz did not realize that Lanchester only theoretically did this with a make believe, idealized actuator for experimental purposes only. I must say, that my beliefs about Albert Betz are just my unsubstantiated beliefs and I could be wrong regarding all that I say about Albert Betz. It would even be worse, if Albert Betz understood that he may be misapplying Lanchester's work to get ahead and gave it little thought or figured if discovered he could always say he had misunderstood. I believe it is likely that it is all just insane error from making assumptions without checking on what those assumptions are based. This is all just conjecture and I have not tried to look into to verify anything I ascribe or blame on Albert Betz so I could be very far off if not completely. My only concern has been the science of the old Wind Power Formula that if called a complete utter disaster would be a massive understatement. On page 2 of the Royal Academy document in the very upper left, the Newtonian equation is not interested in the struck objects movement perpendicular to the side as in rotor blades movement since there is no time for that but we will prove that even if there was time it would make no difference. Newton is only concerned with vectors that change the velocity of contact between masses. Perfectly to the side, perpendicular movements are in the 1 vector that does not add or subtract to the velocity of the vectors colliding whether heading toward each other or by one over taking the other or with one striking the other while stationary.

The second page of the Royal Academy of Engineering Document, page 2, top left, the first formula is Newton. E (Energy) has no time component. In the next equation, they change to P (Power), Joules/Second, and on the other side of the equation they introduce the Mass Flow Rate (KGs/Second).

This introduces time back into the equation which makes perfect sense because there is a continuous flow of mass (wind) which is balanced on the other side of the equation by Power (Joules/Second). The enormous error in A (area) by using the area of the wind path versus the area that the rotor blades occupy in the wind path when simply stationary. Swept area was calculated using the entire area of the circle that the rotor blades only pass through. Newton's basic formula for E (Energy) has no time component as you see on the top of page 2, the top left formula from the Royal Academy of Engineering. The rotor blades have no time to move, they are stationary as to this energy calculation. Matter only occupies one space at an instantaneous time. Knowing how Lanchester determined Betz Law illuminates what led Betz Law to erroneously liken rotor blades to make believe, idealized actuator discs used by Lanchester and the insane applications that became part of the old Wind Power Formula. Betz did not realize that the strike of wind on the rotor blades was nothing more than Newton's formula at the very top left of page 2, where E (Energy) has no time component and the area that is struck by the flow of air can only be seen as stationary. Matter cannot occupy more than one space at an instantaneous time. The considerable speed that the rotor blades slice through the wind in an overall perfectly perpendicular sweep does not increase the velocity of the wind strikes because the perpendicular movement is not additive to the velocity of the wind strike. The perfectly sideways movement does not add or subtract to the velocity of the wind strikes which of course would have a direct effect on E (Energy). The rotor blades movements are in the 1 perfectly perpendicular vector that has 0 effect on strikes velocity.

It seems as if Betz thought you could count “Swept Area” because Betz forgot or did not know or fully grasp or want to know how the Betz Limit was calculated by Lanchester using a non-real, perfect idealized actuator disc because Betz may have borrowed the Betz Limit discovery that he published and put his name on from Frederick W. Lanchester without a lot of thinking because it was helpful to making his results working with ship propellers appear better, explaining poor efficiency in propeller designs, making 59.3% the best theoretically possible efficiency. This is an assumption since I have not looked into propeller science. Betz than moved on to wind turbines. As off base as it may seem, the author/inventor believes that Betz may have unthinkingly or hopefully not purposefully for that matter falsely likened rotor blades to the non-real idealized actuator discs that Lanchester used that were idealized (made believe) to operate in an imaginary way for experimental purposes only, with the imaginary ability of the actuator disc to sweep and utilize energy from an entire circular swept area without a component of time. Betz likened the idealized actuator disc to rotor blades because he did not understand Lanchester's work and believed that is how it all worked or Betz chose to think that imaginary way about rotor blades of a wind turbine. Unlike the non-real idealized actuator, you cannot sweep an area for kinetic energy unless you occupy that area at the same time and that is the crux of where the applied sciences of wind turbines and likely ship propellers took this unfortunate turn. The inventor will further elaborate since this is all critical to understanding all that is here.

Betz used Lanchester's work from a confined dynamic fluid flow experiment and applied to open unconfined wind turbine. In the experiments Lanchester was not sweeping an area, using this make believe idealized actuator, Lanchester knowing was imaginarily and theoretically full occupying the area with an imaginary idealized disc that impossibly had an infinite number of rotor blades that impossibly were infinitesimally thin. It was an entirely imaginary set up which cannot exist. This make believe idealized actuator was capable of removing 100% of the kinetic energy from the entire swept area (more accurately described as the nearly fully occupying the area) but Lanchester's discovery was only that if you removed more than 59.3% of the kinetic energy from a confined mass flow, the mass flow exiting the swept area (really more closely described as the nearly fully occupied area by the idealized actuator) would be going too slowly to have a true dynamic mass flow on the exiting side of the idealized actuator disk and all, of this was in a confined pipe. I have used the odd language of “nearly fully” occupying because I am describing a device that cannot exist, one that can fully block a mass flow and at the same time fully allow that mass flow to pass through itself. To have a dynamic flow situation on both sides of the idealized actuator disc required enlarging the area for the mass flow by 2.47 times on the exiting side of the idealized actuator within a pipe after the idealized actuator had removed 59.3% kinetic energy from the mass flow causing the exiting mass flow to be 2.47 times slower than the entering mass flow. There is just one enormous problem, Lanchester was using a make believe idealized actuator disc that had an infinite number of blades that were infinitesimally thin or alternatively likened to a theoretical disc that could extract all the kinetic energy while allowing all the mass flow to pass through it and the theoretical imaginary experimental analysis took place in a pipe. Yes, this idealized disc could theoretically sweep the entire area without moving (more accurately described as nearly occupying the entire swept area not requiring movement) without a component of time. This idealized actuator disc was capable of occupying the entire mass flow area, and at the same time completely not occupying the entire mass flow area. Betz, really Lanchester using this non-real idealized actuator disc could take all the energy from a mass flow by occupying the mass fluid flow area to capture 100% of the kinetic energy and allow all mass fluid flow to pass through the idealized actuator disc, a pretty good feat best left to a perfect but non-real idealized actuator disc to perform. It seems likely to me that Betz misapplied this Betz Limit that I believe he likely took from Frederick W. Lanchester and misapplied the Limit to both his work on ship propellers and wind turbines and has hurt both applied sciences unimaginably. Again, the idealized actuator disc was for convenience, made to have an infinite number of infinitesimally thin blades capable of taking all the energy from the mass flow but also letting the mass fluid flow to fully pass through itself for purposes of rendering experimental results. This perfect non-real idealized actuator disc could simplistically be described as sweeping the entire area at every instant but it was actually more occupying the area. This may have created confusion. At every instant, this idealized actuator disc can allow the full mass flow to flow through this idealized actuator disc while extracting 100% of the kinetic energy by blocking the flow, a nifty trick indeed best left to a make believe idealized actuator disc. Betz must have likened the make believe idealized actuator disc to rotor blades on wind turbines and that is a problem along with the application of the Betz limit itself to unconfined wind turbines. No such device exists, and likening this imaginary actuator disc to very heavy small rotor blades (small in relation to the area they rotate within, 6% of the area of the wind path) with mostly all totally empty space between the rotor blades makes no sense. Believing that 55-ton rotor blades, rotating in a 300-foot diameter circle or 100-ton rotor blades rotating in a 528-foot diameter circle with rotor blades comprising 6% of the area they rotate within can be likened to a perfect, imaginary, non-real, make believe idealized actuator disc is quite out there but this is what Betz concluded and foisted on the wind turbine industry. The wind industry benefited in as much they claimed efficiencies that are massively greater than 1.5%.

The fact that rotor blades often rotate at many times the speed of the wind does not increase the E (Energy). This is proved by the Newtonian equation on the very upper left of page 2 as previously referenced that does not allow for time. Rotating rotor blades give the impression of great power since there is little resistance against the rotation and the rotational force appears very powerful. Although time is not present for the calculation of E (Energy), even if we allow for time into the equation, it does not change anything. An example to prove this would be to create a very slow, evenly flowing water fall with a long width analogous to wind. Time how long it takes to fill a bucket with water, holding the bucket stationary in the waterfall. Using very fast speed move the bucket in a level position very quickly along the flow of water and no matter how fast you go the bucket fills at the same rate. Matter only occupies one area at any instantaneous time. This is identical to the very fast rotating rotor blades in respect to wind. The perfectly perpendicular movements in respect to the mass flow (wind) does not gather the energy any faster even though it may appear and seem as if it should. The only way to fill the bucket faster or slower would be temporarily if you moved the bucket up into the waterfall's flow or away from the waterfall's flow respectively increasing or decreasing the velocity of strikes. Of course, the simple way to gather water faster would be to use a larger bucket and that is the main reason why this patent uses sails instead of rotor blades.

This mistake of using the area of the wind path (πR²) versus the area the rotor blades occupy in the wind path is like using the entire waterfall's mass flow area because you are speeding along its flow in a level fashion believing the bucket will fill faster. A larger bucket analogous to larger rotor blades' areas will gather more water but the speed of the same bucket along the waterfall will not; no matter how fast you move the bucket in the waterfall flow. Now liken the moving bucket to rotor blades spinning and liken the water to wind and liken the amount of water flowing into the bucket as wind energy and this is identical to the first initial error made by Albert Betz. The only way to gather more water faster would be with a larger bucket and that is why Wind Sail Turbines with large sails substituted for rotor blades are massively more energy producing. Another simple example would be to go outside on a windy day and hold up a pencil in the wind to block a tiny bit of wind. Now move the pencil back and forth very fast trying to block more wind. You do interrupt a little wind since you sideways motions push a little wind into other wind (but disregard that messiness you cause) and you should sense that you are only blocking the same amount of wind no matter how fast you move the pencil, no matter how fast you go and/or how small or large the arc of movement may be. If you hold the pencil still, the only difference is you are continually blocking the tiny amount of wind at a stationary location behind the pencil. No matter how fast you move the pencil you are blocking the same amount of wind but just spread out over a larger area for very lesser amounts of time. A last example would be to hold up a small piece of thin plywood into the wind and feel the force. Now run sideways with the piece of thin plywood and see if the wind force changes and it will not. You could do this from a side window of a car with the wind blowing at the side of the car that you hold the thin plywood in the window and have the driver go 30 mph and there will no more force on the plywood than if stationery. Be careful to not let the wind that the car's own motion makes rip the plywood from your hands. Be very careful to keep the plywood parallel to the car to avoid the plywood being ripped out of your hands. If wind worked this way, race cars when they had a wind to one of their sides would not be able to stay on the track. The rotor blades are identical to the plywood and/or the race car and nobody would think otherwise except that a physicist, Albert Betz, that had no knowledge of wind, developed the Wind Power Formula that has been universally accepted for 90 years without ever checking the efficiencies, just the power outputs. This is hard to believe at first, but it is easier to believe once you understand how the Wind Power Formula produces correct power outputs yet overstates efficiencies by 4700%. Even if time is introduced to the formula, it does not change the results. If 1 second is introduced to both sides of the equation, and the rotor blades occupy 6% of the wind path area they spin within as seen stationary, and then for example we assume the rotor blades in 1 second spin through an area 16.67 times larger than the rotor blades' own size, this does not change the utilized energy because instead of being in 6% of the area for a moment, the rotor blades are in 100% of the entire area the rotor blades spun through for 1 second but to analyze this properly, you need to break up the 100% area into 16.67 areas of 6% of the entire 100% area and then consider and factor in that the rotor blades were only in those 16.67 areas of 6% of the entire 100% area for only six one hundredths of the second, so equal wind energy is striking the rotor blades if stationary or spinning rapidly. Seeing and hearing the massively heavy and long rotor blades spinning at considerable speed it is easy to assume that more is going on than is. This is especially true when a physicist, Albert Betz, formulaically claims in the Wind Power Formula that the rotor blades utilize energy cumulatively from the entire 100% Swept Area. Although 100% false, this false belief then became totally adopted. This totally incorrect Wind Power Formula underpins all of Wind Science. This Wind Power Formula has been used by all wind engineers for 90 plus years and is the very fabric of Wind Science. How this error could persist undetected for 90 plus years, will become obvious very quickly, although it is shocking. This one simple error in the original assumption led Albert Betz to believe wind turbine rotor blades were cumulatively utilizing energy from 100% of the wind path area when in fact rotor blades were utilizing 6% of the wind path area. This largest applied science error ever, a 1667% error (100%÷6%) which is a 16.67-Fold error caused Albert Betz to have to continue to make more errors in creating the Wind Power Formula so that the Wind Power Formula would produce predicted power output results that matched power outcomes from actual wind turbine testing. Albert Betz offset this initial 16.67-Fold error with multiple additional offsetting errors but first, let us look at simpler examples showing this same initial 16.67-Fold error so you will not be questioning this first initial error as we move on. Rightfully, you would think that a physicist would not ordinarily make this type of simple error, which is true, but Albert Betz was

Now even if you included allowing for time into “Swept Area theory” it would change nothing. Assume a rotor blade that occupied 6% of the are within they rotate and they were rotating fast enough that the rotor blades swept an area 16.67 times greater than the area the rotor blades occupy in the wind path in 1 second, yes, it is true that they harness energy over the entire area but they are only in one sixteen of that 10 times larger area for one tenth of one second so it comes out the same. The old Wind Power Formula mistakenly acts like the rotor blades were in those ten area for the one second, so it is falsely cumulative, overcounting by 10-fold in this example. To use the entire area of the wind path that the rotor blades travel through versus the rotor blades own area of the wind path is as far off the mark if not more off the mark than believing that Betz Limit itself applied to wind turbines that operate in a totally unconfined environment. Applying Betz Law assumed a closed mass flow situation on both sides of a make believe idealized actuator disc and had no zero application. Betz determined that only 59.3% of the wind could ever be harnessed. This 59.3% in C (a constant) was further reduced due to the need for strength and durability and other mechanical and electrical factors and is usually around 35%-50% in the wind power formula. The lack of time in the derived Newtonian equation (page 2, Top left of the Royal Academy Document) precludes the rotor blades sweeping an area larger than themselves since there was no time and even with time, a perfectly perpendicular vector to the contact vector does not increase the velocity of the contacts even if you allowed time into the calculation. Swept area never had a place application. It is impossible for matter to occupy more than one area at one time, at least on any Newtonian physics' level. When Betz included swept area by the rotors blades, he overlooked that it was impossible since there was no time to sweep any area and even if rotor blades were to sweep an area over time, the only struck area ever is the area that the rotor blades occupy in the wind path making whether you include time or not, irrelevant.

The belief that sails are airfoils and work primarily based upon lift is incorrect developed because the power in the wind was erroneously determined to be half of its actual power. Lift as should be expected never calculated good results, the Theory of Lift saw airfoils with over-pressure on one side of the airfoil and under-pressure on the other side of the airfoil created a doubling effect of forces. The fantasy of lift as applied to airfoils is due to the power in the wind being incorrectly calculated at 50% its correct power. Lift as expected never worked well for aeronautical, wind turbine, or sailing engineers. When results were inevitably off, they often relied on a combination of lift and Newton's 3^{rd} Law, that a force in one direction will create an equal and opposite force and lift has always been a muddled mess. Newton held the entire answer but differently. Wings, rotor blades, and sails are all just sails and not airfoils and work from simple Newtonian collisions from the wind. The entire problem was science had the power in the wind at 50% of its correct power causing scientists and engineers to create this fantasy use of lift. Wind scientists and engineers believe rotor blades sweep an area acting as if their size is enormously increased by their movement and/or cumulatively benefiting from lift that contains the same impossibility as to matter occupying more than one space at one time. Any possible tiny lifting force is negligible compared to the primary force of wind strikes. The high winds that rotor blades create themselves to provide any lift, initially have the energy coming from the true wind striking the rotor blades and the wind the rotor blades cause themselves is just resistance and no new energy source is present except the fantasy of lift.

When observing rotor blades, spinning 5 to 7 times the speed of the wind at their outer tips it gives the impression that something more powerful is being utilized than the very limited wind energy that the small area that the rotor blades occupy in the wind path catches, just the same as if the rotor blades were stationary. Think of a sail boat that comes about and gets under sail. It starts off a little slow (inertia etc.) and then quickly reaches full speed. On a sailing boat from a standstill to reaching fill speed you never sense that more wind is hitting the sail. Ice boats travel up to 5 plus times the speed of the wind. They are not catching 5 times the true wind. The reasons that these certain boats can achieve this terrific speed just happens to be because of an unusual set up of the sails angularity to the wind. Ironically, the fastest speeds of these boats are achieved when sailing almost into the wind. The sails are trying to run away from the wind which is what sailing is but because the sails are at an angle close to pointing directly into the wind (very close-hauled or a very tight beat in sailing terms), the sails will try to go much faster than the wind in order to be fully running away from the wind's force. To understand this, you must draw it out. Since the sail(s) and sailboat are joined, they will go much faster than the wind to escape the wind if provided with a very low resistance path. Sailing theorists attributed the speed up to the speed of the wind to the true wind, and the great speeds beyond the speed of the wind to lateral forces being squirted forward (squirting phenomenon). I believe it is just the sail's angularity to the wind and the fact that these exotic speed sailboats and especially ice boats have very low resistance to moving forward and there is likely no squirting phenomenon. It will be great if the squirting phenomenon exists since it increases the efficiency of wind turbines One last comment about high-speed sailing, it is quite remarkable that the set-up of sailing nearly into the wind and having the sails' large sail face adjusted nearly parallel to the wind, makes it so that the sail itself does not offer a lot of resistance to the part of the apparent wind that the boats own speed forward creates and this is part of the overall low resistance path to the boats as they race forward. Although it makes sense, is just hard to believe that everything sets up in perfect harmony to allow the sailboat and/or iceboat to race forward with very low resistance, ironically with the sailboat and its sail(s) facing nearly into the wind. These sailing theories had the inventor initially assume that the squirting phenomenon is at work but I believe now it is less likely the factors at work. If a sail is held up to catch a 10 mph wind and if the sail was moved 10 mph away from the wind, there would effectively be no wind force on the sail. Oddly, if you held a sail perfectly diagonal to the wind and ran perfectly perpendicular to the wind toward the sail in the direction that the sail would more naturally want to go, you would need to run 20 mph to diminish the wind force on the sail to zero. At first, since you are running perpendicular to the wind, you might not think that you were reducing force of the wind on the sail but if you draw it out and consider it, you will see and realize that from the wind's perspective the sail is still backing away from the wind even though the sail is moving perpendicular to the wind. The speed of an angled sail will affect the power and angle of force the wind provides.

A reach in sailing language is simply sailing 90 degrees off the wind but instead of sailing in a straight line, current wind turbine rotors blades sail on a reach vertically, circularly around the axis but this movement is in sailing terms identical to a boat sailing on a “reach”. The sails are another rough 45 degrees (this varies over the rotor blades) off the wind so the rotor blade (sails) are roughly 135 degrees off the wind or said simply, the rotor blades (sails) are diagonal to the wind on a reach.

It is easy to jump to conclusions about wind energy harnessed when you see the giant rotor blades whipping. It is impressive and makes it seem, believable that something more than basic wind hitting three relatively small rotor blades (considering the large size of the area they rotate in) is involved.

The power in the wind that rotor blades gather energy from is simply based on the size the rotor blades occupy in the wind path when stationary. Their angularity of course loses wind power but that is accounted for in C (a constant) in the New Wind Power formula.

So, all this sound and fury of the rotor blades (thin slivers of sail) rotating 6 times the speed of the wind signifies just the original true wind. The fact that rotor blades are more efficient at high speeds comes not from lift but the fact that portions of rotor blades that are quite perpendicular to the wind is seen by wind as if they are more angled and because of high-speed on the outer rotor blades, the blades can be flattened, thus catching wind still effectively even with the great speed because the very slight angle of the rotor blades at the outer portions of the rotor blades is perceived by the wind as having more angle thus the force from the sail is effectively converted into the desired rotational force. This has allowed for ever larger rotor blades with higher speeds of travel during the rotation to capture and to harness wind at these higher speeds of rotation that inevitably comes along with larger wind turbines and their larger rotor blades, since as you move towards the outer circumference the rotor blades are traveling as fast as 5 to 7 times the speed of the wind.

Before moving on from the discussion that rotor blades initially utilize only 6% of the wind energy, their 6% area in the wind path, it may help to consider this. Even though wind scientists and wind engineers might see value in the points just raised they may revert to thinking, propellers on an airplane supply power based on their speed of revolution so why would rotor blades speed not create more power. Propellers do create more power as their rpm-s increase but this is an entirely different system even though visually there is similarity. The constant speed of any wind is only striking the rotor blades on a wind turbine. The amount of wind strike does not change based on how fast the rotor blades move, they are just in more places but over any same time are struck the same as if stationary. Propellers unlike rotor blades are not being struck by wind, they are powered by engines and the faster the propellers are made to turn, the more air they carve and force rearward. So, propellers do apply more force even though they do not occupy more area by turning faster. They do however carve the air faster, and air can be very effectively carved. As air is carved away at increasing speed, air at an ever-increasing speed fills in to be carved by the higher carving speed of the propeller. As you carve away air faster you create a greater vacuum effect pulling in air ever faster, additionally the airplane is thrust forward at high and higher speeds forcing its way into new air to be carved and increased air is forced back providing increased thrust. So, propellers do provide more power by rotating faster but it is not because the propellers are occupying more space than their own size which is impossible, it is just that they are carving faster using more engine power and the added power is evidenced by more air being pulled through the propellers providing greater thrust. The added air movement is caused by the use of more energy from the engine that then increases the rpm-s and the system makes perfect sense. Wind blows at a rotor blades and they will spin at different speeds based on the wind speed and any load on the rotating shaft. Unlike the propeller there is no more air (wind) coming into the wind turbine or exiting the wind turbine based on the rotor blades rpm-s because it is the wind itself that is the source of energy. Unlike propellers, rotor blades gather energy by being struck by wind not carving wind using energy from an engine to carve wind faster as propellers do. The only way that rotor blades can utilize more wind is if the rotor blades are literally physically larger thereby being struck by more wind. Rotor blades speed comes from the wind strikes and the wind strikes do not increase because the rotor blades are allowed to run away from the wind faster by rotating faster. Sailing is nothing but a sail attached to a sailboat running away from the wind. Rotor blades are nothing but sails and their speed of rotation is nothing but how well they run away from the wind based upon how easy the path is to run away on and angles of the rotor blades (sail) have a lot to do with it as well which I will skip for our purposes here. Rotor blades power from the wind is no different if the rotor blades are moving or stationery. Propellers are using an engine to rotate into the air, carving the air into rearward thrust. Lastly, if rotor blades are spinning 125 mph, they create an artificial wind in respect to themselves of 125 mph but this is not an energy source, it is just an expression of resistance. If manipulating the effect of this artificial wind by rotor blade design to create more or less lifting force in either direction (towards or away from the true wind), provides any tiny increased efficiency, it is not some fantasy of created energy, it is just a result of relieving a stress that helped mechanically advantage the mechanical rotation of the low speed shaft in their bearing collars. I am not trying to give Albert Betz an excuse but he came to wind turbines from a background of ship propellers which are not unlike airplane propellers. Rotor blades and propellers look alike but are entirely different systems. Albert Betz in addition to not taking time to understand the basis of Frederick Lanchester's work, may have assumed that these 2 systems shared more of the same physics than they do because they visually were quite similar and Albert Betz may have been hurrying without checking every assumption.

### Additional Information as to why Winds' Physical Mass Must be Doubled to Calculate the Power in the Wind.

Wind results from uneven heating of the earth by the sun, and wind is the flow of air from higher pressure areas (less heated) to lower pressure areas (more heated). Wind power is an indirect utilization of concentrated solar energy. Solar energy sets up the air pressure imbalance. Gravity attracts the areas of denser air (high pressure areas) with more downward force than the less dense air (low pressure areas) and air flows (wind) towards the less dense areas of air (low pressure areas). The utilization of wind, correctly done using sails provides massive energy. The best way to utilize wind's energy has always been with sails and remains sails, not rotor blades mistakenly believed to have impossible properties and mistaken to be something different than what they are, which are simply tiny (relative to the area they spin within) slivers of sails.

To calculate wind energy, pAv, as the mass of a wind flow, has always been used.

p (density)×A (area)×v (velocity)
v (velocity) is meters per second, so v (velocity) in this usage is the length (depth) of a mass of wind that strikes during 1 second with a given p (density) and given A (area).

Winds' mass for calculating wind energy has always been incorrect and needs to corrected to 2pAv. The correct figure, 2pAv, is twice winds' physical mass of pAv. Liken wind to a 1 mile long piece of solid iron of any area with a v (velocity) of 12 meter per second striking head on into an immovable sail. Because we have likened wind to solid piece of iron, to calculate the collision force, we would not use just the 12 meters of the iron's mass to calculate the energy of the collision due to the belief that that is how much of the iron's length could pass into the sail if the sail were penetrable during 1 second. You of course would use the entire 1 mile of the iron's mass since the iron is solid. Likening wind to the 1 mile piece of iron is very inaccurate. The Wind Power Formula goes to the other extreme, making the calculation to determine wind power by likening wind as follows. The Wind Power Formula likens wind to only 12 meters of iron as if this 12 meters of wind was unattached and a separate from the 1 mile of iron, with just the 12 meters of iron striking the sail at 12 meters per second. That likening is also not correct for winds' power. To be correct, wind should be likened to this next description. Wind is like the 1 mile long piece of iron traveling at 12 meters per second but when the iron strikes the sail, the striking end of the piece of iron readily collapses and disperses into the environment and this striking ends ability to collapse is so efficient as to allow essentially new strikes of every infinitesimal part of that 12 meter length over the entire 1 second with the entire 1 mile piece of iron moving forward at 12 meters per second so the striking ability of the 12 meter length of wind that will strike in 1 second does not diminish at all over that 1 second, even though the striking 12 meters goes from 12 meters to 0 meters as it strikes during the 1 second. With this correct likening the 12 meters that strikes, retains the same striking force on the sail as its 12 meters collapses to 0 meters because the remaining 1 mile of iron moved forward at 12 meters per second keeping the effective mass and its corresponding force of the strikes the same during the entire 1 second. This describes wind, and 2pAv needs to be used to describe the energy yielding mass which is double its physical mass, pAv. Now this at quick glance may seem to violate basic physics but when mass is put into Newton's collision energy calculation, mass is multiplied by one half since the equation is based on the mass's initial collision mass being immediately exhausted to 0 collision mass. This one half in the Newtonian energy equation has the 12 meters and the final 0 meters at the end of 1 second for the collision mass of the iron at an average of 6 meters of mass. pAv is just the mass of a flow that will strike in 1 second and if not adjusted, it is cut in half by the equation. This mass of pAv because the 1 mile of iron moves in behind it at 12 meters per second, makes it so as the 1.2 meters collapses to 0, the same force is exerted for the entire 12 meters as if it did not collapse, so we do not average the 12 meters with 0, we just use the entire 12 meters, but to do that, since the Newtonian equation for collision energy is assuming a separate mass, not a mass that is part of a mass flow that will always retain the full force from the entire 12 meters per second of collision mass, we simply have to multiply the mass by 2, so when the mass is cut in half by the Newton's energy equation, we have accounted for 12 meters of mass force, striking for the entire 1 second and not the average of 12 meters and 0 meters that it would be if we did not make this adjustment to the mass by doubling the mass for purposes of use in the Newtonian energy calculation.

### SUMMARY OF INVENTIONS

Patenting of The Application of the New Wind Power Formula (NWPF) that improves the use of sails (rotor blades, sails, and wings are sails as defined by this patent) and patenting The Application of the NEW Wind Power Formula with HWB 3s (a type of Wind Sail Turbine) and the patenting the novel movements of sails and patenting the novel movement of sails and patenting HWB 1s and HWB 2s (types of Wind Sail Turbines) wherein novel sails' movements are used to end the fossil fuel age and supply abundant, clean, and far less expensive electricity (power) to humankind. The new Wind Sail Turbines produce roughly 10-Fold to 50-Fold more power than conventional wind turbines using rotor blades in the same wind path. A novel more direct force propulsion system, the Henry Propulsion System is patented.

### DESCRIPTION OF DRAWINGS

The following drawings show various Wind Sail Turbine designs and the Water Propulsion System. Seven animation links and 1 video link of Wind Sail Turbines are contained in (Appendix A). The video link is to 2 operating new prototype HAWT Wind Sail Turbines that are HWB 3s. There are links to animations of HWB 1s, HWB 2s, and HWB 3s, the 3 general types of Wind Sail Turbines, in Appendix A that help to understand the drawings and will make visualizing and understanding the operation and design of the invented Wind Sail Turbines easier. At the website, HenryWindBuster.com, there are active links to the same animations/video on the opening page. The inventor has poor drawing skills, so the drawings are very simplistic. Scale is unimportant, these devices could all be built tiny to enormous. The wind direction is to be considered from the reader to the page and/or from the reader to the screen unless otherwise stated. Any errors in this and every section of this document should be corrected to the most reasonable interpretation and/or outright correction base on this entire document and the animations make understanding and/or clarifying and/or correcting this entire document easier and better and it is the inventor's hope that a court will always include the animations/video that will always contain the date created in their title to show their existence prior to this Utility patent Filing and these requests are made without exception or limitation.

FIG. 1—HWB 1s—#1 is a square sail. The area between the lines are the sail face, and/or if a sail is said to be facing the wind and/or into the wind, it is the sail face that is being spoken of. If a sailboat faces into the wind, the sail face and/or sail is said to be out of the wind meaning the sail is perpendicular to the wind, so the sail catches no wind. HWB 1s use sails in this orientation to track downwind.

FIG. 2—HWB 1s—#2 are meant as 6 separate straight lines only. Each line represents a sail(s) shown in FIG. 1 that at the end or near end of its downwind track has pivoted and/or rotated and/or otherwise moved to be oriented so any one of those 6 lines represent the sail with only the sail's thin edge facing directly into the wind. This is called as a sail(s) being out of the wind. This minimizes wind resistance as sail(s) are mechanically moved up wind. The sail(s) are then pivoted and/or rotated and/or otherwise moved to be oriented to start catching the wind and will then move downwind as in FIG. 1. Orienting a sail between FIG. 1 and FIG. 2 will catch varying amounts of wind and could also be described as spilling wind.

FIG. 3—HWB 1s—FIG. 3 is the same as FIG. 1, except that the sail is made up of segments and/or can be thought of and/or called louvered. There are 2 sails of the same nature shown but only the front sail is visible. The seen, front sail is blocking seeing the second sail that has its louvers open. That open louvered sail would look like what is visible in FIG. 3 minus all the horizontal lines but connecting the 8 dashes on each of the 2-vertical line with new horizontal lines. The 8 new horizontal lines would only be the thin edges of the sail segments of the sail in the position that minimizes wind resistance. In general, throughout this entire document when speaking of open and closed louvers, substituted for that could be segmented sails with their segments positioned to catch wind and/or minimize wind resistance and/or any state in between is included throughout this entire document without limitation.

FIG. 3A—HWB 1s—FIG. 3A is a side view of FIG. 3. Both sails are comprised of sail segments. This design is explained in Detailed Descriptions and an animation clearly shows it operating. 1 full sail has its louvers open while the other sail has it louvers closed. An open louvered sail allows wind to blow through itself as moved upwind. This wind can power a downwind sail if existing. FIG. 3 and FIG. 3A accomplish the same functions as FIG. 1 and FIG. 2 but using louvered and/or segmented sails.

FIG. 4—HWB 2s—VAWT Design—FIG. 4 on the left shows a downwind sail that has been blown 90 degrees to the left around an axis with a sail opposite itself that has been rotated to minimize wind resistance as moved upwind. After approximately 90 degrees of further travel around the axis, both sails are rotated 90 degrees. The upwind sail is now oriented to catch wind to head downwind and the downwind sail is oriented to minimize wind resistance as it moves upwind. After every 180-degree rotation around the axis, both sails are rotated. This VAWT can be made to rotate either direction around the axis based on how it is started. A link to an animation in Appendix A shows this or go to the website, HenryWindBuster.com for a live link.

FIG. 5—HWB 2s—VAWT Design. FIG. 5 is the same as FIG. 4, except on the left substitute close louvers for the sail that will catch wind to move downwind and on the right substitute open louvers for the sail that is minimizing wind resistance as being moved upwind.

FIG. 6—HWB 2s—HAWT Design. FIG. 6 is the same as FIG. 4 but using a horizontal axis. The sails can be made to rotate either direction around the axis by how they are started. This design requires the tower to rotate so the axis is kept perpendicular to the wind.

FIG. 7—HWB 2s—HAWT Design. FIG. 7 is the same as FIG. 6, except substitute close louvers for the sail that will catch wind while rotating downwind around the axis and substitute open louvers for the sail that is minimizing wind resistance rotating upwind around the axis. This design requires the tower to rotate so the axis is kept perpendicular to the wind.

FIG. 8—HWB 3s—HAWT Design. FIG. 8 is a 2-sail design that can rotate either direction if you reverse the orientation of both sails. Both sails are oriented the same if each were looked at in the same location. When the sails are viewed together on opposite sides of the axis they are oriented on different sides of the wind so they will rotate. On the furthest left edge of the sail on the left, a flap is shown. Flaps can be anywhere and of any nature discussed elsewhere in this document and this 1 flap is just placed here as a convenience to show a flap. This design requires the tower to rotate so the axis is kept parallel to the wind.

FIG. 9—HWB 3—HAWT Design. FIG. 9 is a side view of FIG. 8. Cantilevering is most likely necessary so the sails do not strike the tower. The dotted line shows a general location where added support could or could not be added based on engineering design.

FIG. 10—HWB 3s—HAWT Design. FIG. 10 is the same as FIG. 8 except using a round area of sails with a total of 8 sails. 8 Sails is just an example and any number of sails is possible. This design requires the tower to rotate so the axis is kept parallel to the wind.

FIG. 11—HWB 3s—HAWT Design. FIG. 11 is a side view of #10. Cantilevering may be necessary but to a lesser extent than FIG. 9 assuming the same total area of all sails, to avoid sails striking the tower. The dotted line shows a general location where added support could or could not be added based on engineering design.

FIG. 12—#12—Henry Water Propulsion System. This has a shaft attached to a hinge attached to 2 plates although there are many ways to do and they are included without limitation. The plates will open to an optimal point as they are thrust away from the reader to push water back and cause thrust forward toward the reader.

FIG. 13—Henry Water Propulsion System. After the thrusting in #12 has completed, as the plates are brought forward toward the reader the plate(s) will fold and/or the plate(s) will orient in any way so when moved towards the reader to a pre-thrust position that movement causes minimal resistance.

FIG. 14, 15, 16, 17—are housed in Appendix D—Appendix D contains 4 pages of drawings that generally show the operating parts of wind turbines and the inventor includes those drawings as part of his drawings but since they are not drawn by the inventor, those drawings have been included in Appendix D where their authorship is kept intact and these drawings are not specifically to the novel aspects of the claims except that they furnish some general descriptions of parts and/or structure that are found in conventional HAWTs that are available in many places in similar forms.

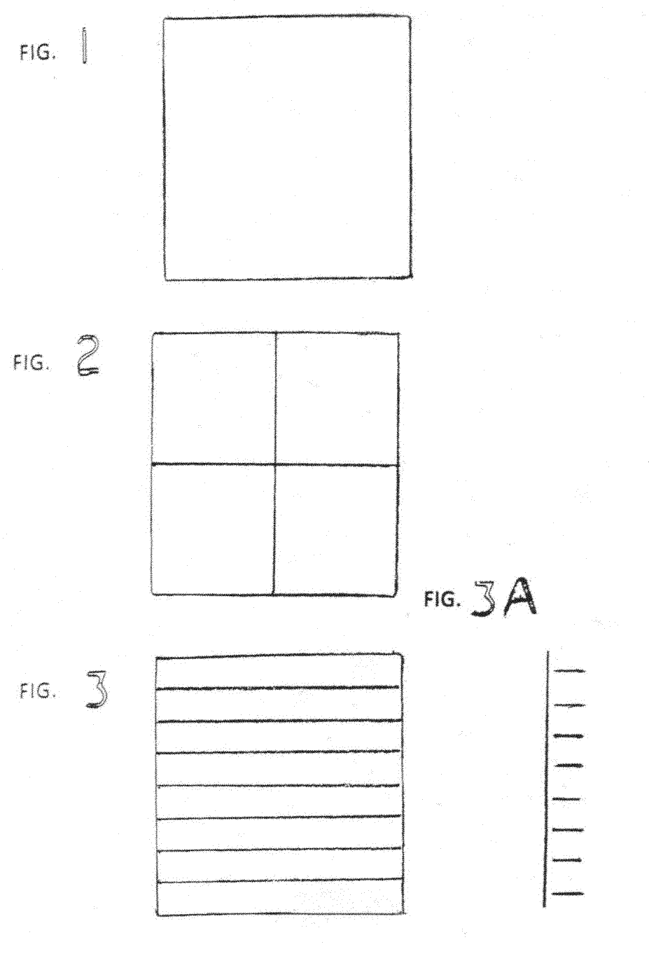

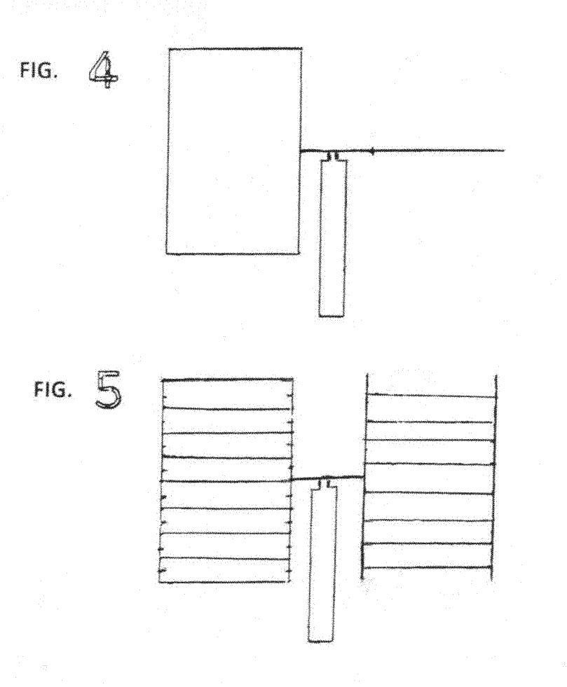

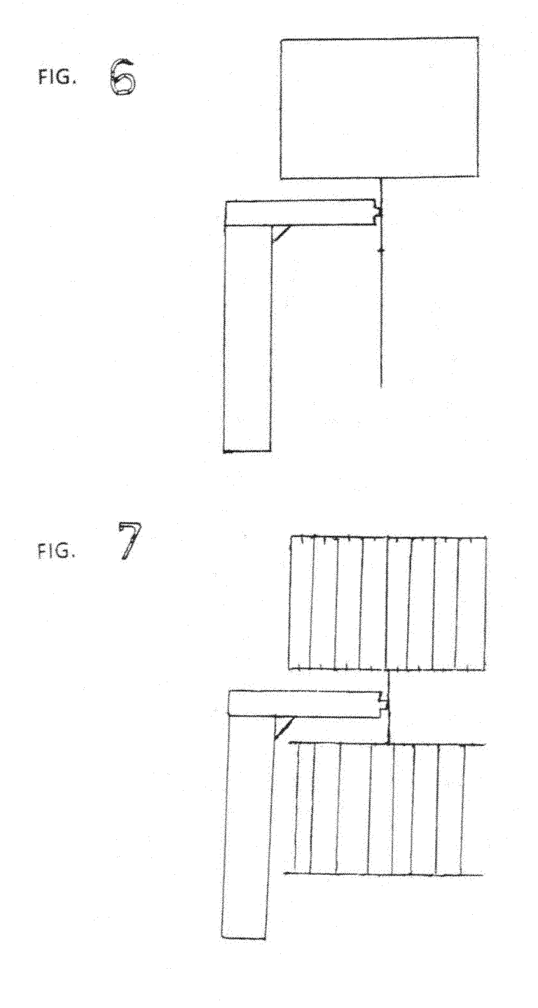

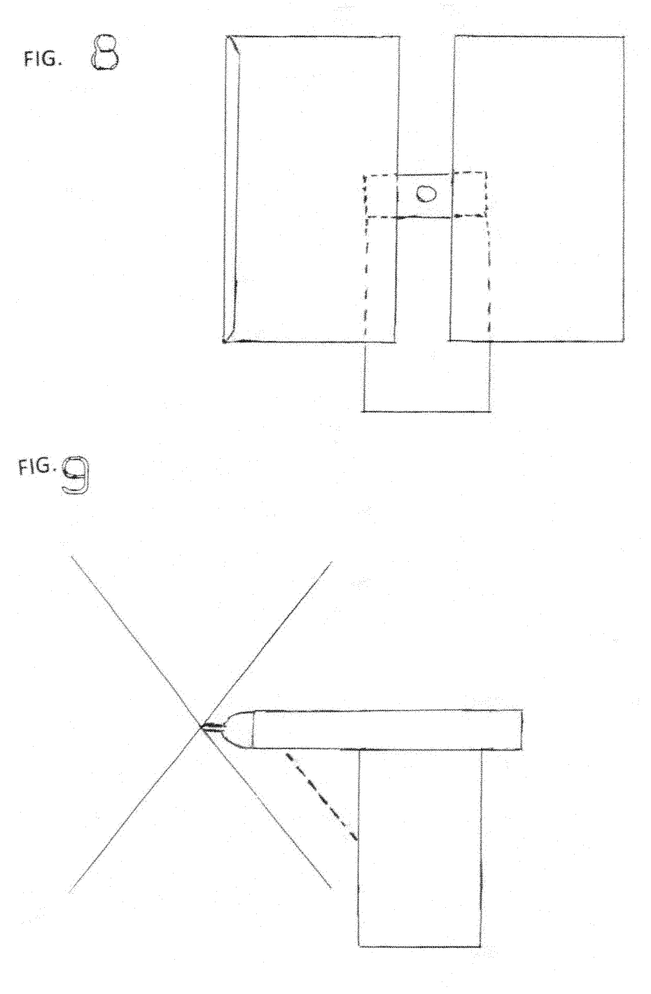

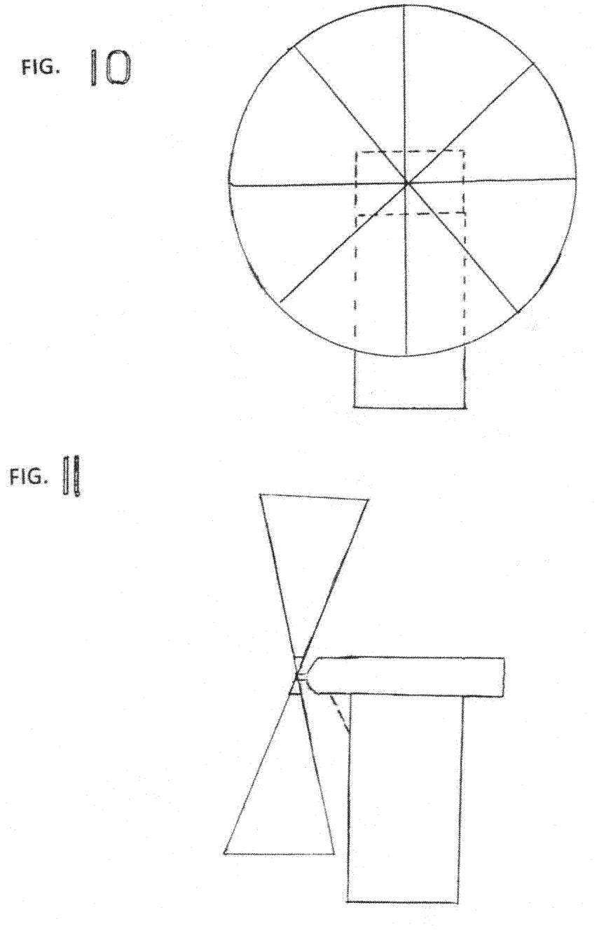

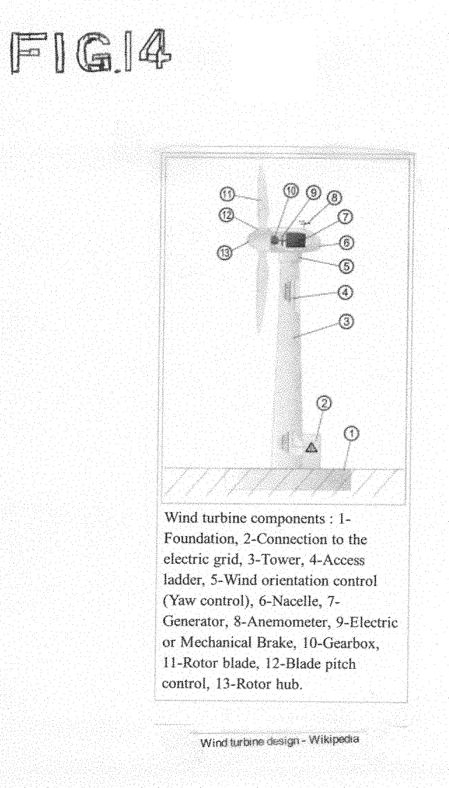

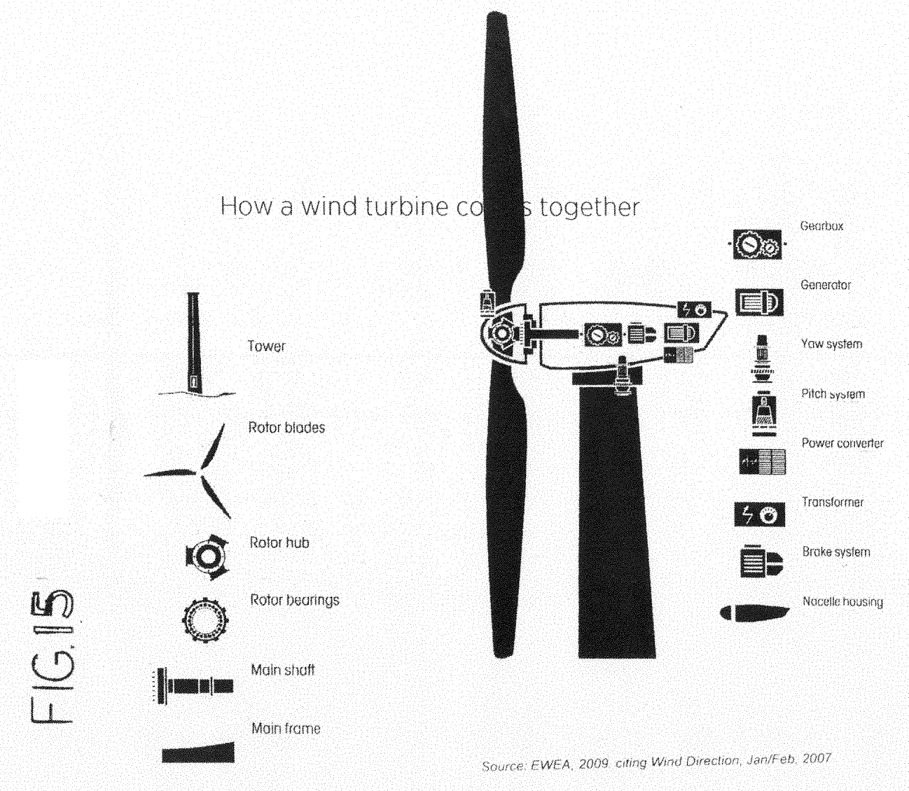

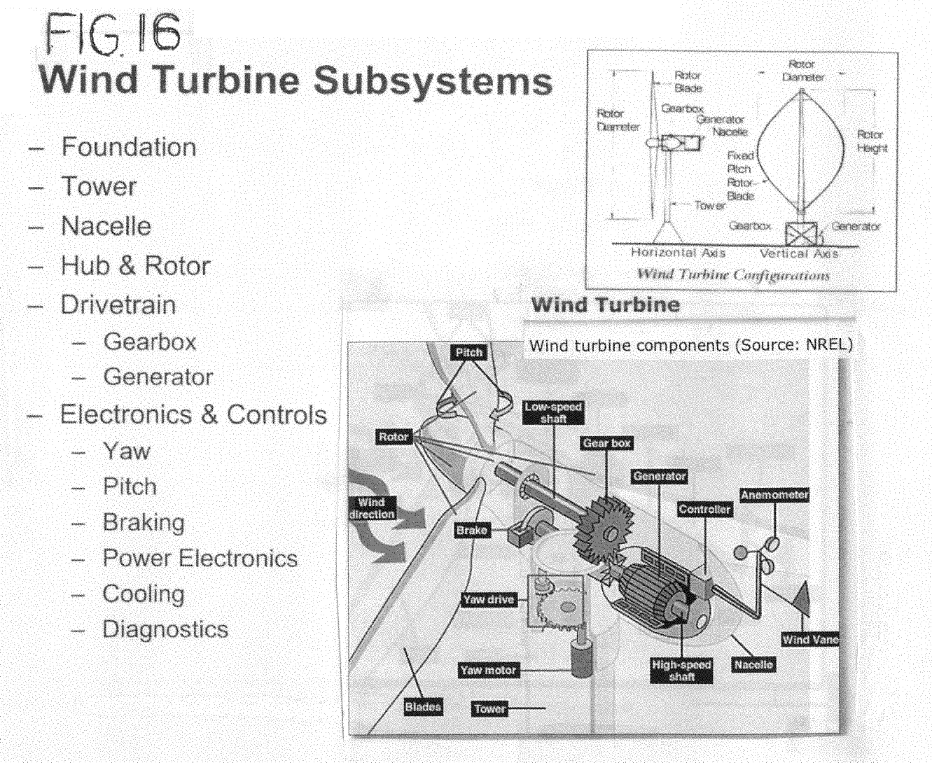

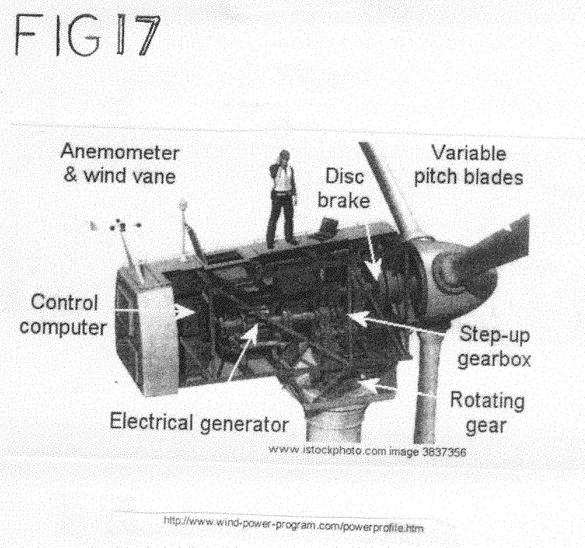

### DETAILED DESCRIPTIONS OF THE INVENTION

This Applies for All Wind Sail Turbines (HWB 1s) (HWB 2s) (HWB 3s) This is the basic mechanical apparatus and structure necessary for the following wind turbines to operate. All designs are comprised of components, structure, and smart controls used in current industrial wind turbines. The parts, exact design, and smart controls have endless need for variance and configurations. The following description is to be a defined term throughout this document, “WTOP”, Wind Turbine Operational Parts. These parts generally comprise a wind turbine, these parts and/or any other parts may be used or eliminated. It is impossible to foresee or name all parts, and/or sub-parts. Advancements and/or advisability may eliminate, and/or combine, and/or replaced any part(s). WTOP applies to all wind turbines but with adaptations and changes to orientations as needed. HAWTs generally have many parts horizontally located in the nacelle. VAWTS would likely have many parts oriented vertically in the tower or within the foundation or other attached structure. Producing power by a reorientation of rotating force through any device or means such as a transaxle etc. is included without limitation.

“WTOP” is defined as follows. There is a ground or sea floor foundation, a foundation (supporting structure on a barge, ship, moving structure on the ground, water body, or in air, that a tower may extends from. Near or in the bottom of the tower, an electrical grid connector. The tower has a ladder and/or stairs and/or an elevator, A Wind Orientation Control (Yaw Control—typically consists of Yaw Motor and Yaw Gears) is usually located between the tower and nacelle in what is called the main frame that is rotated by the Wind Orientation Control with the nacelle above and attached to the main frame. If there are cantilevering supports that run from the tower to the nacelle, then the Wind Orientation Control may be differently located on the tower. The Wind Orientation Control may be below support(s) running from the tower to the nacelle, rotating the upper portion of the tower and/or the nacelle together. Designs could have only the nacelle and the supports to the nacelle rotate with the tower built for the independent rotation of the supports. If the Wind Orientation Control is located other than at is typical location, then what is called the main frame maybe lower in the tower or it may be considered another main frame but the main frame is thought of the structure that holds what is above it, that is typically rotated. The nacelle could cantilever the sail hub far enough out, based on the nacelle's own strength from attachment to the tower alone. This is all variable based on size, weight, and force on and of the sails and their supporting structures. Sails may have very low weight for their relative size easing the amount of strength needed for cantilevering. The nacelle as described here is generally thought of in a HAWT where the nacelle sits above the tower. The nacelle likely contains a generator, power converter, transformer, and usually the computer smart controls. Back-up batteries may be in the nacelle. As you go from the generator towards the sail (rotor) hub there is a high-speed shaft from the generator with an electrical or mechanical brake on the high-speed shaft, and then the high-speed shaft enters the gearbox (wind turbines can be built with a magnetic gearbox or without a gearbox and all possibilities are included such as the use of pulley and belt arrangements of any nature and/or any means to accomplish proper rotational speeds without limitation), and from the gearbox is a low-speed shaft (main shaft) that runs to the sail (rotor) hub where the sails attaches likely with the use arm but the sails do not have to have a part called an arm but the sails have to be attach at the rotor (sail) hub. The sails' pitch controls will also be located at the sail (rotor) hub. There may be servo motors, any type of motor, hydraulics, and any mechanical devices of any type located in, on, or around the sails and/or sails' structures to facilitate any movement of the sails or flaps. Spring adjusted, hydraulic adjusted, any type engine adjusted, and/or otherwise adjusted mechanical mechanisms in, on, or around the sails to enhance performance and/or facilitate survivability with minor or severe wind variations with and/or without the loss of electrical and/or hydraulic and/or other mechanical loss and/or loss of computer smart controls and/or loss of human control. A wind vane and anemometer are usually located above the nacelle. Due to the increased power of these wind turbines, using pulleys and belts like at nuclear power plants etc. is a consideration, even if it creates less compact configurations that are less lined up. The same information applies to VAWT designs but with the obvious adaptations. VAWTs sails do not require being faced toward the wind, so there is no Wind Orientation Control. A VAWT has no nacelle or what is considered by this document to be a formal nacelle, so the parts that would typically comprise the nacelle in a HAWT would be typically expected to be found configured vertically in the tower or possibly partly in the foundation and/or associated structure(s). The sails likely attach to arms that attach through a rotor (sail) to the low speed shaft (main shaft) and the sails may be allowed to rotate around the tower in either direction. The wind vane and anemometer may be located above the tower or anywhere. Adaptations necessary for the Henry Wind Buster 1s are different since their sail movements are linear. There is no nacelle as such, the weather vane and anemometer will need to be in any location that reads accurately for the wind turbine. The linear movement of the sail(s) need to be converted to rotational force. Henry Wind Buster Is would be comprised of many of the same parts as typical wind turbine but any other parts as needed such as tracks, wheels (gears, bearing, rollers, round discs, conveyors etc.), floors, walls, ceilings, front and back enclosures need to be included are without limitation. Sails are moved back and forth on a platform and/or what may be thought of as a platform. Any mechanical means can be used to convert the linear movement to rotational power. Some of the parts to harness the energy may be located under, above, to the sides, in front of, or behind their platforms and/or what may be thought of as being their platforms. The sails are held up to catch wind and allowed to move downwind by any means. The linear power is transferred to a low speed shaft (main shaft) by any mechanical means. This linear power could be transferred by chains and sprockets, gear arrangements, belts and pulleys, conveyors of any type, or any other mechanical means and/or combination of mechanical means without limitation. The sails linear movement can by round discs, wheels, gears, rollers, tracks and/or any suitable device or devices of any nature or any combination of devices and methods to produce rotation to the low speed shaft(s) and/or main shaft(s). The power of these linear sail machines is massive (very roughly up to 50 times more energy producing) than current conventional industrial HAWTs in the same wind path, so engineering difficulties of any type to include for 1 example having any number of 1 or more generators in fixed locations or in movable locations such as but not limited to moving with the sails justifies any engineering. Generators could move with the sails and send the electricity by brushes or any technique. If a sail had wheels or gears etc. at opposite sides of the wind path that carried the sail downwind and upwind, and between the wheels or gears or whatever mechanical devices the sail are rolling on, there was a main shaft affixed in any way by any means that ran between those rolling devices or whatever type of devices are used without limitation and as part of the main shaft there are the parts necessary could be one way for the generator(s') set up to produce electricity. This would be one option that is simple to use since the parts' configuration would not be unlike what is in a nacelle. The power could be fed from both sides into the generator or generators that would move along with the sails. In addition to sails producing energy going downwind, sails require energy to bring the sail(s) upwind by any mechanical means and/or combination of mechanical means, and this could be done by separate motors and/or hydraulics and/or by the generators being used as electrical motors for this function without limitation. Henry Wind Buster 1s may use pivoting/rotating type movements or any movement and this can be accomplished by any mechanical means without limitation and it is expected that that process may produce energy, and/or be neutral on energy usage, and/or require energy usage and this may vary based on variables like wind etc. without limitation. Wind can be funneled or deflected by any structure from anywhere to add power. Shielding or blocking for sail(s) by any structure may come from the deflection or funneling and/or be separate to aid sails being brought upwind or for any purpose including while sail(s) are traveling downwind or being protected. Deflecting, shielding and blocking wind alone and/or in combination with any other method can be used in bringing a sail upwind. Deflecting and/or funneling and/or shielding and/or blocking may come from any part or aspect of the operation of other wind turbine(s). Sails are included in WTOP of this patent since sails are critical to all these designs and sails can be of any nature in anyway on any level without limitation. A segmented sail would generally have many segments but 1 segment for purposes of this patent is still segmented. The following are possibilities for sails but every other possibility is intended and included without limitation. Sails include use with Wind (any gas flow and/or any fluid flow) Sail Turbines, sails, rotor blades (sails) or wings (sails) can be and/or cannot be, and/or have and/or not have, any thickness, cantilevered away from the tower, material, shape, layered, multi-complex layered with any arrangement and types of layers, weight, size, structure, kind, use any type of smart control(s), computer(s), using spring(s), servo motor(s), electrical motor(s) of all types, any type motor(s), any type of engine(s), any type of electronics, any hydraulics, adjustable in any way, strength, folding, any method and design with or without controls to add any feature or attribute including survivability etc. without limitation, partially folding, contracting, overlapping, self-closing, self-opening, self-furling, furling, self-rolling up, self-rolling out, self-stalling, folding, variable folding, expanding, opening, solid, segmented in any way, louvered in anyway and for every purpose, supported by any structure, single layered, multi-layered, transparent, translucent, any color, any colors, composite, heated, jerk, vibrate, move in any way, controlled by smart controls, flexible, soft, hard, curved, bended, straight, having composite shapes, adjusting shapes, bended, bendable, spring loaded, adjustable spring loaded, energy field(s), baffle(s), adjustable baffle(s), vent(s), adjustable vent(s), use deflector(s), use funnel(s), enclosed, partially enclosed, positioned to catch more wind, positioned to spill wind, very small, enormous, any size, cloth, nylon, carbon fiber, polyester, cotton, hemp, polymer, any metal, plastic, glass, aramids, or any material(s) without limitation, with hinges, fold like accordion, fold like a fin on a window air conditioner, collapsible, one or more slopes, with curve(s), angle(s), attachments, secure at any points in any way, catch any portion of wind, any texture, purge valve(s)—automatic or controlled or non-controlled, textured, any type of sail safety device(s) of any type, using any mechanical, electrical, hydraulic motors(s), equipment(s), or device(s), safety valve(s), safety louvre(s) etc., (flap(s) of any type to catch wind or spill wind or for any purpose, flap(s) of any nature, located on the front and/or back edge, located in any number, in and/or on any location, on any side or part of the sail or sail structure, and flaps and/or parts that act as flaps may be located on any structure not considered a part and/or indirect part of the sail for every possible reason to include safety, power, stability, survivability, and every other purpose that any device associated with sails including the sail(s) themselves have ever been used or reasonably would be contemplated to be used without limitation to include any other item or property of any nature that could have been reasonably related to sail(s) and their associated structure(s) without limitation) and also sail(s) can be segmented in any way, and sails where applicable may have any number of rows of sails whose sail(s) are segmented and/or not segmented without limitation and everything is without limitation and WTOP parts include all the parts to make any of these patented designs stackable since due to the massive increased power of these designs, added costs to build to be ready to stack at a later time and/or to currently stack wind turbines vertically is included without exception or limitation and these Wind Sail Turbines may share any parts without limitation were helpful and WTOP further includes all parts to add harnessing and using solar energy in anyway on and/or in and/or associated with these designs and attaching imitation birds of prey etc. to keep birds away is included and the obvious and/or non-obvious use of structures, parts, devices, designs, elements, and smart controls mentioned in any part of this entire patent document and any associated material is to be included where reasonable in WTOP without exception or limitation.

### Henry Wind Buster 1

Today's HAWTs are of a 2-dimensional nature. The rotor blades swing through a large area that has height and width but less depth, this depth is the direction running with the wind. Henry Wind Buster 1s, 2s, and 3s (3s to a lesser extent) utilize depth. Henry Wind Buster 1s work as follows. The sail is in any way oriented so only its thin edge is facing wind. Then move this upwind sail edge by any mechanical means likely either to the right or left or up or down but in between movements are possible depending on the chosen sail orientation. The sail pivots 90 degrees so its large sail face is catching the wind. The sail tracks a distance downwind with energy being harvested. The sail edge is stopped or slowed, and the sail pivots 90 degrees so only the sail's thin edge faces the wind maximally minimizing wind resistance and the sail by any mechanical means moved upwind and the process repeats. Smart controls and the use of energy for upwind movement and assisting in pivoting etc. is expected. The platform needs to rotate. The sail track may have side(s), and/or bottom and/or top and/or any fixed or adjustable in any way structures, and may have front and/or backs that can be closed or opened. The use of multiple sails would allow for a sail to more always be catching wind. Henry Wind Buster 1s could share platforms and/or sides and be built reversible in any way for any purpose. They could be built small to enormous. They could spill wind or let wind pass through to handle any circumstance.

Sail(s) could be built as louvre(s), like a louvered door or window (louvre is to include any mechanism, approach, or means to stop wind by sail(s) and then allow wind to pass through the sail(s)). The sail(s)' louvres could be adjustable as to how open or closed they are. Instead of pivoting the sail in the previous paragraph, the opening and closing of the louvres is pivoting the sails, just with the sails being in smaller louvered sail segments. The sail with its louvres closed is sailed downwind from its upwind position while energy is harvested. When the sail finishes its downwind movement, the louvres are opened and the sail is mechanically with the use of energy moved upwind. Energy is required to bring the sail upwind. A louvre usually has many segments but down to a single segment (a sail) is to be considered a louvre in this patent.

This same louvered approach using 2 sails has the advantage of continuous or near continuous energy production. For example, use 2 sails with their downwind sail paths, one in front of the other. 1 sail is the furthest upwind (sail #1) on the same wind path, the other sail (sail #2) is a distance downwind in the same wind path but with its own separate section further downwind in the same wind path. We close the louvres on sail #1 and the sail travels downwind having energy harvested and its louvres are opened as it approaches sail #2 at the end of sail #1's downwind portion of the wind track. Sail #2 with its louvres closed heads downwind on its portion of the downwind track from wind blowing through sail #1 on its portion of the wind track while having energy harvested until the end of its wind path track and at the same time while this was occurring Sail #1 with its louvres open was moved back to its upwind position using required energy. Sail #1, now closes it louvres and heads downwind while at the same time sail #2 's louvres are opened and it is mechanically taken upwind using energy, so sail #2 will be in its upwind position to have its louvres closed and start its downwind travel again once sail #1 has finished going downwind and opens its louvres and is headed back upwind. The process repeats and repeats and one sail is almost always catching wind. A link to an animation titled, Video 4 Platform Short, animates the sails' movements clearly. This has been described with the sails approaching and separating from each other with one sail heading upwind while the other sail is going downwind, each using separate parts of same wind path with one sail just in a more upwind position than the other sail. The example could be changed where each sail fully tracks upwind and downwind in the same wind path but where the upwind segmented sail is oriented such that it passes through the segmented downwind sail.

The movements of the sails in the first paragraph of this section uses pivoting, and in the second paragraph louvres are rotated. Pivoting and rotating the sail itself as used in both paragraphs accomplish the same general sail orientation, and in all cases either pivoting or rotating can be used alone or in any combination with each other from any point on the sail and in any angular direction so the sail(s) catch the wind and minimize catching the wind and partially catching wind is included since that is useful in different wind conditions, such as handling high winds and/or providing stability.

### Henry Wind Buster 2s

The Henry Wind Buster 2s work with and against the wind and can be vertical axis or horizontal axis wind turbines. As a vertical axis wind turbine (VAWT), the tower need not rotate and sails can rotate either direction. For example, one sail has its sail face perpendicular to the ground and its thin edge upwind, pointing directly into the wind. The sail moved right or left will catch wind and move downwind. A sail on the opposite side of the axis has had its sail face made parallel to the ground to come upwind causing minimal wind resistance. After roughly a 180-degree rotation around the axis, both sails themselves are rotated and/or pivoted by any mechanical means using energy using smart controls and this process repeats after every 180-degree rotation around the axis. Half the wind path area is used bringing the sail upwind, so it is novel for another wind turbine to use the same area for a sail coming downwind. Sails, for example, could have (sideways elongated U shapes) on the sail(s) to allow another sail to pass through itself. The sails could be built in segments so one sail could pass through another. This type of novel approach wastes much less of the wind path. Sails could if both coming upwind share space by being oriented in different planes. If 4 rows of sail were used in the last example, each row of sails would only catch wind for roughly 90 degrees of downwind travel, that 90 degrees would start roughly after roughly 45 degrees in a sail row's downwind travel and the sail itself would rotate/pivot 90 degrees after roughly 135 degrees of downwind travel to no longer catch wind. So, of the 4 rows only 1 row is positioned to catch wind while the other 3 rows have their sail(s) positioned (oriented) to minimize wind resistance. This has 3 rows not catching wind at any point versus 1 sail row in the 2-sail row example, but the sail row catching wind is catching fuller wind during its 90-degree rotation than the sail in a 2-sail design during its roughly 180 degrees of downwind travel. Sails during their downwind travel around the axis could be made to have their large sail faces be adjusted to be more perpendicular to the wind to optimize wind energy capture. Alternatively, sails could be louvered with louvres closed downwind and opened upwind. Louvres are segmented sails with their segments being rotated. Downwind sails and upwind sails can be made to operate on just one side of a turbine. This would allow fuller use of the wind path with the ability to utilize both sides of a single wind turbine for downwind energy producing sail use and the upwind necessary travel of the sail(s).

The rows of sails would have segmented sails. When you stopped the downwind path of a row of sails you would rotate the sails in the row so when brought upwind they could pass through the segmented sail heading downwind. The animation “The Future of Electricity 2 shows this design.

Another different configuration would be for sail(s) at roughly the end of their downwind 180-degree travel around the axis is the sail in approximately its furthest downwind position could be disengaged from rotating around the axis and without rotating the sail 90-degrees, move the sail by mechanical means straight upwind (keeping it with its small edge into the wind) except for any needed minor positioning to avoid the tower. At the time the sail is fully back upwind, the sail is reengaged to the low speed axis before heading downwind. This is like a Henry Wind Buster 1 but using a rotating wind sail turbine. This process avoids the need to rotate the sail or segmented sail 90-degrees or use louvered sail(s) that open and close. This method of upwind sail movement will allow wind turbines to share some of the same wind path area.

This wind turbine design as a horizontal axis wind turbine (HAWT), requires the tower to turn the axis (low speed shaft) to be perpendicular to the wind. For example, use 2 sails oriented 90 degrees differently from each other on opposite sides of the axis. Viewing the animation, “Video 5_Pit Final” will show the sails movements etc. The starting upwind sail can be made to rotate up and downwind or down and downwind. The sail in its furthest upwind position has its large sail face parallel to the ground, the sail may need to rotate up to avoid striking the tower but likely the wind turbine is built with room for the sail to rotate either up or down. After an approximate half revolution around the axis (180-degrees around the axis) the sails themselves are rotated 90 degrees so the sail going downwind catches the wind and the sail going upwind creates minimal wind resistance. After every 180-degree rotation around the axis, the operation repeats. This design can have the sail heading upwind being underground, saving on above ground space, wind path, and visual interference. This underground operation is shown in the last animation. Being partly below the ground applies to water and/or ground but creating air space in and/or beneath the water for sail rotation upwind around the axis and/or rotation of the sail itself would involve substantial structures but it saves space above ground and is less of a visual impact. Sails can be segmented and there can be any number of sail (segmented sails) rows. This adds cost and complexity but could add power. Assume 4 rows of sail(s), each row of sails in this example would only be used to catch wind for roughly 90 degrees of rotation around the axis, that 90 degrees would start roughly after 45 degrees into a sail rows downwind rotation and then the sail itself is rotated after roughly 135 degrees of travel downwind to be positioned to no longer catch wind. So, of the 4 rows only 1 row is positioned to catch wind while the other 3 rows have their sail(s) rotated to minimize wind resistance. This has 3 rows not catching at any point versus 1 sail row in the 2-sail row example, but the sail row catching wind is catching fuller wind during its 90-degree rotation than the sail in a 2-sail design during its roughly 180 degrees of downwind travel. Sails during their downwind travel around the axis could be made to have their large sail faces be adjusted to be more perpendicular to the wind to optimized wind energy capture. Alternatively, sails could be louvered with louvres closed downwind and opened upwind. Louvers are segmented sails with their segments being rotated. Downwind sails and upwind sails can be made to operate on one side of a wind turbine. This would allow for fuller use of the wind path with the ability to use both sides of a wind turbine for downwind energy producing sail use and the necessary upwind travel of the sail(s). The rows of sails would have segmented sails. When you stopped the downwind path of a row of sails you would rotate the sails in a row so when brought upwind they could pass through the segmented sail heading downwind. Wind can be deflected or funneled to downwind sail(s) and/or may come from any part of another wind turbine. Wind shields and/or wind blocks on the upwind side alone or in combination with any other means can be used to eliminate wind resistance to sail(s) on their upwind travel. Wind blocks and wind shield can be used to protect any portion of the wind turbine and sail(s). Wind shields and/or wind blocks could be from other sails and/or from other wind turbines and associated structures. Wind turbines can be made to share wind path as covered for a VAWT and adapts easily to a HAWT. The animation, “Video5_Pit Final”, shows the operation of this HAWT.

Sail(s) at roughly the end of their downwind travel could be disengaged from rotating around the axis and without rotating the sail, itself 90-degrees, move the sail by any mechanical means straight upwind (keeping it with its small edge into the wind) except for minor positioning to avoid the tower. When the sail is fully upwind, the sail is reengaged to the low speed shaft prior to moving downwind. This is like a Henry Wind Buster 1 but with a rotating Wind Sail Turbine.

### Henry Wind Buster 3s

A HAWT design using 1 to any number of sails spinning perpendicularly to the wind. These designs because of the application of the New Wind Power Formula use sails to fully occupy the wind path versus rotor blades merely spinning through the wind path. Two sails opposite each other on different sides of an axis work well, with each sail angled off the wind but on different sides of the wind. Sails are oriented to the wind the same as HAWTs using rotor blades. Provided in Appendix A and/or at the website, HenryWindBuster.com there are 1 video link to 2, operating 2 sail HWB 3 prototypes and there are 2 links to 2 animation of 2-sail design, HWB 3s. The sails are attached to the low speed shaft at a sail hub. Larger sails due to being angled may require cantilevering of the sail hub with its associated structures, so the sails avoid striking the towers and/or associated structures. Using any number of sails, like a farm type windmill (a pie shape cut into pie shape slices) is included here with the application of the New Wind Power Formula without limitation. HWB 3s may have designs that would have them look similar to farm type windmills but as explained by this entire document, in particular Claim 2, and then Claim 1, then the Background Section, and then the entire document and/or associated material. In the 2-sail prototype and animation, the inventor used perpendicular flaps around most outer edges of the sails. The 2 prototypes produced great relative power to a conventional wind turbines using rotor blades. Specifics as to flaps and/or sails design is not to be assumed. Claims and/or Preface to Claims discusses the design of sails and/or the use of flaps in more expanded detail.

### Henry Propulsion Systems

Knowing the value of using the following types of operation to increase propulsion efficiencies is very novel and included in every way on every level without limitation. This applies to all ships, boats, submarines, and all watercraft, including mixed use watercraft. Most engine watercraft use a propeller. Propellers have roughly 60 percent optimal efficiency. Jet boats and jet skis have the propeller within a housing pulling in water and expelling water. The Henry Water Propulsion System can have one or any number of shafts, arms, rods etc. that can thrust the water vehicle forward and/or backward and every way of making the following procedure happen is included without limitation.

The following is just general physical description of devices for the stated purpose, this patent assumes many ways to achieve this process and all those are included without limitation. Assume a round shafts (arm, rod etc., 6 inches in diameter and 80 feet long) or any suitable shape and size and assume a large watercraft, the shaft passes through the rear hull of the water vehicle, oriented so the shaft points port to stern and an engine(s) pulls the shaft(s) forward and then drives the shaft(s) backward. At the shaft(s) end attached two five foot by five-foot strong metal plates that are hinged together at the bow side with their faces flat against each other. The hinge(s) is fastened to the shaft. There is a plate stopper device attached to the hinge and/or shaft or the plates that allow the hinge and attached plates to open to a position to most effectively thrust the water towards the stern. As the shaft is pulled forward toward the bow, the plates, fold together minimizing resistance to the water. As thrust sternward, the plates are designed so the water will open the plates at the stern end to thrust water sternward. The plates and any associated structures could use mechanical, hydraulic, spring assisted and/or any means to achieve this general operation without limitation. Smart control technologies are included in any aspect of this power propulsion system. This system works with human feet and/or arms' powered water vehicle. Some shafts could be angled other than just front to back to aid in turning and/or be located anywhere and/or some of these propulsion systems could be designed for moving in reverse or to be capable of forward and reverse thrust. The plate(s) could be designed to return to pre-thrust position by having the plate(s) pass through the air to reduce resistance. This is a obvious technology, what makes this novel beyond the novelty it contains in its design is that it is based on the application of the New Wind Power Formula. Albert Betz had his hand in propellers and wind turbines. His theory for wind turbines has him miscalculating efficiencies 47-Fold. The inventor does not know if Albert Betz same thinking caused propellers efficiencies to be overstated, but it is reasonably likely, then this novel approach, using the same application of the New Wind Power Formula for wind turbines for propellers were applicable may be revolutionary. Thrusting water in a direction to be propelled in the opposite direction and returning the thrusting devices through water and/or water flow and/or air after orienting to minimize resistance is novel but it stems from the application of the New Wind Power Formula applied as applicable to water (any fluid, and/or any gas and/or any solid), but propellers with their compact simple rotational movement are convenient, but if it turns out that efficiencies are overstated for propellers and/or if the Betz Limit is applied incorrectly (falsely increasing practical efficiencies) and/or even if only this new system is more efficient, than with the engineering available, this propulsion system is valuable.

1: claim 1 is The application of the novel New Wind Power Formula (NWPF) which provides for more effectively using sails in Wind Sail Turbines than current conventional horizontal axis wind turbines (HAWTs) using rotor blades and/or (windmills that use sails but without the application of the NWPF resulting in very limited development), and the application of the novel NWPF provides improvement in the development, engineering, computer engineering, making, and use of rotor blades, sails, and wings which all are essentially sails that are now shown by the NWPF to operate from wind collisions and not lift, and on a purely scientific level, the application of the NWPF discovers and/or rediscovers sails (no formal claim is made to this effect) because sails are currently believed to be airfoils and the application of the NWPF shows that sails are devices that block wind and are not airfoils and work from wind collisions and not the lift (theory of pressure differentials on different sides of an airfoil) and NWPF indicates that sails must occupy the wind path versus rotor blades merely spinning through the wind path, for sails to effectively utilize wind energy which rotor blades fail to do and the application of the NWPF proves that rotor blades do not work as believed, such that a HAWT using rotor blades in an example that claims to utilize 40% of the wind energy, and counting the Betz Limit that limits wind utilization to a theoretical maximum of 59.3% of the wind energy for horizontal and/or vertical axis wind turbines, effectively making the practical efficiency claim, 67.45% (40%÷59.3%), but the application of the NWPF proves that the HAWT in this example utilizes roughly 1.5% of the wind's power and the NWPF shows that 66.67 times more wind energy exists in the wind than is being utilized in this example and on a practical level, wind turbines could utilize up to very roughly 50-Fold more wind energy, and the NWPF indicates that rotor blades, sails, and wings are not airfoils working from primarily lift and are all sails working from wind collisions and the application of NWPF disproves “Swept Area Theory” which is comprised of the error of having matter occupying more than one area (space) at one time, yet due to series of offsetting errors including errors by omission, energy output is still calculated somewhat accurately by the old Wind Power Formula, with the enormity of the errors showing only in massively overstated efficiencies, undiscovered for decades, because obscured in a complex intermingling of errors that further include the power in the wind being determined at 50% of wind's correct power, and this error of miscalculating winds' power, led to the false belief that sails, rotor blades, and wings are primarily airfoils and due to this false belief, the theory of lift (pressure differentials above and below these airfoils used sometimes with Newton's Third Law of “equal and opposite force”) were used to calculate operating results for rotor blades, sails, and wings mistaken to be airfoils, that are all just sails that work from wind collisions, and pressure differentials if they do have any impact, it is very minor, and wind collisions are the primary force and these errors occurred again because the power in the wind has been incorrectly calculated at half of its correct power, and this error of calculating the power of the wind incorrectly made it so wind collisions would not account for the power provided to the sails, and hence the theory of lift evolved that falsely created the energy that existed but was unknown to exist in the power of the wind and the error of lift offset the error of having the power in the wind at half its correct power but lift is not directly used in the old Wind Power Formula for determining energy produced by HAWTs but this error of having winds' energy at half its correct power is included in the old Wind Power Formula and causes the old Wind Power Formula error of failing to double the physical mass of wind for the purpose of being the correct energy providing mass (2×the physical mass) that must be used in a Newtonian based equation to calculate energy produced by wind and the application of the NWPF shows the error that the Betz Limit (59.3%) has zero application for wind turbines, and the application of the NWPF indicates there are 2 more errors by omission, first HAWTs lose roughly 50% power of the wind energy striking rotor blades and/or sails due to rotor blades (sails) necessary diagonal angle into the wind, and second, the rotor blades (sails) then lose roughly 50% more of the remaining power because rotor blades (sails) must rotate perpendicular to the wind (90-degrees off the wind), which is at an angle, roughly 45-degrees different than the directional force the wind pushes the rotor blades (sails) (roughly 135-degrees off the wind), and these two rough losses of 50% may vary but the use of 50% for both losses is a good starting point subject to testing in any given wind turbine in varying wind condition etc. and these 2 rough 50% losses should be reflected in C (a constant) along with the already covered elimination of the Betz Limit in C (a constant) which was the old C's (a constant's) very largest component and the application of the NWPF provides the use of nearly all new and very different inputs in the NWPF versus the current, old Wind Power Formula, and the NWPF literally changes almost every basic underpinning of current wind science and the application of the NWPF can be seen as indicating and creating a new wind science which is not a claim except to the extent it goes to novelty and the Background Section of this document is comprised of a very full and detailed explanation of the NWPF that may aid in more easily understanding the NWPF, and the NWPF and its explanation follows;
Wind Power Formula;
P=½pAv³C
is the old Wind Power Formula and
P=½pA2v³C
is the correct New Wind Power formula; Simplifies to
P=pAv³C
and the three errors in the old formula are;
1) A (area) is not determined by swept area (πR²) nor is it determined by the rotor blades area but by the area of the wind path that the rotor blades occupy as viewed completely stationary which is only approximately 6% of the swept area (πR²) and
2) The mass of wind that needs to be used in calculating wind energy is double the literal physical mass of wind in the collisions and thus, is pA2v versus pAv in the old Wind Power Formula and
3) New components need to be included in C (a constant) and the 1 main old component of C needs to be removed
and due to the entirely new determinant of A (area), using the correct energy mass for calculating wind energy which is double the literal physical mass of the wind itself that strikes, and changes to the main components of C, the same approximate wind power for current wind turbines will be calculated by the corrected New Wind Power Formula but the efficiencies of current wind turbines will be shown to be roughly 4,700% less than the old Wind Power Formula indicated and in the proof section of the Background Section, the inventor has proved that the Betz Limit has no application in wind turbines and I have proved that A (area) is not the swept area of rotor blades (πR²) but is the area of the rotor blades not in respect to themselves but the area the rotor blades occupy in the wind path, with the rotor blades viewed as stationary and “Swept area” was perhaps the largest applied physics mistake in the history and cascaded out of a series of follies partly made if not fully made by Albert Betz in 1919 and Albert Betz, a German Physicist, did not understand Frederick Lanchester's work of 4 years earlier, and likely took that work and published it, having Lanchester's work inconceivably distorted and named, the Betz Limit and Betz should have taken time to understand how the formula was derived and had Betz understood Lanchester's work these errors would not have occurred and Albert Betz for reasons that you will understand after reading the Proof section in the Background Section needed and/or wanted a number near 0.5 and the Betz Limit even though misapplied provided that approximate number (0.593) and the approximate A (area) industrial HAWT rotor blades occupy in the wind path is approximately 6% of the incorrect A (area using swept area (πR²)) and using the incorrect A versus the correct A caused the single largest error ever in applied science, a 1667% of error (100%÷6%) and this was because Betz assumed because Betz did not understand Lanchester's work, that rotor blades could sweep an area 16.67 times larger than the rotor blades occupy in the wind path and this 1667% error was largely offset by not having the mass of the wind for purposes of calculating energy yield at double wind's literal physical mass striking causing a 2-Fold error and this shows in the old formula by using pAv when the correct input is pA2v for the energy yielding mass that was needed and C (a constant) is a number that must make predicted results and actual results match up and C (a constant) is also terribly incorrect and we will cover the correct C (a constant) soon. Since C (a constant) is really a variable and is designed to be the number that will make the old Wind Power Formula have predictive results that match actual results, therefore this entire disaster is possible, since C (a constant) as you will soon see is nothing more than the efficiency factor, so the Wind Power Formula could predict power produced but C which is just the efficiency is 4,700% overclaimed, so, C does not require being verified, it is simply taken as the efficiency and was just used to compare to other wind turbines that also had their efficiencies 4,700% overclaimed and
the original derived Newtonian Equation for calculating energy in the wind, that the wind power formula is based;
E=½mv² and
since wind is a mass flow over time, the formula introduced a mass flow equation to each side of the equation. E (energy), became P, which is (joules per second) and m (mass), became a mass flow (kg per second) and
P=dE/dt=½v²dm/dt #1
and a mass flow is given by;
dm/dt=pAdx/dt
and the rate of change per distance is given by;
dx/dt=v
and we get;
dm/dt=pAv
and now substitute pAv in the equation marked #1 and you have;
P=½v²pAv
and this simplifies to;
P=½pAv³
and now introduce C (a constant), which is really a variable and which is also always the efficiency of the wind turbine and this is the current Wind Power Formula;
P=½pAv'²×C (a constant)
and this pAv that was substituted for the m (mass) is broken down as follows. The p is density and A is the area and v is the (velocity). This third v calculated over 1 second is nothing more than a dimension of the volume of the m (mass) which is the m's (mass's) depth or length as you like expressed as v. So, this third v is not changing the original Newtonian formula because it is just a dimension of a mass flow that is supposed to allow for the calculation of a flowing mass. This is an error and pA2v needed to be used and not pAv and then let us imagine that we have a section (depth or length as you prefer) of wind that has the wind's v (velocity) for 1 second as its depth (length) and for convenience let us use 12 meters per second as the v (velocity and now, please take a ruler and draw a line 12 inches long and make marks at every one-inch point along that line and if we scale every inch to be one meter, then we know that that entire 12-inch ruler length of wind (12 meters) will strike the stationary area in its path over 1 second since the wind is traveling 12 meters per second and when this 12-meter depth (length) of wind first strikes, it has 12 meters of mass and then the strikes reduce over the 1 second, the strikes has progressively less depth (length) and proportionately less mass and therefore, over each one twelfth of one second the depth (length) becomes 11 meters, 10 meters, 9 meters, 8 meters, 7 meters, 6 meters, 5 meters, 4 meters, 3 meters, 2 meters, 1 meter, and finally 0 meters and this also reduces the m (mass) proportionately as this occurs and this is precisely what is measured by mass flow creating one extra v which is a dimension that corresponds exactly with one dimension of the volume of the m (mass) since it is the depth (length) of the m (mass) and this would have the average dimension for the volume of m (mass) over that one second be 6 meters versus 12 meters for the calculation of the m (mass) since this v is the dimension used to calculate m (mass) and, however, this is not how wind works, which is not a mass flow but is a relative never ending mass flow suffering a complete stop where it strikes and during the 1 second in the last example when over each one twelfth of a second, the depth (length) and the corresponding m (mass) was reduced by a twelfth for each one twelfth of a second is not correct for wind. Harnessed wind is a continuous flow of m (mass) being fully stopped and as the reduction in depth (length) and correspondingly m (mass) was reducing as described above creating progressively less force due to less m (mass); this does not occur in wind because when wind crashes and stops when striking a rotor blade or a Wind Sail because wind at the identical velocity is coming in from behind it, filling the wind depth in completely, then these reductions in depth (length) and most importantly m (mass) do not ever occur and this keeps the force always full, so when you start at 12 meters it never reduces at all over that second and to account for this you need to double v (2v) and
we all know this intuitively since wind has continuous force and if we only had finite wind with a depth (length) of v that would last for 1 second only, then we would be fine with pAv and in that absurd example; we would not need pA2v and therefore, to describe the energy yielding mass of a continuous flowing mass to determine the collision mass, the correct mathematical description needs to be, pA2v and when a mass of wind strikes, the mass for purposes of calculating energy yield is double the literal physical mass because wind is constantly nourished and kept at full strength from its source and its source is easiest thought of as everything that is behind the point of impact at every instant and
the New Wind Power Formula is now;
P=½pA2³×C (a constant)
and which simplifies to;
P=pAv³×C (a constant)
and C (a constant) is entirely incorrect in the old Wind Power Formula and the corrected new C (a constant) eliminates the 1 main component C (a constant) in the old Wind Power Formula because in the old Wind Power Formula, the Betz Limit accounted for the vast majority of C (a constant) and started C (a constant) at 0.593 (59.3%) and using and applying the Betz Limit to C (a constant) was completely absurd because the Betz Limit has zero application for wind turbines as covered in the Proof sub-section of the Background Section and discussing C (a constant) for conventional HAWTs, this is what C (a constant) should be comprised of, in the aggregate first, C (a constant) is simply the percentage of the total wind power utilized, as a percentage of 100% of the energy in the wind path energy, now it must be known that there are inherent difficulties in trying to capture maximum wind energy and as you capture wind by having the wind collide with a rotor blade and/or sail, wind power for any number of reasons hinders itself from being fully captured, there are probably a host of subtle and not so subtle factor(s), and for a few examples of those factors are; sails angles to the wind, different shapes, different sizes, different types, different numbers, different locations, and endless possible uses flaps of different size, shapes, locations, and then how does deflected wind and/or slowed wind and/or stopped wind interfere and/or benefit new wind capture at the point of collision and at different distance from the collision, and it may boil out to being very complex and/or very simple and either way it may still be relatively easy to arrive at the near best or best techniques for wind capture without total understanding since just basic testing will provide more than sufficient results to allow for massively powerful wind turbines and fully understanding the subtle factors may take some time and at some point even just be diminishing returns and everything varies based on wind velocity and/or other factors known, to be known, and/or unknown but for purposes of this patent it is sufficient to know that perfect wind capture is not possible but incredibly more powerful wind capture is available now with the Application of the New Wind Power Formula using Wind Sail Turbines that even without perfection of wind capture, today increases energy production in the same wind path to roughly 1,000% to 5,000% of current conventional HAWTs using rotor blades, well capable of ending the fossil fuel age, and conventional HAWTs using rotor blades and HWB 3s using sails suffer the same 2 huge losses that the C (a constant) in the current Wind Power Formula unimaginably misses; there is the initial loss of wind energy of roughly 50% due to the diagonal angle of the rotor blades and/or sails into the wind and the next enormous, roughly 50% loss is because the rotor blades and/or sails must rotate perpendicular to the wind which is an angle 90 degrees off the wind which is roughly 45% of a different angle than the directional force that the wind applies to the rotor blades and/or sails which is 135 degrees off the wind, and there are all the other practical efficiency losses that all wind turbines suffer, mechanical, gearing, need to be built strong and durable, electrical etc. and this practical area of C (a constant) is obviously the same in the current Wind Power Formula and the New Wind Power Formula and HWB 1s are designed very differently than conventional HAWTs and are the most powerful Wind Turbine ever by far because HWB 1s do not suffer the two roughly 50% losses that conventional HAWTs and HWB 3s suffer and all losses of wind energy have always been thought and designed so all losses should show up in C (a constant), and C (a constant) is meant to start and should start at 100% of all wind energy in the wind path and then, C (a constant) is reduced by the (% of loss of the 100% starting wind energy) caused by all the loss factors and C (a constant) therefore is supposed to be a wind turbines' efficiencies but the current C (a constant) in the current Wind Power Formula is almost 100% incorrect, and it is literally insanity because in HAWTs, the primary wind turbine of today, C (a constant) has its dramatically largest component by far as the Betz Limit of 59.3% which has zero application in the formula and the C (a constant), then totally fails to understand and use and account for the 2 massive primary losses of wind energy in conventional HAWTs, first is a loss due to sails and/or rotor blades diagonal angularity to the wind (roughly a 50% loss) and the second loss is due to the rotor blades and/or sails having to rotate in a direction that is roughly 45 degrees different that the directional force that the wind is applying to the rotor blades and/or sails resulting in the loss of the remaining wind energy by roughly another 50% loss and Albert Betz and/or whoever is responsible for developing this current Wind Power Formula has foisted an abomination of the natural physical laws onto this applied wind science by careless work and careless assumptions having precluded the development of efficient wind turbines and knowing that losses in a wind turbines are not caused by the Betz Limit is critical since when capturing wind aggressively, negative results happen, causes other than believing the losses are due to the Betz Limit, are focused on, and when aggressively trying to catch wind with any sail design and/or structure and/or flaps may create backpressure on the sail itself and/or adjoining sails and/or sails' structures from captured wind and/or or partially expended wind and/or expended wind and the application of the NWPF provided that this is not because of the Betz Limit,
and Swept Area theory and the Betz Limit are ridiculous and fundamentally utilizing wind is done by blocking wind as much as reasonably possible consistent with whatever arrangement and/or means being used to convert and utilize the wind energy and Swept Area Theory and the Betz Limit are massive errors that has wind science currently completely lost,
and if we use the 2 roughly 50% loses previously explained to reduce C (a constant) to 0.25, that has C (a constant) at 0.25% and then C (a constant) is further reduced by other losses (need to build the wind turbine strong and durable, gearing and other mechanical losses etc.) for example of 5%, based on these factors, C (a constant) would be (0.2) and/or 20% efficiency, but that it is anything but the case, since we now know that C (a constant) is not the efficiency as it mistakenly thought to be in the old Wind Power Formula because we have shown that only 6% of the wind path A (Area) is being utilized by the rotor blades versus the 100% of the wind path A (Area) that has been believed to be utilized, so we need to take 100%÷6%=16.67, and we now know that the old Wind Power Formula thought they were utilizing 16.67 times more of the wind path than is the reality of what was being utilized, so we need to take the 20% and divide it by the 16.67 and this equates to 20%÷16.67=1.2% and this is 1.2% efficiency is the correct efficiency for current wind turbines and earlier I had said current Wind Turbines' efficiencies were 1.5%, that is simply because I did not reduce the 25% above by the 5% for general losses to 20% and if the inventor simply used the 25% without an adjustment and divided it by 16.67, it comes out to precisely 1.5% and if the inventor had used 1.2% efficiencies, wind turbine companies are overstating efficiencies by 5903% which is 59.03-Fold (70.83%÷1.2%) and to the extent that there are any errors that comprise the NWPF, claim is still made to the correct and surviving parts of the remaining applications of the NWPF without limitation and the claim for the application of the NWPF is in any way without exception or limitation and for the application of the NWPF in improving the development and/or use of sails for wind turbines, sails for sailboats and/or any craft using sails, and sails (wings) for any craft using wings without exception or limitation since now it is known that rotor blades, sails, and wings work from wind collisions and not lift and therefore these three items which are all essentially sails and everything they may be used with, benefit in development and/or usage greatly from the application of the NWPF and is part of this claim without exception or limitation. claim 2 is a dependent claim of this claim 1, and as such refers to the applications of the NWPF for HWB 3s and because of this, claim 2, refers endlessly to the application of the NWPF and adds many added points that the inventor may have missed in claim 1, so where claim 2 adds useful information of the application of the NWPF along with the entire document and associated material is included here without exception or limitation and the inventor believes that sails' shapes and/or the use of flaps of any nature and/or any size may benefit wind capture significantly, but the use of flaps and/or the shapes of sails are all variables that require testing and endless work and no specific belief as to the specific use of flaps and/or sails with the endless possible design and use variations should be inferred even if stated to the contrary elsewhere in this document and/or shown in any video/animation links provided except the claim of the application of the NWPF shows that wind must be captured by blocking the wind, not merely spinning through the wind to utilize wind and variations in sails and/or flaps of every nature that accomplish this to the extent that the capture of the wind provides net energy production which will not always be the case is included here without exception or limitation and the use of application of the NWPF is not limited to wind since its applications as expanded in the definitions section is included and the application of the NWPF is seen in Sail Turbines since Sail Turbines are now capable of easily ending the fossil fuel age and providing clean and safe energy but the application of the NWPF to sails for sail boats and wings is not as dramatic since sails and wings (now known to be sails with the application of the NWPF) are used with good efficiency but the application of the NWPF by proving the power in the wind as double frees sails for sail boats and wings from the false belief that they are airfoils working from lift, that had a false doubling effect to overcome and/or explain for the error of having the power in the wind at 50% of its power, so without this terrible hindrance of an entirely false understanding of how these 2 different type of sails work, scientists and/or engineers working with these two devices will be able to much more simply and accurately design for the desired behaviors and for example sails on sail boats thought sails work from lift and also benefit from the wind that is exhausted of the sail rearward thought to propel the sail boat forward, that exhausted wind to the extent that it adds any propulsion is minor, what that exhausted wind because of the application of the NWPF can be seen as lost wind energy that was regrettably deflected off the sail, now much of this may not be able to be avoided but to the extent that the sail had flaps that harnessed the exhausted wind, it will yield greater force against the sail that may be able to be translated into more forward power, the inventor cannot be sure how much if anything is to be gained by shapes of sails and/or flaps located in any number, of any nature, and located in any locations that more aggressively trap the wind but the application of the NWPF opens the possibilities to all designs of sails that now understand that sails work from wind collisions from wind that is doubly powerful as now believed and this will lead to very different sail development owing to the application of the NWPF and with wings, it is really the same value that the novel application of the novel NWPF brings to wings, having engineers and/or scientists know that they push the aircraft (any vehicle of any nature using wings (sails)) up (could be any direction but up is generally what is thought of) from wind collisions and not lift (pressure differentials) and this same insight from the application of the NWPF will certainly aid in many ways the development, engineering, and use of wings (sails) and the application of the NWPF that indicates the correct energy mass that must be used for wind as double its physical mass is also applicable to other continuous flows of any substance (water is important but not in any way limited to water) energy and where the novel application of the NWPF and/or parts of the application of the NWPF aids in any way any other item and/or process than the application of the NWPF to any and/or all areas that benefit from the application of the NWPF is claimed without exception or imitation.

2: The application of the New Wind Power Formula of claim 1, wherein a Wind (any gas flow, any water flow and/or fluid flow and/or expanded as wind is defined in the Definition Section of the Background Section) Sail Turbines of a novel design called Henry Wind Buster 3s (HWB 3s) are HAWTs that include using 1 to any number of sails spinning perpendicular to the wind and HWB 3s require basic mechanical apparatus and structure of WTOP (Wind Turbine Operating Parts) to operate, and WTOP is fully described at the beginning of the section, Detailed Descriptions of Inventions, and HWB 3s use the application of the NWPF (comprised of the how, why, and way of the use of sails) to use sails that more fully occupy the wind path contrasted to current conventional style HAWTs using rotor blades and/or windmills that are based and/or understood in light of the governing incorrect current wind power formula and its indication that rotor blades by merely spinning through the wind path, can effectively utilize energy from the entire wind path, as if the rotor blades were far larger than their physical size and windmills are governed and seen as severe violators of the Betz Limit which has the loss of efficiency for windmills due to violating the Betz Limit becomes more severe as speed of rotation of the sails in windmills increase and for any reason should the dependent claim of HWB 3s fail to survive and/or be limited, then the inventor reserves and/or claims the invention of the HWB 3 for all their independent novelty, and HWB 3s work great with two sails and an example of this design would be to take two rectangular sails (as in all HWB designs the sails could be incredibly tiny to enormously large), side by side each diagonal to the wind but on different sides of the wind and on opposite sides of the axis of a Wind Sail Turbine and these rectangles of sails would likely be sized so that after being angled (angle is likely adjustable), the two sails that are close together will look like a square together and with proper shaping of sails, the 2 sails could also be shaped so after being angled to the wind the sails would appear circular when viewed together and this 2 sail design is believed to likely be the best but the inventor is not sure and therefore this claim does not limit itself based on the number of sails used with a HWB 3 and includes 1 sail to any number of sails in this claim and for example using 2 sails with the sails on opposite sides of the axis with each sail angled off the wind but on different sides of the wind (sails for HWB 3s will be oriented to the wind, with the same orientations of rotor blades and sails for HAWTs with rotor blades and windmills with sails, respectively, and there is a video link to two operating 2 sail prototype in the video link titled, Henry Explainer, and there are 2 other links to 2 animations of 2-sail design, HWB 3s, both titled Henry Wind Buster 3, and all links are provided in Appendix A and/or can be viewed at the website, HenryWindBuster.com and HWB 3s because of the use of large sails that are angled, the wind turbine structure often will have to cantilever the location where sails and/or sail arms are attached to the sail (rotor) hub, so, the sails, as they rotate around the axis, the sails will not strike their towers and HWB 3s with multiple sails may look like farm type windmill (a roughly circular group of sails comprised of roughly pie shaped slices of sails) but even in this similar looking form to a windmill, HWB 3s have great novelty, and the claim of HWB 3s in all forms including when appearing similar to a windmill is included here without exception or limitation and HWB 3s include any number of sails and to talk about some huge differentiators of HWB 3s from windmills which have the consequence of expanding on the likely attributes, aspects, and/or characteristics that HWBs may and/or likely to possess and those differentiators are as follows; but before going into a more comprehensive list of differentiators that will include the same differentiators as immediately next being written about, all of the differentiators that are relevant whether located in this claim and/or anywhere in this entire document are included as well as any existing differentiators that the inventor failed to mention for any reason and/or think of and/or know for any reason without exception or limitation are all claimed that HWB 3s may and/or likely possess these attributes, characteristics and/or aspects being of any nature and/or on any level for use with and/or in HWB 3s, and HWB 3s may require significant cantilevering and tower adaptations, and/or other structures adaptations etc. that would accomplish the required cantilevering, however the need for cantilevering decreases as the number of sails used in the same given area is increased if the total area of the sails are kept the same and avoidance and/or reduction of the required cantilevering can be accomplished by the use of more sails and this would make HWB 3s look more like windmills, so establishing HWB 3s as very novel from windmills is important because of the avoidance of the need for cantilevering may be highly desirable especially in certain circumstance but this would be weighed against factors, such as the efficiencies of HWB 3s designed using 2 sails which is the highly likely choice if using a design with few sails versus the efficiencies for example of an 18 sail Wind Sail Turbine that would highly resemble a more typical windmill (at least on a basic, general visual level) and the inventor is not sure of relative wind energy utilization efficiencies of the 2 sail versus the 18 sail Wind Sail Turbine, not that that would be the only determinant of design choice but is certainly extremely important but to understand why that comparative efficiencies cannot be simply known requires a discussion of some of the types of wind reactions as wind strikes sails that might be generally expected are as follows and the inventor is not sure of wind reactions on different sail designs where the sails are very large and/or made having many smaller sails where the fewer larger sails and the more numerous smaller sails comprise the same total sail area and then consider as wind strikes a HWB 3 using the example of the less numerous and more numerous sails, the wind imparts force to the sails and a good portion of the wind deflects along the sails' faces, and depending on how large the sail face is and depending where flaps are used to contain wind along any sail face it is difficult to predict if the larger sail and/or the smaller sails will yield more energy force to the sails collectively in these different design examples, because the deflected wind runs along the sail while being struck by other new wind and it is possible that the new wind causes the wind that is deflected to change angle towards the sail and the sail captures otherwise unused deflected wind, now all of this is influenced by flaps and/or sail shapes that can be of any nature that better contain the wind and generally these thoughts lead you to believe fewer larger sails might utilize the wind better since there is more opportunity for this described reactions to take place however the inventor will mention that the inventor is not even positive that this is correct and/or the relevant detail, certainly knowing to look and find the relevant detail is what is important at this point, not having the answers to specific design issues that will need lots of routine engineering testing but these patents take wind capture up thousands of percent and these are unknowns are only mentioned to explain why the inventor does not unnecessarily and/or unwisely limit the inventor based on any assumption of what sail design may prove to be the best, no matter how much the inventor may believe the 2 sail design seems incredibly desirable and when using fewer sails there are of course a less number of sails to deal with but those fewer sails are larger if they comprise the same sail area and therefore require more strength and power to control; and to discuss some opposing science that would argue against catching more deflected wind on a longer sail as to its relative importance in sail efficiency is that on the other hand smaller sails have less wind deflecting along the sail and new wind may in essence be getting better more direct wind strikes that are not having their force hampered by as much deflected wind interfering and even smaller sails may be helped by flaps and/or sail shapes that better utilize the wind, so nothing should be assumed and testing for sail efficiency is best and to go further into wind capture by sails, with more than 2 sails there is also the issue that increases with more sails, likely made worse that as you capture wind aggressively, the deflected wind may cause back pressure on the sail itself depending on its shape and/or the use of flaps and may cause backpressure on the adjoining sail and what the inventor means by backpressure, is deflected wind, and/or compressed air that when talking about this for all one sail, this backpressure will effect a part of a sail that fights the direction that the sail is moving, and when talking about an adjoining sail, this backpressure will affect the adjoining sail from the rear of sails fighting the direction the sail is designed to rotate toward and backpressures can cause a decrease in net wind energy harvested and then to move to another issue that will souls a drop like the Betz Limit but it is anything but that since this next point has nothing to do with the amount of wind passing through a wind turbine which is inapplicable to wind capture in a Betz Limit sense but there may be an effect like this that should be tested for, which is when aggressively capturing wind with aggressive use of sails' designs and/or flaps etc., you may set it up so wind that is in front of the sail may tend to deflect some new incoming wind, causing a loss of efficiency, so the inventor claims here but applicable throughout this entire patent, that all Wind Sail Turbine designs that are used as described without the highly sophisticated sail designs will increase wind energy utilization between roughly 1,000% to 5,000% depending on which design of HWB that is used, and the sophisticated best capture of wind energy using highly sophisticated sails and/or flaps should be tested for since improvements of this nature by routine testing may add very roughly 5% to 10% to the increased 1,000% to 5,000% which is the core of this patent, although achieving those last relatively tiny increases owe themselves to the application of the NWPF that has the wind engineers and wind scientists understanding how and why sails work scientifically making this routine testing of sails owing much if not all to the application of the NWPF and best testing, needs to test using different sized and/or shaped and/or with and/or without flaps of all different shapes, sizes and angles of sails and this is best done in wind tunnels using any and all techniques to try to determine what is precisely the most relevant effects in different conditions and/or circumstances that is happening to the wind and its wind energy as it strikes differently structured sails and/or flaps and this will be a never ending work in progress to tweak sails and the inventor is has by no means claimed to have laid out the relevant details of best sail designs since that discussion could be easily expanded as to general questions and the knowing how to best capture wind in many different circumstance will initially wind up on grids and tables for general use and likely be followed from assistance by developed design formula's that will aid in design and help limit and speed testing needs, and this information about sails shows that HWB 3s (all HWB Designs) have considered all of these factors and that the more final factors of sails' and flaps, designs etc. may be quite different after testing and analysis progresses knowledge
and HWB 3s because of the application of the NWPF knows that sails and/or rotor blades are not airfoils working from lift but are all sails working from wind collisions and this error occurred because of an error of having the power in the wind calculated at 50% of its correct power, and HWB 3s because of the application of the NWPF know that rotor blades (sails) do not sweep an area cumulatively for energy which is a mainstay of current wind science and because this must have seemed to some engineers and/or scientists and/or anyone, some people working with windmills and wind turbines must have suspected “Swept Area Theory” to be false, so what is so extremely novel is to have proved and explained this and made it being known to be incorrect as possible since it is contrary to the old Wind Power Formula and by the application of the NWPF what is even more extremely novel is the all that has to be meant by the application of the NWPF, and all that has to be meant by the application of the NWPF to HWB 3s, and one extremely pivotal point that is part of the NWPF is that the inventor has proved that the power in the wind is double what is believed and without this, the old Wind Power Formula would be seen as inviolate since it did predict power output correctly endlessly for decades, so if others had contemplated that “Swept Area Theory” were false it was and would appear as somewhat meaningless since it could not be proved by formula, actually the old Wind Power Formula seemed to disprove it and without the application of the NWPF which includes calculating the power of the wind as double, this allows for the breakthroughs that rewrites almost all of what is wind science and the application of the NWPF is such a novel discovery because the NWPF's application gives what would have appeared impossible to now be seen and known, where the endlessly different and corrected science can and does entirely makes sense, and without all the pieces of the application of the NWPF, the application of partial beliefs that comprise the NWPF would not be possible and/or given any serious consideration since it would not be a complete formula, weighed against a complete formula that was predicting power correctly for decades, and isolated thoughts even when correct would just be seen and miscellaneous near valueless guesses with zero traction, and the discovery of the power in the wind being double is highly novel since it indicates for the old Wind Power Formula that rests on a Newtonian Formula that requires the mass of wind that that will strike in 1 second (a time period) for critical use in the old Wind Power Formula, and the application of the NWPF knows that for purposes of an energy formula for the energy producing mass that must be used for wind is twice the physical mass must be used as the energy mass (how this is exactly expressed can be a matter of semantics) and without this novel knowledge comprised in the NWPF which is outside any current wind science and/or basic sailing theory, this adds great novelty to the application of the NWPF since the NWPF relies on the wind having double the wind's believed power, and the NWPF is novel for many more reasons such as the old current Wind Power Formula is unaware of and misses 2, giant losses, with each loss being a staggering 50% loss, suffered by HAWTs and windmills, incorrectly uses “Swept Area Theory”, a roughly 1667% error, and the application of Betz Limit that is entirely inapplicable has the HAWTs using rotor blades and windmills using sails operating and analyzed with the inapplicable limiting false belief that only 59.3% of wind energy can be utilized due to the Betz Limit, but the inventor assumes that other people must have wondered about at least one and/or more of these issues but the incredible novelty lies in putting these issues together into the application of the NWPF which has not been done for decades with endless scientist etc. working everyday around wind turbines and/or windmills, but this is all even more extremely heightened as to the application of the NWPF's novelty because of the determination and clear proof of why the any Wind Power Formula must use twice wind's physical mass as its effective energy mass for calculating wind power, thus the NWPF formula has as part of its core, discovering wind's power as double what is believed and/or at least calculated currently in all Wind Power Formula calculations and/or accepted core wind science fundamentals, and some of what the application of the NWPF provides has to have been suspected but lacked an integrated NWPF that pulled together entirely different inputs than the old Wind Power Formula and showed a correct NWPF that made complete sense pitted against the old Wind Power Formula since it has to be remembered that the old, current Wind Power Formula predicted power output correctly for decades seemingly confirming itself every day because without the application of the New Wind Power Formula, none of this, that only in retrospect will appear as insane folly may have ever been corrected and by this the inventor means and will just use a rough number based on an example of a wind turbine claiming 75% practical efficiency with the use of the Betz Limit versus the NWPF showing the correct efficiency to be 1.5%, so, this corrects the efficiencies by 5,000% (50-Fold) (75%÷1.5%), so, what the application of the NWPF does is monumental and although the inventor is sure that endless isolated points will be able to be pointed to, that shows that some of wind science had its doubters, the NWPF's application is massively novel and totally transformative to the worldwide energy landscape and all other uses and to remember what its application does requires understanding each and every factor of the old Wind Power Formula and seeing why the old Wind Power Formula correctly indicates power outputs but overstates efficiency by roughly 5,000% (50-Fold) as used in the last example and understanding fully how the NWPF calculates the same power outputs using entirely different inputs but shows the efficiencies to be 50-Fold less than calculated with the old Wind Power Formula and what existed prior to the accomplishment of the application of the NWPF, what the application of the NWPF provides is not possible to be fully appreciate without working to grasp all that the NWPF means and is comprised of and not comprised of with all of this held in proper perspective to what surrounds versus what should have surrounded the prior state of wind turbine science and/or wind turbine science before and then compared to after the application of the NWPF and its unprecedented revolutionary importance, and the application of the NWPF requires to be fully appreciated the necessary learning of what is almost an entirely new and different wind science versus the old wind science so when the inventor talks about the application of the NWPF, it is not that the NWPF is a live teaching formula which is how the inventor must speak of it but the application of the NWPF is not a live person that can inculcate correct knowledge of wind energy principles by its existence and/or merely being read, and the application of the NWPF would be mean that a skilled scientist having gained reasonable knowledge working with wind and sails took time to understand the basis of the old Wind Power Formula but in light of what are the corrected beliefs which is still an undertaking even for someone knowledgeable in current wind science and then the NWPF would need to be studied to then be able to have an integrated knowledge of the application of the NWPF and the new wind science created around the NWPF's application and then, that person would be a person “skilled in the science and/or near science” that would understand the application of the NWPF, and this next point is obvious but needs to be said since talking about a written formula, that is just writing and symbols on a page having so many abilities by its application, makes the inventor feel strange to ascribe active qualities associated with peoples' active human type effort ascribed to an inanimate formula on pages and for that reason the inventor says this obvious statement, and the application of the NWPF is included of course for any one since its application has massive use to whatever extent it is understood in light of past beliefs and what will be future beliefs, the application of the NWPF is of a revolutionary nature, best but not exclusively appreciated by those people that have taken the time and effort to appreciate the before and after of the application of the NWPF in its full context and what the application of the NWPF fully encompasses, and for the reasons provided windmills and/or wind turbines using rotor blades cannot be extrapolated into Wind Sail Turbines that are capable of ending the fossil fuel age because HWB 3s are extremely novel because of the application of the New Wind Power Formula (NWPF) and for many more reasons HWB 3s are novel Wind Sail Inventions and the inventor will expand with the following other differentiators of HWB 3s that include differentiators already mentioned in this claim and/or mentioned anywhere in this entire document that indicate HWB 3s as not being extrapolation of windmills into a HWB 3s and all of these differentiators provided are not to be considered a complete list and the right to all reasons within and/or outside this patent document where legally allowed that differentiate HWB 3s from windmills and/or wind turbines using rotor blades are included without exception or limitation and this necessity and/or intended benefit of this attention to differentiators that provide light on HWB 3s in every way without exception or limitation is because HWB 3s have visual and operating similarities to windmills, so, to show HWB 3s' novelty, going as in depth as reasonably possible is necessary and/or adds benefit than the inventor only providing less in depth descriptions in order to distinguish HWB 3s which are Wind Sail Turbines based on the application of the NWPF as not being extrapolations of windmills that are without the application of the NWPF and all that the NWPF entails showing HWB 3s as new Wind Sail Turbines that are defined as based on the NWPF and more confirming facts to be added to all other confirming facts to support these areas of this claim are as follows;
and first, both HWB 3s and windmills on the visual surface use what loosely seem to be sails but the sails used by HWB 3s and windmills are defined differently scientifically that being that HWB 3s employ sails that operate from wind collisions versus windmills that use sails that are believed and defined to be airfoils operating from lift and having the central basis and understanding of how and why, the primary structure of HWB 3s and windmills, sails, operate has far-reaching implications on every level for the building and operation of HWB 3s and windmills,
and second, the simplest sweeping type of proof that HWB 3s have great novelty and are differentiated as compared to windmills, is that windmills are not used for serious electricity production, as are conventional HAWTs using rotor blades which are believed to be more powerful than windmills and conventional HAWTs using rotor blades are exclusively used for serious industrial electricity production and HWB 3s produce roughly 10 to 20-Fold more electricity than conventional HAWTs with rotor blades, so globally (generally) showing the enormous difference in the use that HWB 3s will be placed into versus windmills,
and third, the application of the NWPF proves almost all of current Wind Science false and establishes a New Wind Science whether ever formally recognized or not, and without understanding all the false scientific beliefs disproved and all the new scientific knowledge that is shown and/or proved and then the need to understand the sweeping nature and full scope of the scientific advancements from the application of the NWPF as provided and explained from this document's entirety simply points overwhelmingly that an extrapolation of windmills to HWB 3s without the application of the NWPF is impossible,
and fourth, this next point has been made just earlier in the first reason but the inventor presents the same statement but more aggressively, which may open the same statement to a semantics' argument but the inventor submits the reason again in more aggressive form because it is completely true, although it will fly in the face of some people, that will be put off by an argument that states that the existence of sails defined correctly scientifically does not currently exist except on a layman's superficial basis and then to a limited degree only since it lacks the science being correct which is important even to the quality of a laymen's understanding and/or appreciation of the relevant characteristic etc. that are found in sails and even more so than laymen at least in a certain sense because experts no less than the laymen in the sense that they believe what is incorrect more firmly since it is supported by convincing science even though that science is incorrect and it is only when current science enlightens laymen and explains scientifically how sails scientifically work, that people start to misunderstand how sails operate that can rival wind scientists and wind engineers that with conviction based on formula believe and know their scientific knowledge to be solid even though the formula turns out to be completely inaccurate and based on incorrect inputs throughout the formula, so, to say sails are discovered will greatly offend sensibilities, it cannot be dismissed easily nor should it be because even if semantics deny the application of the NWPF discovering sails, this assertion is true whether formally recognized and goes incredibly strongly to the novelty of the application of the NWPF and the novel invention of HWB 3s using the application of the NWPF and this makes the discovery of the HWB 3s along with their attributes to utilize massive wind (the use in any flow is included in this entire patent without limitation) with the uses of newly discovered sails in whatever context it is framed and/or limited to in the invented HWB 3s, and this may sound overreaching but it is literally true because current wind science has for decades defined sails as airfoils that operate primarily from lift and sails in HWB 3s work from wind collisions and sails in windmills are believed to be airfoils that work from lift, so sails for HWB 3s are defined differently scientifically and are different scientific objects as such defined,
and fifth, current wind science is incorrect that sails work from lift and sails work from wind collisions but the error was made because the power in the wind has and is incorrectly determined by current science to be half of its correct power and to say this patent with the application of the NWPF discovers sails does fly in the face of thousands of years of sails being thought of correctly and being used correctly for thousands of years but sails now and for decades on a scientific level are believed incorrectly to be airfoils using primarily lift and sails are now discovered and/or rediscovered and/or modified greatly to sugar coat this point as to how and why sails are known to operate, making what they are considered to be something entirely new and it is not the inventors intent to claim the invention of sails generally but the inventor makes this point and claims the invention of sails in the context that science history will describe this but in any even as the actual scientific effects no matter how formally recognized by science history and the importance of this is at this point as a differentiator because windmills use sails and the sails are defined and believed to be airfoil working from lift, wind turbines use rotor blades, with the rotor blades defined and believed to be airfoils working from lift, and Wind Sail Turbines with sails are defined and known to work from wind collisions and knowing why and how sails and what sails are and correctly understanding the operation of sails is tied directly to the massive increase in efficiencies that may now be utilized from Wind Sail Turbines and other devices that all use sails and currently that scientific knowledge does not exist and all devices of any type and nature whether the device's common name has sail and/or any other name(s) in its name without using sails as the correct description and/or how the device essentially operates base on wind collisions against a structure to block the wind to some extent without exception or limitation which is what sails are, and sails when known as airfoils are erroneously ascribed to be airfoils working from lift, and wind turbines using rotor blades and windmills would be the most egregiously harmed from these errors versus sails on sailboats and wings being much less harmed, so, the inventor with certainty of scientific arguments could say that windmills do not use sails understood to be sails and/or windmills use sails but without the scientific knowledge that would allow the sails' value to be fully exploited as a new and useful purpose without the application of the NWPF and some of the main core of this statement is that current wind science has the power in the wind, determined and calculated to be 50% of winds correct power and windmills work from a wind science and wind turbine science that has determined and calculated wind at 50% of the wind's correct energy and this adds to the indication that an extrapolation of windmills to HWB 3s to be impossible,
and sixth, current wind engineers incorrectly believe that rotor blades can act as if physically larger than their physical size and/or with any other incorrect belief(s) that has wind engineers holding to the following incorrect belief of believing that rotor blades cumulatively sweep the area they spin within for energy and since using much smaller rotor blades are believed to be effectively sweeping the swept area and with this belief, the use of sails would be seen as unnecessary and a hindrance and all the refinements and sophistication that wind turbines using rotor blades utilize would seem entirely unwarranted and no extrapolation has or would occur,
and seventh, with wind turbines using small rotor blades that only comprise 6 to 7% of the area they spin within, wind engineers believe that as they add more and/or larger rotor blades the benefits of any added power at slower speeds is minor since at higher speeds wind engineers believe the rotor blades and their wind turbines would and are constrained by the Betz Limit (no more than 59.3% of wind energy can be utilized by wind turbines) before causing losses of efficiencies, so windmills with their large sails that are in fact no different than wide rotor blades are seen as terrible violators (walking disasters) of the Betz Limit and extrapolation of windmills using what is currently scientifically seen as unsophisticated uses of sails would never be extrapolated into Wind Sail Turbines, and Wind Sail Turbines required the application of the NWPF to know how and why Wind Sail Turbines operate and what they are and what their own power and value are and then why would windmills be extrapolated to be built to comprise all the sophisticated workings of any type and/or nature of industrial wind turbines using rotor blades,
and eighth, obtaining high speed rotation for wind turbines using rotor blades and/or windmills has always been a goal and/or partial goal since there is less needed gearing to step up the rotational speed of the low speed shaft to the high speed shaft that feeds the generator and less gearing means higher efficiencies (this type of power generation of windmills is rare if it even exists), and having windmills achieve high speed rotation of large sails has never been seriously developed and windmills are and/or would be seen as having to suffer large gearing losses to step up rotational speeds if desired and again there was not seen to be any reason to work at this extrapolation to what is routinely seen in industrial wind turbines using rotor blades since this avenue is surrounded is surrounded by real and/or perceived drawbacks, so no extrapolation of windmills to HWB 3s, Wind Sail Turbines, could and/or has ever occurred since these extrapolations are impossible without the application of the NWPF,
and ninth, using inefficient and large cumbersome sails in windmills with no benefit and terrible drawbacks for serious usage in electricity production that would mean increasing windmills sizes has not occurred and windmills have been relegated to other uses, such as pumping water and/or grinding grains, and/or recharging batteries and/or for more minor electrical needs, to supply energy to a single farm, residence, or small single commercial business use, and there is no evidence of these uses having led to any extrapolations of windmills to Wind Sail Turbines because Wind Sail Turbines require the application of the NWPF,
and tenth, wind engineers being incorrect in their beliefs as to why and how wind turbines and windmills work, prevented wind engineers from extrapolating wind turbines and/or windmills into Wind Sail Turbines without the how and why of the correct use of sails and what sails are that is provided by the application of the NWPF,
and eleventh, extrapolations of wind turbines and/or windmills because of lacking the why and how wind turbines work into Wind Sail Turbines is even more remote in respect to windmills than wind turbines using rotor blades since windmills are seen as inferior to wind turbines by wind engineers, wind scientists, and wind science,
and twelfth, more sweeping proof that extrapolations cannot occur is that in the face of severe air, water, and general environmental pollution, and after possibly trillions of dollars having been invested into alternative energy research and likely millions of people working directly or indirectly with wind turbines, such extrapolations of wind turbines and/or windmills into Wind Sail Turbines that use the application of the NWPF would have occurred if possible; indicating that the application of the NWPF is necessary for this extrapolation,
and thirteenth, it must be considered that conventional wind turbines using rotor blades have claimed efficiencies as high as 52% efficiency without the Betz Limit and verified by the US NREL, and as a practical matter when efficiencies include the Betz Limit that is dogma for current wind turbine science and wind science that states that not more than 59.3% of the wind energy can be harnessed by a wind turbine, that is a practical efficiency claim of 88% (52%÷59.3%) and this highest efficiency ever achieved was certified by the US National Research Energy Laboratory (NREL), so, as crazy at it seems, although this example has used the highest claim ever for efficiency by a wind turbine using rotor blades; even using more typical base efficiency claims of 30% to 45%, when the Betz Limit is included those efficiency claims on a practical level are 51% to 76% (30%÷59.3%) to (45%÷59.3%) respectively, so wind engineers and wind scientists knew and/or at least believed they knew they had highly efficient wind turbines, and it is only now with the application of the NWPF that we now know that those efficiencies of wind turbines are only roughly 1.5%,
and fourteenth, wind engineers in addition to believing excellent efficiencies were being achieved, wind engineers cannot know without the application of the NWPF that the efficiencies as shown in the last example were over-stated by 3400% (34-Fold) to 5867% (58.67-Fold) because efficiencies are only used to compare wind turbines to each other and the errors of efficiency claims are universally applied to all wind turbines so they have and remain unknown and can only be known and corrected by the application of the NWPF,
and fifteenth, windmills and conventional wind turbines using rotor blades employ entirely different science than Wind Sail Turbines that use the application of the NWPF and the new wind science that the application of the NWPF creates that is nearly 100% different than the old, current Wind Power Formula and the old, current wind science,
and sixteenth, another practical differentiator is when using larger sails that would accompany large windmills required for larger scale electricity production, the location of where the low speed shaft attaches to the sails at the sail (rotor) hubs), these sail (rotor) hubs often will require being significantly cantilevered away from the tower in order for the large sails that are diagonal to the wind, to not strike the tower as they rotate around the axis and the inventor has not found one example after considerable internet search of even 1 cantilevered windmill and/or wind turbine using rotor blades, so, cantilevering, although not invented, certainly as used with Wind Sail Turbines that will likely often require cantilevering, is claimed as a design differentiator for HWB 3s, Wind Sail Turbines,
and seventeenth, another indication that windmills are believed to be of lesser efficiency than conventional HAWTs using rotor blades and not even a candidate for the enormous serious and difficult work to be made larger and/or more sophisticated is that with the use of large sails on windmills, cantilevering would be needed for large sails but windmills not only never use cantilevering, windmills are actually built the opposite of having the needed cantilevering that large sails (large sails would be used in windmills if trying to produce electricity on a serious industrial and/or otherwise basis) would require towers and/or structures that would provide the necessary cantilevering, but the towers and/or structures on windmills are pyramid shaped, effectively the opposite of what would be the often needed cantilevering nature the towers and/or associated structures would often be required to have and certainly towers and/or associated structures as used with Wind Sail Turbines, HWB 3s, will likely often need to be designed for cantilevering, and the tower and/or structures being designed for cantilevering is claimed as a design differentiator likelihood necessary to have Wind Sail Turbines designed as HWB 3s and design features to provide this often required cantilevering is not found in windmills and/or at least has not been found by the inventor and if found should be rare enough to be totally discounted as existing for the purpose of showing intent for an extrapolation of a windmills to HWB 3s, and likely necessary for the same reason that any cantilevering is necessary but lacking the serious and determination of an effort to extrapolate a windmill to a Wind Sail Turbine, HWB 3s, and this indicates that windmills were never thought of being built for large sails and/or at least large sails associated with serious energy production and in fact were never built for serious electricity production anywhere remotely near the level and scope that wind turbines using rotor blades were and are used, and in Appendix C, the inventor has included information from the internet that shows Aermotor Windmill Company's history, a brochure page about American Eagle Windmills, some pages of photographs that came up when windmills were Googled, and Wikipedia information covering windmills and wind turbines by Googling and Appendix C gives a snapshot of the present state of windmills and wind turbines and Appendix C may be partially and/or fully left for any reason and now Appendix C has been left out of this document and has been expanded to 344 Pages in 5 parts that are dates as to when added and can be found in the website, HenryWindBuster.com and has been gathered there with the indent for a court if necessary at a later time to document the state of wind turbine science and wind science,
and eighteenth, for many decades to the present current wind science has believed that rotor blades merely spinning within an area of wind path can cumulatively sweep the swept area for wind energy (Swept Area Theory) and without the novel application of the New Wind Power Formula, whose application shows that sails must fully occupy the wind path area to utilize wind energy efficiently and without the application of the NWPF that indicates “Swept Area Theory” to be false, and further shows it to be false in the light of almost all new and different inputs that comprise the NWPF, giving validity as only a complete integrated working formula can offer on all fronts used by the formula, there would be and there has never been impetus to extrapolate windmills and/or the necessary knowledge to extrapolate windmills and wind turbines using rotor blades into Wind Sail Turbines, HWB 3s,
and nineteenth, the inventor knows of no windmill using 2 sails, making the 2 sail design extremely novel and claimed and likely being a very wonderful design but there is so much more to the novelty of these patented HWB 3, Wind Sail Turbines, than any specific number and/or type of sails' and/or flaps designs and that is being a product and process of the application of the New Wind Power Formula but novelty is claimed for any one and/or more of these factors and/or differentiating factors, and the 2 sails design may be the simplest and most powerful HAWT design and is claimed for all reasons without limitation but whether it turns out to be the best and/or the most powerful HAWT design is by no means a certainty, and this patent does not rely on the novelty of any limited specific designs for its novelty although it does claim novelty based on any new design claimed which are HWB 3s using any number of sails and with added emphasis a little perhaps because of the great uniqueness of the 2 sail design without exception or limitation,
and twentieth, increasing the number of sails used in a Wind Sail Turbines to more than 1 and/or 2 sails up to a very large number of sails is important to this patent because a design with many sails may be as powerful, less powerful, and/or more powerful than a 2 sail design and this is not presently known but what is known and is claimed is that with the application of the NWPF, sails must more fully occupy an area of wind path and/or as fully occupy an area of wind path as possible to maximum efficiency consistent with any other constraints and/or desires for Wind Sail Turbines and this claim recognizes that a larger number of sails in a typical fashion in a given area of wind path reduces the amount of any needed cantilevering, so a high number of sails could be of great value and benefit because it diminishes the need for cantilevering on the new Wind Sail Turbines and additionally because a higher number but smaller sails occupying the same total wind path area allows for easier modifying and retrofitting of existing wind turbines towers to use sails since they were not built with any significant cantilevering, so, the value of more sails could be very important and have much relative advantage over designs with fewer sails so that the economics and/or their power may make them the better choice for many uses, and it is the application of the NWPF that shows how and why great wind energy can be harnessed by any number of sails from 1 sail to any number of sails and after basic testing of designs using any number of sails, the best design for the suited purpose of any number of sails can be chosen in light of generated power and all other design issues, costs, etc.,
and twenty-first, generally, windmills are incredibly crude and unsophisticated contrasted with sophisticated wind turbines with rotor blades, and to evidence the seriousness given to wind turbines with rotor blades versus the greatly lesser status of crude windmills, rotor blades individually weigh up to 33 tons on a Vestas 164 for example with a diameter of 533 feet for this largest wind turbine with an amazing weight in the very rough range from only memory of 400-500 tons with extremely sophisticated mechanics, electronics, and advance smart computer controls and contrast that to all photographs of windmills that can be endlessly located on the internet and it shows that comparatively windmills are incredibly crude and unsophisticated by comparison to wind turbines with rotor blades, indicating that windmills are not seen as serious energy producers compared to wind turbines with rotor blades, so, there is the no evidence of the slightest extrapolation that had and/or would take place for windmills into Wind Sail Turbines (HWB 3s) without the application of the NWPF since it is the application of the NWPF that indicates the compelling value of the use of sails versus rotor blades contrary to all current scientific belief as supported by the old, current Wind Power Formula,
and twenty-second, when rotor blades are being designed for large wind turbine there are dozens of engineers working for months if not longer on the rotor blades' design and manufacture, and it is only now with the application of the NWPF that the entire approach of rotor blades can be seen as incorrect and prior to this awakening where would the impetus for an extrapolation of windmills to Wind Sail Turbines originate from without any compelling science and in fact compelling science to the contrary (the Betz Limit and “Swept Area Theory”, and knowing and considering that such development may cost hundreds of millions of dollars to develop over several years when sails were scientifically believed to be inferior to rotor blades as simply seen when looking at all evidence of sophisticated and/or industrial wind energy production without any exception that the inventor is aware of,
and twenty-third, when looking at a windmill, the sails and overall construction, in every instance and in every way, looks and is highly unsophisticated compared to the engineering of wind turbines using rotor blades indicating the belief that windmills are universally scientifically believed inferior in energy producing value relative to wind turbines using rotor blades but additionally the angles (pitch) of the sails on windmills, are not generally adjustable like rotor blades' angles that are adjusted (pitch control) by sophisticated mechanics using smart computer controls and this further confirms the belief that windmills are inferior to wind turbines with rotor blades and this belief of inferiority creates its own inferiority since adjustments of pitch are important to performance and this makes windmills extrapolation to HWB 3s more remote,
and twenty-fourth the sophistication of the design of the sails (complex and varied angles) is lacking on windmills hindering their value and making any extrapolation to HWB 3s more remote and to expand on this as sails and/or rotor blades are further from the axis, performance is enhanced if the diagonal angle to the wind is lessened and at the further points from the axis the sails and/or rotor blades would be more toward the direction of being perpendicular to the wind and this can be seen on large rotor blades and this type of sophistication of sail design is not known to the inventor and/or certainly is not typically bothered with windmills, making windmills extrapolation to HWB 3s, Wind Sail turbines more remote,
and twenty-fifth, the major effort for wind turbines using rotor blades has been on ever increasing size and having the rotor blades achieve greater speed and for the rotor blades to be made structurally capable of withstanding the stress from greater speed of the rotor blades, moving at speeds of 5-7 times of the speed of the wind up to roughly by memory to 180 mph and higher and these speeds are believed to greatly benefit the wind energy capture for these wind turbines and these high speed for sails are seen as totally impractical and/or at least very difficult especially since sails are believed inferior to rotor blades for energy production, along with the fact that the sails would create their own massive wind resistance and then couple these issues with the belief that there is nothing to be gained by the use of sails versus rotor blades and in fact rotor blades were and are seen as superior, so there is no impetus for extrapolation of windmills and/or wind turbines using rotor blades into Wind Sail Turbines (HWB 3s) that include the application of the NWPF for how and why they work and what sails are and for what their real efficiencies are,
and twenty-sixth, if an effort was made to control the angle of sails by mechanical means to enhance performance at different wind velocities, there would be a natural tendency to want to reduce the number of sails since it would reduce the number of controlling devices and this would lead to the need for cantilevering and windmills were built the opposite of having the required cantilevering, making extrapolation of windmills that would want to add sophistications to HWB 3s more remote,
and twenty seventh, when using more than 2 sails to occupy the entire wind path which may be desirable, wind if captured aggressively by aggressive sail shapes and/or the use of flaps on the sails, this aggressive capturing of wind which is desirable has to be considered and figured out since the capture of wind aggressively can cause backpressure on a sails own and/or adjoining sail's structure(s) and/or flaps and/or associated sails' structures decreasing power efficiency and this issue is unknown and would be naturally assumed to be from violating the Betz Limit since the Betz Limit was believed a severe weakness of windmills and blocking wind aggressively by wind turbines using small rotor blades let alone larger sails on windmills, and the Betz Limit states that wind capture efficiency diminishes as more than 59.3% of the wind passing through a HAWT is utilized, so, development in this direction of trying to utilize wind by aggressively blocking wind to utilize the wind would be seen as exacerbating with the use of more sails having more sail area and this would be seen as a great obstacle due to the violation of the Betz Limit exacerbated greatly even from minor sails' speed increases and without the application of the NWPF and to any thought to extrapolate a windmill into a Wind Sail turbines would lack all reason and/or impetus based on any existing wind science and actually quite to the contrary of all the know wind turbine science and/or wind science,
and twenty-eighth, any one of these factors show the unlikeliness for extrapolation of windmills to HWB 3s with and without the application of the NWPF but when some of these factors and/or all of these factors are taken together, they indicate that it is impossible for windmills and/or wind turbines using rotor blades to be extrapolated into HWB 3s (a type of Wind Sail Turbine Designs),
and twenty-ninth, if windmills could have been extrapolated into HWB 3s (Wind Sail Turbines) that are 10 to 20 fold more powerful than current wind turbines with rotor blades when capacity, and this massive potential power with sails has been continuously exploitable for decades accompanied by the needed technologies to easily and readily accomplish this progress but this progress has not occurred because of lacking the application of the NWPF, so the potential for this extrapolation of windmills and/or wind turbines using rotor blades to HWB 3s has existed for decades and this length of time which has passed indicates the impossibility of such an extrapolation without the correct understanding of how and why the wind can be efficiently captured for maximum and/or optimal wind energy utilization using correctly understood sails, and these facts further indicate that an extrapolation to HWB 3s is impossible without the application of the NWPF,
and thirtieth, there are issues of best sail practices that require testing to choose best designs for different uses, but the application of the NWPF does place Wind Sail Turbines as the overall approach in knowing what is needed for effective wind capture, and to date the extrapolations of windmills to Wind Sail Turbines is not even conceivable, because the application of the NWPF shows the Betz Limit is not applicable, the somewhat opposite of the Betz Limit is what applies wherein with the application of the NWPF, in fact obstructing wind with no regard for the Betz Limit is part of maximizing wind energy capture and then optimizing wind energy capture in light of entirely different factors is what is necessary and these designs throughout this patent will capture 10-Fold to 50-Fold more power than current HAWTs using rotor blades, and the application of the NWPF ends the largest applied science error of all time that has wind science believing that merely spinning through wind with rotor blades cumulatively utilizes energy, and the application of the NWPF shows to use sails to actually occupy an area rather than merely spinning through an area to aggressively capture wind force and sails' design and/or flaps' designs can benefit from engineering and close attention to all design aspects, but the vast power of Wind Sail Turbines is due to the application of the NWPF that shows that Wind Sail Turbines using sails to more full occupy the wind path area are vastly more powerful than HAWTs using rotor blades and/or unsophisticated windmill used in the fashion windmills have been and are relegated to and/or suited to, and windmills and wind turbine science believes that windmills' sails and wind turbine rotor blades are airfoils that work from lift, with under pressure on one side of the sail and over pressure on the other side of the sail with the over pressure forcing the sail towards the lower pressure side which is generally called lift theory and now with the application of the NWPF, it is known that sails work because of wind collisions with the error of the “Theory of Lift” developing because the current Wind Power Formula and current wind science had and has the power in the wind at half of its correct power and the point here is if windmills and/or HAWTs were operating on such comprehensive misinformation how and why would and/or could windmills be extrapolated into HWB 3s, Wind Sail Turbines, and the evidence of lack of windmill development supports this conclusion, and further the high efficiency claims by the wind turbine companies and their wind engineers further would lead to non-extrapolation of windmills to HWB 3s, Wind sail Turbines,
and thirty-first, with wind turbine companies selling hundreds of billions of dollars each year of wind turbines claiming vastly overstated (roughly 50-Fold) believed efficiencies, so, there would be tremendous corporate impetus to those companies and/or start-up competitors to extrapolate windmills and/or wind turbines into Wind Sail Turbines due to the enormous value, so if an extrapolation were possible there is tremendous incentive since sales of product with massively more energy production should be of great value,
and thirty-second, an extrapolation of windmills versus wind turbines into Wind Sail Turbines is even more far-fetched since windmills are seen as very inferior to wind turbines by wind engineers based on the firmest scientific beliefs of current wind science (Betz Limit and/or “Swept Area theory”) and these false beliefs show that no extrapolation of windmills into Wind Sail Turbine would and/or could occur, actually all of wind science pointed totally against such extrapolation of windmills because windmills are seen as crude, with big sails, whose sails were and are seen as violators of the Betz Limit often even when their sails were barely let alone spinning fast in strong wind which has and is always been known as the most valuable wind exponentially, and windmills were using sails entirely unnecessarily with always looming terrible negative consequences of the Betz Limit present when rotor blades are believed to do the job far better and be more efficient and with incredibly less potential for violating the Betz Limit,
and thirty-third, a huge emphasis of HAWTs has been high speed rotation of the rotor blades to achieve great speed and to avoid gearing losses by reducing the need to step up rotational speed by having the high speed of rotor blades and the resulting faster rotation, and windmills with large clunky sails would appear as prehistoric nightmares to wind engineers that believed they already had the near perfect HAWTs so there is not any impetus and/or evidence and/or a result of any extrapolation of windmills into Wind Sail Turbines,
and thirty-fourth, sails were seen as airfoils as were rotor blades, operating due to lift, and lift is proved false by the application of the NWPF, so all wind turbines and windmills were operating under completely incorrect science making any extrapolation to Wind Sail Turbines working from the application of the NWPF impossible,
and thirty-fifth, the cost of electricity produced using Wind Sail Turbines may reduce electricity cost to roughly 20% to 4% of the current dollar for dollar cost of electricity from all other sources without attributing any cost to carbon pollution etc., so, if there was the slightest scientifically supported belief that wind turbines and/or windmills could be extrapolated into Wind Sail Turbines, the social and governmental funding would have poured into any remotely seen and/or perceived extrapolation, let alone the corporate interests of start-up wind turbine companies etc. that would have wanted to be on the forefront of a disruptive technology, so incentive has never lacked if an extrapolation was possible,
and thirty-sixth, for the inventor to be able to dismantle the current Wind Power Formula that has been dogma for nine decades based on inventor's beliefs only and not supported by any present science to be found anywhere that would provide any impetus to such an effort by the inventor and then, the inventor without any previous science to support his approach had to deconstruct the old Wind Power Formula with a total integrated understanding of that deconstruction process if any chance to create something from that deconstruction was to come required considerable knowledge of sails and sailing and basic science and physics that the inventor fortuitously had and then the same factors were necessary in order for the inventor to have the remotest chance of constructing a New Wind Power Formula (NWPF) from entirely different inputs and most all scientists would never venture into the very basics of a science that has been believed fully formed and with most all the ground of the science assumed taken decades earlier and endlessly used for decades with results believed to be correct for decades and is considered the basis for a time tested wind science using the decades old Wind Power Formula, having universally been used by wind engineers' and stood the test of time and endless use for decades and there is no evidence and/or result of wind engineers even conceiving, considering, and/or extrapolating windmills and/or HAWTs using rotor blades to Wind Sail Turbines on any level, anywhere, known to the inventor, and the application of the NWPF disproves “Swept Area Theory”, a 16.67-fold error of a main component of the old, current Wind Power Formula, and it disproves the Betz limit that is a main component of the current wind power formula (a 59.3% error), and the NWPF disproves the calculation of the power in the wind, an error of having the wind power calculated at 50% of its correct value and being an integral component of the current wind power formula, and then the application of the NWPF proves there are 2 successive 50% errors in the current wind power formula that occur by omission for HAWTs; the first of these 50% errors is that it is necessary to reduce the wind force utilized by rotor blades and/or sails by roughly 50% because rotor blades and/or sails are generally diagonal to the wind, and the second 50% loss is because the wind pushes on the rotor blades and/or sails at an angle that is 45° different than the angle that the sails and/or rotor blades have to rotate, and as if these errors are not enough to confuse things, there is the error of incorrectly scientifically believing sails and/or rotor blades and/or wings are airfoils and work from lift and this use of lift is a distortion of Bernoulli's original theory of lift and using lift this way was never intended by Bernoulli, and resulted to find a reason and/or means to double the effect of the power of the wind, because of the error of calculating the power of the wind as being 50% of what the correct power in the wind is, and when you take anyone of these massive errors and/or you use any number of the errors, and/or use all the errors, the science is incorrect in every way to the tune of unimaginable scope and/or level and in light of this, how would wind turbines and/or windmills be extrapolated into HWB 3s, Wind Sail Turbines, because that requires the application of the NWPF, and again when viewing wind turbines and the level of engineering and sophistication that wind turbines using rotor blades employ versus crude windmills with sails, it makes it abundantly clear that windmills are seen as inferior wind energy producing devices compared to wind turbines using rotor blades and this is seen in the use of windmills when you look at the mechanical sophistication of the gearing arrangements and/or the sophistication of the generator(s) and/or all of the electronics etc. and if windmills even have some of the sophisticated parts and processes found on a wind turbine with rotor blades, it is like comparing a modern race car to a buggy hitched to an old donkey, and/or that is what the inventor has concluded from exhaustive internet searches and for any and/or some and/or all of the reasons that comprise the claim of the novelty of HWB 3s, Wind Sail Turbine Designs, with and/or without the application of the NWPF, HWB 3s are distinguished as a highly novel, and further to take a windmill and make their sails much larger, the sails potentially adjustable, making them more efficient at capturing wind under varying conditions, and adding the endless mechanical engineering and smart computer controls would be very expensive and extremely difficult and take years to refine and this endeavor has all the science pointing to this great task being completely valueless, and the New Wind Power Formula (NWPF) is very complex and may have never been arrived at, should the inventor had not pursued a direction that was considered ridiculous by most all as to yielding worthwhile results, and any scientist and/or wind engineer would receive little if any support from the wind turbine companies they work for if in a direction that was contrary to the old Wind Power formula unless they could verify the potential for results grounded in science and this condition is oppositely in place, that the old, current Wind Power Formula has been the dogma of wind science for wind turbine science for decades and was believed and is still believed to be working well and wind science believes that wind turbines with rotor blades are already highly efficient utilizers of wind energy within the constraints of the Betz Limit that has been seen as inviolate for decades, and for the inventor, to be able to dismantle the old Wind Power Formula and to replace it with the New Wind Power Formula that has all new inputs and has many facets that are not even considered in the old current wind science, it is almost unimaginable to imagine somebody else having done this owing to specific circumstances of the inventor, and this is not the inventor bragging, because the inventor does not even believe, that the inventor could have figure out the science without good strength in understanding sails and sailing that the inventor happened to have plus a very unusually strong intuitive sense that became an unshakable belief that rotor blades do not capture any more wind when moving then when stationary in respect to the true wind and then a tireless effort with an ability to use massive time to deconstruct what amounts to the entire science of wind science and like most pursuits there was much luck along the way, and as the inventor approached this and continued to think about each necessary part of the NWPF, any one uncorrected wrong turns could have left the inventor unable to complete the work of writing the NWPF in the face of and fully against 90 years of dogma that was believed to be working since bizarrely the old current Wind Power Formula has correctly calculated verifiable proper electrical outputs for decades but very oddly (to say the least) based on massively incorrect errors that offset each other so the enormous errors of the old, current Wind Power Formula showed only in massively overstated efficiencies which went uncaught for decades until the present with the application of the NWPF because efficiencies were and are only used to compare wind turbines efficiencies, so wind turbines were for examples claiming roughly 50% to 75% efficiencies including the Betz Limit when their correct efficiencies are roughly 1.5% went unknown for decades,
and thirty-seventh, wind turbines with rotor blades are believed to be superior to windmills, and wind turbines using rotor blades due to their massively overstated efficiency claims would preclude out of the box thinking to try to improve operation since the wind turbine industry believed that they had and have highly efficient sophisticated wind turbines within the constraint of the inviolate dogma of the Betz Limit,
and thirty-eighth, the capacity of HWB 3s, is enormous compared to wind turbines using rotor blades, and capacity means how much electricity will be produced during the expected variable wind conditions that would be associated with different locations over time, and capacity is likely massively improved with HWB 3s and the value of this is enormous, so, with capacity being much better with HWB 3s, there is even more reason for an extrapolations to occur and since they did not occur it points to the impossibility of extrapolations of wind turbines and/or windmills that were believed inferior to wind turbines with rotor blades to HWB 3s without the application of the NWPF,
and thirty-ninth, windmills were never designed with any of the seriousness of industrial and/or sophisticated wind turbines using rotor blades and lacked the abilities to furl, turn their sails, so, only the tiny edge of the sail is into the wind, and they lacked the ability to stall, which is to face the large side of the sails perpendicular to the wind and these are techniques necessary to survive very high wind beyond just having the brake(s) engaged, so, without the ability to adjust the sails angles to furl and/or stall, windmills relied only on the brake(s), showing that there was no thought to build windmills much larger that would require more sophisticated planning and adjustments for survivability in sever wind events and the required adjusting the sails angles for survivability, windmill generally lacked all adjustability of sail pitch even to optimize wind energy utilization in variable winds and adjusting pitch to better utilize light winds is important but to not be adjustable as to sails' pitch to more effectively utilize the very valuable higher velocity winds is even more crucial due to the exponential value of heavy winds (wind energy in the wind increases 8-Fold as wind velocity doubles), so, windmills which had employed the same sail angle for all wind velocities at a location were and are greatly losing efficiency and again, windmills had as its only method to deal with extreme wind where survivability is to employ brakes, so, windmills, lacked all mechanical sophistications and/or all smart control sophistications needed to be used as sails are made larger to survive and/or be more efficient to justify the costs and complexities of being larger and on top of these and all other relevant factors, windmills' towers were built like skinny pyramids not allowing for longer and/or larger sails without the sails striking the tower, so, any extrapolation of windmills to Wind Sail Turbines would seem impossible and/or unwarranted without the application of the NWPF,
and fortieth, current Horizontal Axis Wind Turbines (HAWTs) with rotor blades claim efficiencies of 59% to 94% when the Betz limit of 59.3% is included (52% is the highest efficiency recorded by the US NREL (National Research Energy Laboratory), so 52%÷59.3% equals 88% and assuming a roughly 6% loss for miscellaneous losses all wind turbines suffer, roughly 94% is the believed utilized wind energy in this highest and optimal test and remember, this was accomplished using rotor blades that only occupied roughly 6-7% of the wind path when stationery, so wind engineers believe they have highly efficient HAWTs using rotor blades that sweep the Swept Area for cumulative energy, capturing a large portion of the believed utilizable wind energy using rotor blades limited to 59.3% of the utilizable energy by a HAWT using rotor blades that only partially block 6-7% of the wind path when stationery, so with these believed excellent efficiencies when wind engineers would look at a farm type windmill using many sails that blocked considerably more wind path they would see a disaster of inefficiency with the use of sails that would increase the blockage of wind energy readily beyond the Betz Limit with very minimal speed of the sails and wind engineers and wind scientists believed that the incredibly smaller rotor blades could be highly efficient at sweeping the Swept Area without violating the Betz Limit as compared to windmill with a lot of sails occupying the wind path seen as inferior, and to extrapolate for windmills to be and/or to have been developed into what this entire patent has differentiated HWB 3s to be, would take an incredible effort, undertaking, and investment and wind engineers have had and have the firm scientifically supported science based on the old, current wind science that indicates not one advantage to be gained and/or just very difficult obstacles with no reason to even consider let alone actually endeavor to overcome and even if there are bits and pieces of alternate thoughts existing, these thoughts as a practical matter are valueless without the application of the NWPF as shown by decades of non-development to more powerful HWB 3s, Wind Sail Turbines and HWB 3s cannot be developed without the application of the NWPF, because it is not just lightly that wind engineers believe current wind turbines using rotor blades are efficient, this is considered the hardest of science and to understand how hard the science that supports knowing that current wind turbines are efficient using rotor blades even though they are not, is this, for decades, and in thousands of wind turbine tests of power output and efficiency, the old Wind Power Formula was and is accurately predicting power output, and wind engineers were endlessly having the veracity of the old Wind Power Formula confirmed day in and day out, not that it was ever in doubt, since it was developed and looked at by many scientists and/or wind engineers for decades and had been and is the basis of the old, current wind science and it was never in doubt and it still is not and this belief nurtured and/or confirmed over decades by correct predicted wind turbine energy output results, endlessly, over and over, so it was impossible for wind scientists and/or wind engineers to even dream and/or suspect that the old, current Wind Power Formula was incorrect and to know to use sails when sails were seen as disasters for violating the Betz Limit without any science to indicate and/or support any other conclusion that the use of sails in HAWTs were inefficient and inferior as the inventor has previously explained, even though the efficiencies were massively overstated by the old Wind Power Formula because has not been discovered since it efficiencies were only used to compare different HAWTs to each other and this cannot be and is not discovered as yet, since the application of the NWPF at present is unaccepted and/or unknown,
and forty first, little thought has been given to the fact that sails have more wind force against the sails at slower speeds because they are not running as quickly away from the wind, which is what sailing essentially is and energy production from wind with wind turbines using rotor blades has centered on fast speeds of the rotor blades that reduce gearing losses and allow for the rotor blades to be held with their larger face more perpendicular to the wind, catching more wind that goes more effectively into the rotation because the wind acts on the rotor blades as if their large faces are more angled to the wind and these three advantages had wind engineers always working on having rotor blades that could handle and achieve more speed and be longer and less area in the wind path, and rotor blades help with this effort of more speed and even making rotor blades wider did not fit with this effort, let alone sails that would be even wider yet and more difficult in this regard to achieving speed, and of course the belief in the old, current Wind Power Formula that included the Betz Limit made sails appear entirely unsuitable even if faster speeds of sails with the great difficulties of the sails' creating more resistance could be overcome and achieved,
and forty second, farm type windmills often did not bother having sails that fully occupied the wind path, so where would the expectation of the great effort to build windmills larger when windmills sails where not even fully built most often to fully block the wind path and/or windmills seemed to be built with great variation in the amount of sails occupying the wind path, so if there was the lack of knowledge to even have a uniform design to windmills based on a firm science, why and for what reason would great effort go into an extrapolation of windmills into HWB 3s when so many obstacles existed and with all the specific known science pointing to the valueless of the endeavor,
and forty third, millions of people have worked in Wind Science with Wind Turbines with rotor blades and/or windmills for decades and the application of the New Wind Power Formula shows how and why wind turbines and what sails are and how and why sails work and that Wind Sail Turbines can produce roughly a 1,000% (10-Fold) to 5,000% (50-Fold) increased energy production from wind, (the 5,000% increased power is with HWB 1s claimed in a later claim) and prior to the application of the NWPF, extrapolations to Wind Sail Turbines did not occur showing that is impossible for HWB 3s to exist without the application of the New Wind Power Formula because the NWPF changes almost every aspect of Wind Science and wind turbine theory and really creates a New Wind Science,
and forty fourth, the major direction for decades for wind turbine development has been mechanical, electrical, computer, and software engineering improvements and making the wind turbines larger and this has yielded considerable increased power output, and this has taken great effort and focus, and wind engineers believed they were and are up to roughly 70% to 80% efficiencies with newer wind turbines using rotor blades and for those wind engineers to believe their efficiencies are instead only 1.5% and there is an energy revolution available in wind energy is something that must be proven by a formula, the NWPF, and the inventor knows this since the inventor knows that even with the proof by way of formula that it is difficult to convince wind engineers and wind scientists of something that has ostensibly worked for them for decades and is complex to indicate as horribly incorrect by the application of the NWPF and to appreciate the importance of the application of the NWPF, it must always be remembered that the old, current Wind Power Formula for all the incorrect reasons still produces correct power output without the massive errors showing except in horribly overstated efficiencies where those horribly inaccurate efficiencies remained undetected for decades since those efficiencies were only used for comparison purposes to other wind turbines using the same completely incorrect old, current Wind Power Formula,
and forty fifth, with the application of the NWPF, small windmill type designs, if they have the same level of effort applied to them as is being applied to wind turbines incorrectly using rotor blades, the value of tiny to very large windmills, once the sophistications are added, may be far more efficient than using rotor blades but this is highly complicated to be expanded on soon,
and HWB 3s using the application of the NWPF, it is likely that the 2 sail HWB 3 will be the design of choice of HWB 3s due to less sails to control and many factors, such as when aggressively capturing wind there is little negative impact from backpressure on adjoining sails, and this backpressure issue increases as the number of sails increase, but the inventor claims that a windmill type designs, that recognizes its own worth based on the application of the NWPF and has the sophistications added because its value is recognized because of the application of the NWPF, windmills are then something different that being HWB 3s, and HWB 3s in a windmill appearing form requires basic testing to establish its relative value in given circumstance compared often to the very unique 2 sail HWB 3 and again a windmill style even if it has less efficiency then a 2 sail HWB 3, it has advantages since it requires less cantilevering that adds to its value as previously covered, but a windmill type design made with the application of the NWPF and what the application of the NWPF would mean to its overall sophistication in every way and overall structure in every way without exception or limitation is included as part of the claim of application of the NWPF, wherein novel HWB 3s followed and are invented by this patent,
and forty sixth, it is the inventors hope that the inventor dwelling on the differentiators that HWB 3s have due to the application of the NWPF will not be seen as a weakness, but the inventor realizes that there is an psychological aspect to the reader that the inventor may seem to protest too much in regard to differentiating HWB 3s (Wind Sail Turbines) as not being extrapolations that could be made from farm type windmills, and/or in respect to that impression, the court should know that after a very long period of work by the inventor that this is the only issue that could possibly appear as a vulnerability and at this point no amount of effort to differentiate HWB 3s (Wind Sail Turbines) from being seen as a possible extrapolation seems unwarranted at this point since million pounds of prevention while the inventor is fully focused on every issue seems like a minimal effort compared to what work could be involved in the future if the inventor was forced to argue something that this document might have the other side not bother with if as many as possible of the arguments are presented in this patent document hoping to make this point more strong than necessary by hopefully thousands of percent, and the inventor has endlessly repeated and is out of time thankfully to not have time to correct that issue, but to the court, the inventor does not believe the inventor will fool the court with repetition knowing that the court will if need be, boil this to the more important relevant details but the inventor is out of time and this only issue the inventor sees as a concern will with all likelihood never be a litigated issue in the inventor's lifetime and/or the lifetime of the patent and other issues unforeseen will create threats as yet unknown so the inventor at this point leaves this repetition with the express hope that it will never be relevant but if it is, the inventor knows as the court knows that this will boil out and turn on issues unlikely unknown to the inventor and unfortunately the inventor has still not finished differentiating and continues and this last section of differentiating is important because the inventor feels that getting into the subtleties of wind capture may add to this differentiating and to the claim in general as to HWB 3s and here goes and it will be a lot of repeat but it does go to strongly further differentiate HWB 3s from an extrapolation of a farm type windmill and here goes again, and the reader will notice that a lot is not known but clear thinking will see that the unknown by the inventor is irrelevant to the patent, and what is important in what follows is not the answers to the questions that the inventor shows next to exist, since reasonable answers can be readily found with testing, but what is relevant is that these questions are not asked and cannot be asked of current HAWTs using rotor blades and/or farm type windmills without the application of the NWPF and this alone creates a massive novel difference between HAWTs using rotor blades and/or farm type windmills as compared to Wind Sail Turbines (HWB 3s), the 2 sail HWB 3s are likely the best design because large sails may catch wind better but on the other hand smaller sails comprising the same area of wind path as larger sails may have cleaner strikes of wind and on some levels may be more effective in utilizing wind on one of several levels known and/or likely unknown, and the inventor thinks that larger sails may prove much simpler and better at utilizing wind force but needs to stay open minded since the use of smaller sails has advantages of less need for cantilevering of the sails and old wind turbines could be more readily retrofitted with smaller sails because of this important point of needing less cantilevering of the sails and whether larger sails and/or smaller sails are more efficient at gathering wind strike energy is just the beginning of these further complicated considerations of wind energy utilization because for one example, the inventor believes that it is likely that flaps that contain wind on the sails may enhance power and it is not known what the size, shape, locations, and/or angles of the flaps may be, so their effect on utilized energy cannot be known and even the sails own characteristics of every type and nature expanded on many times in this patent are entirely variable so there is not even a fixed point to work from, so there is no knowing as yet and testing to know where relative power shakes out between a 2 Sail HAWT and let us say a 16 Sail HAWT might be one example for basic tests without considering the endless subsets of testing on sails and/or flaps that need testing, and the inventor believes that the 2 Sail HWB 3s will likely be best but that is an assumption but the inventor because of the application of the NWPF and invention of the HWB 3s knows that there are many more questions, for example, let us talk about flaps more, flaps themselves on sails cause air resistance but that effect is often small and for the moment let us ignore that, the inventor in the animations shows flaps perpendicular to the sails on the 3 more downwind sides of each of the 2 sails and in the video, there are flaps on the 4 sides of each of the 2 rectangular sails and no specific inference should be drawn to this as a prescription for exact flaps use, the inventor will say that flaps and/or the shapes of the sails themselves may tremendously boost power, but to speak about the complexity of even a basic decision of flaps would be outside what is known and to give an idea of the possibilities, in the 2 sail designs using flaps on the smaller most upwind side seems possibly unnecessary since wind is not deflected directly off that side but even that may be an oversimplification since wind may back up and run off that side as an unexpected effect of wind utilization and then what would the angle and the size of that flap be assuming this side is to have a flap, then on each sail on the 2 long sides of the sails, the inventor used flaps and had great power but the inventor believes that on the long 2 sides maybe only the half of each long side that is the side to which the sails are oriented to rotate towards should have flaps since the other portions of those sides where the inventor suggests possibly not having flaps would definitely cause backpressure fighting the rotation of the sails, so potentially the inventor was hurting the massive efficiency the inventor achieved and even if the placement of a flap creates backpressure that is negative to efficiency, it is possible that the flaps other effects overcome the negative backpressure effects to increase overall wind capture efficiencies and all these factors could vary based on wind velocity and/or other conditions sought and then all of these factors, positive and/or negative could be altered by the size, shape, and angle of the flaps and/or the sails design in any way and the inventor has not even talked about the possible use of flaps internally on the sails and how all factors would then interact, and before the inventor swirls off into literally endless possibilities whose relative importance will only be established by routine testing, the inventor reminds the readers that with no fine tuning of any of these very complex considerations, just the crude use flaps, the inventor has with the first HWB 3 prototype, made with basic flat rectangular sails produced a wind sail turbine that was 600% more powerful than any current wind turbine using rotor blades as seen in the video link found at the website, HenryWindBuster.com and called Video Explainer, and the inventor likely knows with just basic adjustment of sails angle and perhaps eliminating some of the flaps should be easily over 1000% more powerful that any existing wind turbine with rotor blades and far higher when capacity is included and that is due to the novel application of the NWPF and the very novel 2 Sail HWB 3, and without the NWPF and the HWB 3, wind turbine science has and is hopelessly lost for endless reasons endlessly covered, and then sails and/or the use of flaps become very further complicated making being sure of anything difficult except now with the application of the NWPF, it is known to ask the correct questions and know how to test and/or figure for the answers, and when using a 2 Sail HWB 3 that have the 2 sails occupy the entire wind path area except where practical space must be left, it seems to the inventor that the primary direction of deflected wind is relatively parallel with the sails large face when deflected off any one sail and this deflected wind in the 2 sail HWB 3 does not appear to be troublesome to the other sail and/or to the use of flaps on other sail and the 2 sail HWB 3s' design due to this avoidance of backpressure issue seems efficient but if you go to 3 sails that occupy the entire wind path area versus 2 sails that occupy the entire wind path area assuming all sails are roughly diagonal to the wind, if you project the trajectory of the deflected wind off of 1 sail in the 3 sail example, a good portion of the wind aims into the path of the sail that is following the sail whose deflected wind we are analyzing and this does not occur in the 2 sail design, but back to the 3 sail design that has deflected wind colliding with the rear of the following sail and even though the direction of the deflected wind is parallel to the rear face of the next sail, but even so, because the next sail is moving into the deflected wind it will be effected negatively by that wind that is still on a physics' level travelling towards it and that deflected wind will create more backpressure by striking the sail on the sail's backside than would stationery air would that was being struck, so once we increase the sails above 2 sails we get into this backpressure issue, this issue would exasperate the faster the speed that the sails are allowed to and/or made to rotate from the wind and this requires drawing this out to analyze and effectively understand, but high speed rotation has always been sought out by wind engineers so as they tried to increase rotor blade size and/or sail size they would have experienced these issues when the rotor blades and/or sails were made sufficiently large coupled with sufficient speeds that in wind turbines using rotor blades these speeds could reach 5-8 times the speed of the wind, and wind engineers without the NWPF would have to assume this issue was from the Betz Limit that wind engineers and wind scientists had no way to know had zero effect and were entirely inapplicable in wind capture, now as the number of sails are increased to let us say 16 sails and if you looked at the trajectory of the deflected wind off of 1 sail to the next following sail, you would see nearly all the wind heading into the path of the following sail, so as number of sails were and/or are increased assuming considerable amount of the wind path were occupied by sails and sufficient speed of the sails moving, this problem of backpressure worsened and was hopeless to understand without the application of the NWPF, and focusing on lift when the operable force was wind collisions has wind engineers at an insurmountable deficit, so, how much of the wind path should be occupied by windmills using 3 and/or more sails and the speed that was expected and/or planned on to be most important would need to be figured out in light of the NWPF and is not simple and is actually very complicated, and then take farm type windmills without the application of the NWPF and wind engineers hopelessly adrift in false beliefs that they fervently hold to, how and why would windmills be extrapolated into HWB 3s when none of this is known and almost entirely incorrect beliefs are the basis of wind turbine science and The Betz Limit was a blazing red light no matter which thought one might entertain about a windmill assuming thoughts were entertained in any meaningful way which is not supported be any evidence, and this crazy thought process was from the best wind engineers that had a formula that they thought was correct although it was massively incorrect, now this is not all of the problem since going back to a 16 sail design, the inventor believes the amount of wind caught to be utilized would be possibly greatly enhanced by flaps on the downwind long edge of each of the 16 sails, this flap location is likely the most important flap, but unfortunately when you are into sail designs above 2 sails and have exasperated backpressure issues as the number of sails increase than a flap on that long downwind edge and to keep going with complexity, a sail itself can create backpressure on its own sail by sail design and/or the use of flaps that has to be weighed against the advantages of catching more wind force by the flap, and this is of course becomes further complicated since the size of the flap, the shape, and the angle need to be tested to determine if benefit is indeed yielded by this flap and/or even a possible partial flap, and now there is more because assuming that a small flap helps the sail its on, we have changed the deflected wind, and the inventors best guess is the deflection would still be in the same general direction as if the flap was not there but the deflection would be for practical purposes further in front of the sail that it is being deflected off of and perhaps angled more back towards the sail that is following the sail, likely creating more backpressure, and these problems as the number of sails increase above 2 sails are formidable but sometimes easy solutions mitigate issues and/or show problems to not be as big an issue as possibly suspected, the inventor sees mitigating these issues by possible sail shape, giving up some wind path area by not fully occupying it with all sails if using more than 2 sails, perhaps not using flaps that would exasperate this problem and/or using smaller flaps, additionally in order to harness massive power the inventor believes that seeking high speeds of sail movements may not be as important as currently believed, and lower speeds does increase gearing losses by having to more step up rotational speed of the shaft that feeds the generator, but generators are designed today to need less speed which is an option based on cost and efficiency of those types of generators etc. and the inventor believes the gearing loss is incredibly minimal compared to the massive increased power of HWB 3s, and with greater speed, the outer portions of rotor blades that are further from the axis that have higher speed are able to be made flatter to the wind and therefore were struck by more of the wind path while still being effective at converting the wind energy to rotational force since the rotor blades due to their speed were impacted by the wind as if the rotor blades were more diagonal to the wind and because the outer portions of the rotor blades were flatter to the wind the rotor blades caused less resistance by their own speed and speed and this is where huge emphasis of wind turbine technology has and is going, which has had and does have wind engineers chasing after miniscule extra power and leaving most all of the power non-realized because they did not have the application of the NWPF and the novel HWB 3 designs,
and generally, sails when turning slower in a HAWT have a lot of power, since if you let sails spin fast, in essence you are allowing the sails to run away from the wind, which is how sailing works and this is true even though the sails are spinning perpendicular to the wind, the sails are still running away from the wind and losing power, so massive increased power is available to be utilized at slower speeds with sails because of the massive increased power by using sails that optimally occupy the wind path area, and other advantages that where associated with rotor blade speed includes errors relating to incorrectly believing sails work from lift, and the inventor believes it likely that the obsession with speed will disappear and those goals will be minor compared to the massive increased raw power that can comfortably be achieve at slower speeds eliminating some of the high speed engineering that may be costly and this brings us back to the application of the NWPF and not falsely believing rotor blades can cumulatively sweep the Swept Area cumulatively and seeing that sails possibly moving considerably slower may have massive increased power and using sophisticated belt and pulley arrangement may be warranted for efficiencies as an alternative to gearing but these arrangements have difficulties of being in a less linear placement that gears allow for, so, endless power and opportunity exist with probably less speed sought after and with good engineering with the application of the NWPF, to avoid negative issues and/or not create any issues, HWB 3s using more than 2 sails may be of great value, and this patent claims 1 to any # of sails used in a HWB 3s and this patent reminds all that none of these issues, questions, and invention could exist without the application of the NWPF and/or due to the novel design of HWB 3s with and/or without the application of the NWPF and we now have Wind Sail Turbines (HWB 3s) that revolutionize energy production by providing very roughly 1,000% to 2,000% more power,
and forty seventh, the reason that the application of the NWPF provides so much, is that the NWPF puts the entire wind science back on track with a formula that will predict power output from a Wind Sail Turbine with correct efficiencies and uses fundamental Newtonian Physics correctly, and the old, current Wind Power Formula violated basic Newtonian collision theory, likely perverted Bernoulli's Theories into misapplied lift theory due to pressure differentials (lift) to compensate for the old, current Wind Power Formula's error of having the power in the wind at half of what wind's correct power is and the list goes on with terrible massive more errors, so the application of the NWPF, gives the correct application for efficiently capturing wind and the application of the NWPF unlocks a totally clean, abundant, and safe energy that was not known to exist as such, as a now known as a massive utilizable energy for a very complex set of reasons that the inventor will not fully repeat again, other than to say that the old, current Wind Power Formula's horrible errors remained unknown because of the bizarre fact that it predicted power correctly but for completely incorrect reasons, yet horribly deceived and hurt wind science by totally obscuring all the enormous utilizable wind energy that is all around us,
and generally since the power of HWB 3s are relatively so increased to current wind turbines, the following are just routine items that should be given extra consideration to enhance operation to include that wind can be deflected or funneled to downwind sail(s) and/or may come from any part of another wind turbine and wind shields and/or wind blocks on the upwind side alone or in combination with any other means can be used to eliminate wind resistance to sail(s) on their upwind travel and wind blocks and wind shield can be used to protect any portion of the wind turbine and sail(s) and wind shields and/or wind blocks could be from other sails and/or from other wind turbines and associated structures and wind turbines can be made to share wind path and the animation, and generally the following are some added considerations that should always be considered for all wind turbines such as that they be built reversible, and heat from any part of the structure and/or workings should be considered for use if beneficial, and due to the massive power consideration should be given to stacking the turbines on top of each other, and they can be built tiny to enormous, and sail(s) can be of any nature covered in WTOP without limitation, and sail(s) can be built as louvre(s), like a louvered door or window (louvre is to include any mechanism, approach, and/or means to stop wind by sail(s) and/or then allow wind to pass through the sail(s)) and/or the sail(s)' louvres could be adjustable as to how open or closed they are and instead of pivoting the sails, and opening and closing of the louvres causes the same effect, just with the sails being in smaller louvered sail segments and a sail could be segmented and effectively able to act as a louvre but arguably not what looks like what is thought of as a louvre and for purposes of this patent no distinction should be made, and sail segments can by any means be positioned to spill wind and/or deflect wind in any direction and/or have the segments adjustable to allow wind to pass through itself while being deflected and/or not and/or partially deflected and sail segments can be treated differently over any part or parts of sail(s) so as to create any wind effect such as but not limited to operating in high wind and/or surviving high wind, and the use of flaps on sails located anywhere and of any nature, shape, and size without limitation should be used to assist in every aspect of wind use, and due to the massively higher efficiencies extra consideration should be given to use of these Wind Sail Turbines in many more situations from possibly being located on any type moving device/vehicle and/or craft of any nature down to be located on tiny drones or even tinier uses and made to also be gargantuan, simply due to massive increases of efficiency the use of these turbines is expected to be used in many new ways and uses that would create energy when on anything moving that is creating its own resistance that manifests as wind and for any reason is not be avoided may benefit from the use of these turbines, and the use of smart controls is of critical value and the expectation along with everything mentioned is that these turbines will work in water flows and that is full expected and included but has not been tested but there is no reason not to expect excellent operation in all types of water (fluid) flows and everything here is included without exception and/or limitation,
and Henry Wind Buster (HWB) 3s, HAWT designs, using the application of the NWPF to have sails designed to efficiently occupy the wind path area versus rotor blades and/or sails spinning through the same wind path area, believing that rotor blades and/or small sails in respect to the area they are spinning through are cumulatively utilizing wind energy is of massive importance for effectively utilizing energy in a wind path and/or believing they could violate the Betz Limit, losing efficiency, and HWB 3s are roughly 1000% to 2,000% more efficient with capacity included than what are believed to be the most efficient current conventional HAWTs using rotor blades, and the inventor has explained his use of 1,000% versus 600% explained elsewhere and HWB 3s with the novelty that is claimed using just 2 sails to occupy the entire wind path is claimed as an extremely novel design using the 2 sails, since the inventor knows of no two sail HAWT design so fully occupying the wind path and the inventor's 2 sail design that has the 2 sails totally occupying the wind path, and with proper dimensioning of the 2 sails that accounts for the range of angles that the sails may be positioned, a 2 sail design could be made to appear when viewed head on from a distance to have a total look of both sails together as a relative square and/or circle although they do not need to be limited to any shape, and the 2 sail HWB 3 may allow for the most aggressive wind capture and prove to be very most powerful and/or best design but an any numbered sail, HWB 3 with a more windmill multiple sail configuration is fully included as HWB 3s and claimed and these multiple sail designs above need to be tested for relative power ability since the more sails the less the need for cantilevering and/or the easier on some levels are the smaller sails, and a 2 sail HWB 3 or very few sail HWB 3 may be unique but 3, 4, 5, 6, or any higher number or more sail designs will also work and using more sails in a given wind path will require less cantilevering of the sail hub and associated structures than designs with fewer sails in that same given wind path and/or larger sails, so multiple smaller sails is important when cantilevering is not easily possible and/or desirable for any reason, and HWB 3s with any number of sails are now known to be given their proper value compared to rotor blade designs that have falsely claimed efficiencies that are roughly 34-Fold to 46.67-Fold overclaimed and when Wind Sail Turbines lose efficiency if when trying to aggressively capture wind, the inefficiency will lie in inherent difficulties in catching wind energy and/or sails' design, flaps” design and/or is due to backpressure on any structures associated of and/or with sails in any way without exception or limitation,

3: The application of the New Wind Power Formula of claim 1, wherein a Wind (any gas flow, any water flow and/or fluid flow and/or expanded as wind is defined in the Definition Section of the Background Section) Sail is used in any way to create energy based on the application of the NWPF that indicates vastly more energy in the wind and if moving away from what are thought of as wind turbines, sails could be used to track back and forth perpendicular to the wind across salt flats, water, and/or any location and sails could be allowed to move very long distances downwind and then brought upwind by any techniques in this entire patent and/or in all obvious ways that have sails have and are allowed to move by and all these ways are included to include for just 1 example just packaging up the sail (folding, rolling, etc. to bring the sail back up wind in any which way where wind resistance is minimized and moving the sail upwind mechanically and to then harness the wind energy going downwind and/or perpendicular back and forth movements of the sail(s) in the wind to include every conceivable direction of sail movements to include movements going up and/or down and what is important is that the application of the NWPF has made the power in the wind known to be massive as compared to what wind turbines have been and are harnessing and the application of the NWPF makes the use of all techniques patented here includable since without the application of the NWPF they would not be used to produce power,

4: Novel sail(s) movements used in the operation of sail(s) in Henry Wind Buster 1s and Henry Wind Buster 2s, and their use and the use of the word, wind, include the use in any gas flow and/or any fluid (water etc.) flow and/or and any flow of a solid and/or semi-solid and/or any combination of the flows and/or as defined in the Background Section without exception or limitation, and these novel sail(s) movement are with and against the wind and these novel sails' movements are done by a sail(s) exposing their large sail face to catch the wind while going downwind and before the sail travels back upwind, the sails themselves are rotated and/or pivoted and/or by any movement so the sail(s) are oriented such that when the sail(s) are moving and/or being moved upwind, only the sail(s)' thin edge is into the wind, minimizing resistance and the energy required for the movement of the sail(s) upwind is accomplished by or from energy from other sail(s) coming downwind and/or by the use of any other energy source, and net energy is what is sought to be utilized after all expected and needed energy uses and throughout this document in the detailed descriptions many ways are discussed in how this novel sail movement would work in Henry wind Buster 1s and Henry Wind Buster 2s, and understanding that this novel movement may be hard to visualize and/or visualize in respect to these new designs of wind turbines, there is in Appendix A, with links to animations and 1 video link, and there is given a website location, HenryWindBuster.com, where the operations of wind turbines using these novel movements of sail(s) are shown clearly and there are two animations that do not have these novel sail movements, that are more like industrial HAWTs, that will each be identified as a Henry Wind Buster 3 and this design does not have the novel movement of sails that is talked about in this claim and when the inventor wrote the 9 provisional patents and/or this document, the inventor has detailed descriptions in likely at least more than one place and if this claim is insufficient in explanation than overcoming the lacking should be easily overcome to explain and expand if necessary on this novel sail movement explained here and the entire detailed description section of this document may suffice and the inventor has given many examples of these novel sail movement in the Detailed Description of Henry Wind Buster 1s and Henry Wind Buster 2s, and the inventor is going to move those two sections into this claim and then in the claim that will immediately follow, the inventor will take sections and put those into each claim for the specific Henry Wind Buster 1s and Henry wind Buster 2s, so, now the inventor will add those entire sections just taking out the punctuation and basically putting “and” everywhere and what follows are novel sail movements described in relation to Henry Wind Buster 1s first, and it is helpful to contrast it to today's HAWTs which are more of a 2-dimensional nature where the rotor blades swing through a large area that has height and width but less depth, this depth is the direction running with the wind but Henry Wind Buster 1s, 2s, and 3s (3s to a lesser extent) utilize depth and Henry Wind Buster 1s work as follows; sail(s) is moved in any way so only the sail(s) is oriented with only the sail(s)' thin edge facing the wind and this upwind sail edge is moved by any mechanical means likely either to the right and/or left and/or up and/or down but in between movements are possible depending on the chosen sail orientation and the sail pivots 90 degrees so its large sail face is catching the wind and then the sail(s) are made to track a distance downwind with energy being harvested and then the forward sail edge is stopped or slowed, and the sail pivots and/or is moved in anyway 90 degrees so only the sail's thin edge faces the wind thereby maximally minimizing wind resistance and the sail by any mechanical means is moved upwind and the process repeats utilizing smart controls without limitation and the use of energy for upwind movement and assisting in pivoting etc. is expected and the platform also needs to rotate to orient to the wind and the sail track may have side(s), and/or bottom and/or top and/or any fixed and/or adjustable structures in any way, and may have front and/or backs that can be closed and/or opened and the use of multiple sails would allow for a sail to more always be catching wind and Henry Wind Buster 1s could share platforms and/or sides and be built reversible in any way for any purpose and the sail(s) could be built small to enormous and the sail(s) could spill wind or let wind pass through to handle any circumstance and sail(s) could be built as louvre(s), like a louvered door or window (louvre is to include any mechanism, approach, or means to stop wind by sail(s) and then allow wind to pass through the sail(s)) and the sail(s)' louvres could be adjustable as to how open or closed they are and instead of pivoting the sail previously mentioned, the opening and closing of the louvres is essentially pivoting the sails, just with the sails being in smaller louvered sail segments and the sail with its louvres closed is sailed downwind from its upwind position while energy is harvested and when the sail finishes its downwind movement, the louvres are opened and the sail is mechanically with the use of energy moved upwind and energy is required to bring the sail upwind and although a louvre usually has many segments but down to a single segment (a sail) is to be considered a louvre in this patent and this same louvered approach using 2 sails has the advantage of continuous or near continuous energy production and for example, use 2 sails with their downwind sail paths, one in front of the other and 1 sail is the furthest upwind (sail #1) on the same wind path, the other sail (sail #2) is a distance downwind in the same wind path but with its own separate section further downwind in the same wind path and we close the louvres on sail #1 and the sail travels downwind having energy harvested and its louvres are opened as it approaches sail #2 at the end of sail #1's downwind portion of the wind track and then, Sail #2 with its louvres closed heads downwind on its portion of the downwind track from wind blowing through sail #1 on its portion of the wind track while having energy harvested until the end of its wind path track and at the same time while this was occurring Sail #1 with its louvres open was moved back to its upwind position using required energy and then Sail #1, now closes it louvres and heads downwind while at the same time sail #2 's louvres are opened and it is mechanically taken upwind using energy, so sail #2 will be in its upwind position to have its louvres closed and start its downwind travel again once sail #1 has finished going downwind and opens its louvres and is headed back upwind and the process repeats and repeats and one sail is almost always catching wind and in Appendix A, there is a link to two animations with the word, Platform, in their names, where the sails' movements are shown clearly and/or the website, HenryWindBuster.com. can be gone to, to view the operation of the sail(s) in the 2 links with the word platform in the links and Henry Wind Buster 1s as discussed here in the previous 2 louvered sail example and showed in the 2 video links with the word platform in the links can be described with the sails approaching and separating from each other with one sail heading upwind while the other sail is going downwind, each using separate parts of same wind path with one sail just operating in a more upwind part of the wind path than the other sail and the example could be changed where each sail fully tracks upwind and downwind in the same entire wind path but where the upwind segmented sail is oriented such that it can pass by and/or be passed through by the segmented downwind sail heading upwind and the movements of the sails can uses pivoting, and/or louvres, that are pivoting and/or rotating the sails' segments used to accomplish the same general sail orientation as pivoting and/or rotating would for a non-segmented sail and/or a sail(s) that are not thought of as louvered, and in all cases either pivoting and/or rotating can be used alone and/or in any combination with each other from any point on the sail and in any angular direction so the sail(s) catch the wind and/or minimize catching the wind and/or (partially catching wind is included since that is useful in different wind conditions, such as handling high winds and/or providing stability), so as to achieve the desired effect.

5: Novel sail(s) movements of claim 4, wherein Henry Wind Buster 1s (HWB 1s) (their use and the use of the word, wind, include the use in any gas flow and/or any fluid (water etc.) flow and/or and any flow of a solid and/or semi-solid and/or any combination of the flows and/or as defined in the Background Section without exception or limitation), are novel designs of novel Wind Sail Turbines that use novel sail(s) movements of claim 3 to operate and HWB 3s may produce the most power of any Wind Sail Turbine and the power produced may be in the rough range of up to 50-Fold more energy producing than any conventional HAWT using rotor blades that exists currently and the reason for the extraordinary power is because unlike conventional HAWTs using rotor blades, HWB 1s do not lose roughly 50% of the power of the wind due to rotor blades necessary diagonal angle into the wind, and then additionally lose roughly 50% more power of the wind due to rotor blades having to rotate perpendicular to the wind (90-degrees off the wind), which is at an angle, roughly 45-degrees different than the directional force the wind pushes the rotor blades (roughly 135-degrees off the wind), and due to HWB 1s not suffering from these 2 loss factors, it is the inventor's belief that power production of roughly 50-Fold more power than conventional industrial HAWTs using rotor blades in similar wind paths but wherever the increased power shakes out, the power increase is massive ending the fossil fuel age and HWB 1s require basic mechanical apparatus and structure of WTOP (Wind Turbine Operating Parts), and WTOP is fully described at the beginning of Detailed Descriptions of Invention section and included here without limitation and first; the novelty of HWB 1s contrasted to a typical industrial HAWT which are more 2-dimensional in nature where the rotor blades swing through a large area that has height and width but less depth, and this depth (direction running with the wind), HWB 1s use more depth and work as follows; sail(s) are moved and/or positioned in any way so the sail is oriented so only the sail(s)' thin edge is facing the wind and this upwind sail edge is moved by any mechanical means likely either to the right or left or up or down but in between movements are possible depending on the chosen sail orientation and the sail then is allowed and/or aided in pivoting 90 degrees so its large sail face is now catching the wind and then the sail(s) are made to track a distance downwind with energy being harvested from the sail and then the forward sail edge is stopped and/or slowed, and the sail pivots and/or is moved in anyway so the sails orientation is changed 90 degrees so now only the sail's thin edge again faces the wind thereby maximally minimizing wind resistance and the sail(s) by any mechanical means is moved upwind and the process repeats utilizing smart controls without limitation and the use of energy for upwind movement and assisting in pivoting etc. is expected since net energy produced is the objective and the platform and/or track also needs to rotate to orient to face the wind and the sail(s) track(s) may have side(s), and/or bottom and/or top and/or any (fixed and/or adjustable structures), and may have front and/or back that can be closed and/or opened and the use of multiple sails would allow for a sail to more often be catching wind and HWB 1s could share platforms and/or sides and/or constructed in any way, and another example of a HWB 1, is that a sail with louvres that can be thought of as (segments of sail) and/or (a segmented sail) can be closed to catch wind, and the sail(s) is sailed downwind from its upwind position while energy is harvested and when the sail finishes its downwind movement, the louvres are opened and the sail is mechanically with the use of energy moved back upwind with the process repeating and this same approach but using 2 louvered sails has the advantage of providing continuous or near continuous energy production and to explain how to accomplish this, have 2 sails in the same wind path with one sail's downwind wind path area of operation in front of the other sail's area of downwind wind path, the sail that is upwind of the other sail is called sail #1 and the other sail, that is downwind of the sail #1 is called sail #2, and the louvres on sail #1 are closed and the sail #1 travels downwind having energy harvested and then its louvres are opened so wind may pass through itself as it approaches sail #2 at the end of sail #1's downwind travel on its portion of the wind track and then, Sail #2 with its louvres closed heads downwind on its portion of the downwind track from wind blowing through sail #1 while having energy harvested until the end of its wind path track but at the same time that sail #2 is travelling downwind while having energy harvested, Sail #1 with its louvres open was mechanically moved to its upwind position using energy and then, Sail #1, now closes it louvres and heads downwind while at the same time sail #2's louvres are opened and it is mechanically taken upwind using energy, so then sail #2 will be in its upwind position to have its louvres closed and start its downwind travel again at the same time that sail #1 has finished going downwind and then sail #1 is ready to open its louvres and head back upwind and the process repeats and repeats and one sail is almost always catching wind, and as a way to further clarify, the 2 sails repeatedly would travel to be close together and then travel to be apart and so on and so on and in Appendix A, there is a link to two very similar animations, titled Platform FoE and Platform Short and these same animations can also be found on the website, HenryWindBuster.com. and another example of how this would work with 2 sails is that each sail could fully track upwind and downwind in the same wind path area but with one segmented sail with its segments closed but with sufficient space between its segments to allow the other open segmented sail to pass through its segments thus allowing each sail to travel the full distance upwind and downwind of the entire depth of the wind path track and it should be said that generally speaking that louvered sails being opened and/or closed are the same generally as sails themselves being pivoted and/or rotated to accomplish the same general sail orientation in order to have sails catching wind and/or minimizing wind resistance and partial states of being opened and/or being closed which are the same condition can have many important functions for all HWBs and sail #1 and sail #2 do not need to be identical in size which could have important benefits and louvered sails can be designed in any way, with and without a frame surrounding the segments and/or with a partial frame around the segments but how segments are held is important to how the sail(s) act and/or for how sails interact in every way and/or on every level, so, all types of designs are included without limitation; and generally since the power of these designs are massive, the following are just routine items that should be given extra consideration to enhance operation to include that wind can be deflected or funneled to downwind sail(s) and/or may come from any part of another wind turbine and wind shields and/or wind blocks on the upwind side alone or in combination with any other means can be used to eliminate wind resistance to sail(s) on their upwind travel and wind blocks and wind shield can be used to protect any portion of the wind turbine and sail(s) and wind shields and/or wind blocks could be from other sails and/or from other wind turbines and associated structures and wind turbines can be made to share wind path and the animation, and generally the following are some added considerations that should always be considered for all wind turbines such as that they be built reversible, and heat from any part of the structure and/or workings should be considered for use if beneficial, and due to the massive power consideration should be given to stacking the turbines on top of each other, and they can be built tiny to enormous, and sail(s) can be of any nature covered in WTOP without limitation, and sail(s) can be built as louvre(s), like a louvered door or window (louvre is to include any mechanism, approach, and/or means to stop wind by sail(s) and/or then allow wind to pass through the sail(s)) and/or the sail(s)' louvres could be adjustable as to how open or closed they are and instead of pivoting the sails, and opening and closing of the louvres causes the same effect, just with the sails being in smaller louvered sail segments and a sail could be segmented and effectively able to act as a louvre but arguably not what looks like what is thought of as a louvre and for purposes of this patent no distinction should be made, and sail segments can by any means be positioned to spill wind and/or deflect wind in any direction and/or have the segments adjustable to allow wind to pass through itself while being deflected and/or not and/or partially deflected and sail segments can be treated differently over any part or parts of sail(s) so as to create any wind effect such as but not limited to operating in high wind and/or surviving high wind, and the use of flaps on sails located anywhere and of any nature, shape, and size without limitation should be used to assist in every aspect of wind use, and due to the massively higher efficiencies extra consideration should be given to use of these Wind Sail Turbines in many more situations from possibly being located on any type moving device/vehicle and/or craft of any nature down to be located on tiny drones or even tinier uses and made to also be gargantuan, simply due to massive increases of efficiency the use of these turbines is expected to be used in many new ways and uses that would create energy when on anything moving that is creating its own resistance that manifests as wind and for any reason is not be avoided may benefit from the use of these turbines, and the use of smart controls is of critical value and the expectation along with everything mentioned is that these turbines will work in water flows and that is full expected and included but has not been tested but there is no reason not to expect excellent operation in all types of water (fluid) flows and everything here is included without exception and/or limitation.

6: Novel sail(s) movements of claim 4, wherein Henry Wind Buster 2s (HWB 2s) (their use and the use of the word, wind, include the use in any gas flow and/or any fluid (water etc.) flow and/or and any flow of a solid and/or semi-solid and/or any combination of the flows and/or as defined in the Background Section without exception or limitation) are novel designs of novel Wind Sail Turbines that use novel sail(s) movements of claim 3 and operate with and against the wind but before discussing their novelty operation, HWB 2s need to have mechanical apparatuses and structures, called Wind Turbine Operating Parts (WTOP), and WTOP has been defined at the beginning of Detailed Descriptions of Invention section and is included here without limitation and the novelty of HWB 2s, which shares similarities with a Savonius wind turbine that works with and against the wind but HWB 2s using novel movement of sails and/or smart controls massively amplifies the difference of the sail that is catching wind on a Savonius and the same sail design but the other side of the sail is used to pierce the wind, it is just with a Savonius it is a stretch to even say piercing the wind, it might be better described than piercing to say less effectively catching wind and with smart controls and novel sail movement the net power of a HWB 2s are far greater than a Savonius and Savonius designs have had limited use because conventional HAWTs are believed more powerful and Savonius designs were mostly used for situations where very low maintenance was needed like on a buoy at sea and/or where the high speed rotations of the designs were especially helpful with tasks such as pumping water and HWB 2s which can be made to be vertical axis or horizontal axis wind turbines and as (VAWT), the tower does not need to rotate to orient the sails to the wind and the sails can rotate either direction around the axis by simply how the sails are started and an example would be to have one sail have its sail face perpendicular to the ground off an arm from the axis and with one of sail's thin edges most upwind, pointing its thin edge directly into the wind and then, the sail is moved right or left and the sail will catch wind and move downwind and a sail on the opposite side of the axis from this sail has had its sail face positioned to be parallel to the ground to allow it to come upwind while causing minimal wind resistance and after 180-degrees of rotation around the axis, both sails themselves are rotated and/or pivoted by any mechanical means using energy and using smart controls to be positioned like the sail opposite itself had been positioned prior to the simultaneous rotation of both sails themselves and this process repeats after every 180-degree rotation around the axis and in this example half the wind path area is used bringing the sail upwind, so, it is novel for another wind turbine to use the same area for a sail coming downwind and to accomplish this sails for example could have (sideways elongated U shapes) on the sail(s) to allow another sail to pass through itself and/or the sails could be built in segments so one sail could pass through another and this type of novel approach avoids wasted wind path and sails could if 2 sails were coming upwind share space by being oriented in different planes and this is shown in the animation “First Design” and if 4 rows of sail, 90 degrees apart around the axis were used as a different example, each row of sails could have it sails rotated such that each row of sail (a sail can or cannot be segmented into what could be called 1 sail or segments of 1 sail) would catch wind for roughly 90 degrees of downwind travel, that 90 degrees could start roughly after roughly 45 degrees in a sail row's downwind travel and the sail itself would rotate/pivot 90 degrees after roughly completing 135 degrees of downwind travel to no longer catch wind and to make this work only 1 row of the 4 rows of sail is positioned to catch wind while the other 3 rows have their sail(s) positioned (oriented) to minimize wind resistance and this has 3 rows not catching wind at any point versus 1 sail row in the 2-sail row example, but in this example the sail row catching wind is catching fuller wind during its 90-degree rotation downwind while catching wind than the 1 sail row in the 2 sail row example during its roughly 180 degrees of downwind travel while catching wind and sails during their downwind travel around the axis could have their large sail faces adjusted to be more close to perpendicular and/or perpendicular to the wind to optimize wind energy capture and instead of sail of any number of segments being rotated, the sail could be louvered with louvres closed to utilize wind energy downwind and opened when they are moving and the opening of the louvres which can be seen as segmented sails with their segments being easily rotated as what is referred to as opening and closing louvres and downwind sails and upwind sails can be made to operate on just one side of a turbine and this would allow fuller use of the wind path because this provides the ability to utilize both sides of a single wind turbine with sails travelling downwind and upwind on both sides of the axis and this is shown in the animation, “Future of Electricity”, and an example of how this works is that the rows of sails would have segmented sails and when you stopped the downwind path of a row of sails you would rotate the sails in the row so when brought upwind they could pass through the segmented sail heading downwind on the same side of the wind turbine and another configuration would be for a sail at roughly the end of its 180-degree downwind travel around the axis when the sail is approximately at its furthest downwind position, the sail could be disengaged from rotating around the axis and without rotating the sail 90-degrees, move the sail by mechanical means straight upwind (keeping it with its small edge into the wind) except for any needed minor positioning to avoid the tower and when the sail is fully back upwind, the sail is at the proper time reengaged to the low speed axis and then allowed to downwind and this is like a HWB 1 but using a rotating wind sail turbine and this process avoids the need to rotate the sail 90-degrees and/or use louvered sail(s) that open and close and this method of upwind sail movement will allow wind turbines operating this way to share wind path and these examples are only partial examples since any number of rows are included in this claim and these same design examples work if the axis is made horizontal, what were VAWTs are now HAWTs, and these same designs as HAWTs require the tower to turn the horizontal axis (low speed shaft) to keep it perpendicular to the wind and for example, use 2 sails oriented 90 degrees differently from each other on opposite sides of the axis and to make visualizing this easier view the animation, “Video 5_Pit Final” which shows the operation of this design of wind turbines as HAWTs and when starting the upwind sail, the upwind sail can be made to rotate up and downwind or down and downwind and the sail in its furthest upwind position has its large sail face parallel to the ground, the sail may need to rotate up and downwind to avoid striking the tower but the wind turbine can be built to leave room for the sails to rotate either direction and after an approximately rotating 180-degrees around the axis, the sails themselves are rotated 90 degrees so the sail going downwind is always positioned to catch wind and the sail going upwind is positioned to minimize wind resistance and this rotation of the sail itself repeats after every 180-degree rotation around the axis and this design can have the sail heading upwind being underground, saving on above ground space, wind path, and visual interference and this underground operation is also shown in the animation “Video 5_Pit Final” and being partly below the ground could also be applied to being partly below water but this would require structures in the water to create air space in and/or beneath the water for sail rotation upwind around the axis and/or for the rotation of the sail itself but designed this way saves space above water and/or above ground and would have less visual impact and sails can be segmented and there can be any number of sail (segmented sails) rows and this adds complexity but could add power and assume for example, 4 rows of sail(s), each row of sails in this example would only be used to catch wind for roughly 90 degrees of rotation around the axis, that 90 degrees would start roughly after 45 degrees into a sail row's downwind rotation and then the sail itself is rotated after roughly 135 degrees of travel downwind to be positioned to minimize wind resistance, so, in this example using 4 rows only 1 row is positioned to catch wind while the other 3 rows have their sail(s) rotated to minimize wind resistance, so, this has 3 rows not catching wind at any point versus 1 sail row in the 2-sail row example, but the sail row catching wind is catching fuller wind during its 90-degree rotation around the axis than the sail in a 2-sail design during its roughly 180 degrees of downwind travel and sails during their downwind travel around the axis could be made to have their large sail faces be adjusted to be more perpendicular to the wind to the point that optimizes wind energy capture and alternatively, sails could be louvered with louvres closed downwind and opened upwind and louvers are segmented sails with their segments being rotated and the downwind sails and upwind sails can be made to operate on one side of a wind turbine and this would allow for fuller use of the wind path with the ability to use both sides of a wind turbine for downwind energy producing sail use and the necessary upwind travel of the sail(s) and in this type of case the rows of sails would have segmented sails and when you stopped the downwind path of a row of sails you would rotate the sails in a row so when the row of sails was brought upwind the row of sails could pass through the segmented sail heading downwind and this is clearly showed in the animation, “Future of Electricity” except that animation is of a VAWT and we are now talking about a HAWT so a little self-visualization is needed and with this design used as a HAWT and/or a VAWT; and generally since the power of these designs are considerable wind can be deflected or funneled to downwind sail(s) and/or may come from any part of another wind turbine and wind shields and/or wind blocks on the upwind side alone or in combination with any other means can be used to eliminate wind resistance to sail(s) on their upwind travel and wind blocks and wind shield can be used to protect any portion of the wind turbine and sail(s) and wind shields and/or wind blocks could be from other sails and/or from other wind turbines and associated structures and wind turbines can be made to share wind path and the animation, and generally the following are some added considerations that should always be considered for all wind turbines such as that they be built reversible, and heat from any part of the structure and/or workings should be considered for use if beneficial, and due to the massive power consideration should be given to stacking the turbines on top of each other, and they can be built tiny to enormous, and sail(s) can be of any nature covered in WTOP without limitation, and sail(s) can be built as louvre(s), like a louvered door or window (louvre is to include any mechanism, approach, and/or means to stop wind by sail(s) and/or then allow wind to pass through the sail(s)) and/or the sail(s)' louvres could be adjustable as to how open or closed they are and instead of pivoting the sails, and opening and closing of the louvres causes the same effect, just with the sails being in smaller louvered sail segments and a sail could be segmented and effectively able to act as a louvre but arguably not what looks like what is thought of as a louvre and for purposes of this patent no distinction should be made, and sail segments can by any means be positioned to spill wind and/or deflect wind in any direction and/or have the segments adjustable to allow wind to pass through itself while being deflected and/or not and/or partially deflected and sail segments can be treated differently over any part or parts of sail(s) so as to create any wind effect such as but not limited to operating in high wind and/or surviving high wind, and the use of flaps on sails located anywhere and of any nature, shape, and size without limitation should be used to assist in every aspect of wind use, and due to the massively higher efficiencies extra consideration should be given to use of these Wind Sail Turbines in many more situations from possibly being located on any type moving device/vehicle and/or craft of any nature down to be located on tiny drones or even tinier uses and made to also be gargantuan, simply due to massive increases of efficiency the use of these turbines is expected to be used in many new ways and uses that would create energy when on anything moving that is creating its own resistance that manifests as wind and for any reason is not be avoided may benefit from the use of these turbines, and the use of smart controls is of critical value and the expectation along with everything mentioned is that these turbines will work in water flows and that is full expected and included but has not been tested but there is no reason not to expect excellent operation in all types of water (fluid) flows and everything here is included without exception and/or limitation.

7- claim 7 is an independent claim for Henry Water Propulsion Systems (their use and the use of the word, water, include the use in any gas and/or gas flow and/or any fluid (water etc.) and fluid (water etc.) flow and/or any solid and/or any semi-solid and/or any flow of a solid and/or flow of a semi-solid and/or any combination of matters and/or the flow of matters and/or as defined in the Background Section without exception or limitation) generally to operate would have plate(s) attached to a shaft (rod etc.) that likely passes through most often the rear hull (it does not have to pass through the hull, it could be above the hull and/or be attached through a transom area (the area where outboard boat motors are often attached) of a ship (boat and/or any moving craft of any nature and of any design) and then attach through any mechanical means to the engine, so, the engine can thrust the shaft (rod etc.) back and forth and there may be any number of these set ups located on the ship etc., and the plate(s) use the large face of the plate(s) that can be of any size and of any shape and of any nature to thrust water and/or any fluid and/or any solid and/or any gas and/or any combination of the aforementioned without limitation providing thrust and the plate(s) would then be moved to a pre-thrust location after being positioned to reduce resistance, with one example being that as the plates are moved to the pre-thrust position using plate(s) folding on a hinge and/or in any way and/or otherwise to position the plate(s) in any way without limitation so their thin side(s) are resisting the movement to minimize resistance and then the plate(s) are repeatedly thrusted to provide continuous thrust and returned to the pre-thrust position, being positioned to minimize resistance and the plate(s) could be shaped to naturally open as thrusted and/or be assisted in the opening and positioning of the plate(s) by any means to be positioned to thrust and/or for the plate(s) to be positioned to reduce resistance as being moved to the pre-thrust position is included without limitation and the movement of plate(s) to pre-thrust position could be done above the water and/or partly above the water to further reduce resistance and the plate(s) can be made to thrust as pulled and/or pushed and/or for plate(s) operation to be reversible or not by design and there can be any number of these set up located anywhere on a ship etc. to pull and/or push to thrust and there are many design possibilities that are all included without exception and/or limitation and in support of the value of this invention, the inventor states that the inventor believes it is likely that efficiency calculations for propellers are overstated but the inventor has not checked into this belief but believes it likely since Albert Betz worked on propeller theory and Albert Betz may have used some of the same incorrect science that Albert Betz applied to wind turbine science.
Every aspect and part of this document is meant to apply where reasonable to apply to every other part of this document without exception or limitation. There may be lack of consistency in all numbers, this information can be looked at in many ways and using many examples and the inventor has used roughly to describe many numbers, percentages etc. but all numbers etc. are meant to convey a reasonable range for the purpose intended and any discrepancy of any numbers should be very broadly construed and not used to diminish the intent of the patent without exception or limitation. This patent is for all commercial, industrially, business, residential, and personal use of all inventions without limitation. If the New Wind Power Formula has any errors, claim is kept for its correct and surviving parts without exception or limitation. Although the inventions have been explained in relation to preferred embodiments, it is to be understood that many other possible modifications and variations can be made without departing from the spirit and scope of the inventions patented here without limitation. If anything ends or partially ends without saying without limitation, it is to be considered said where it strengthens the claims without limitation. The USPTO told the inventor that a Utility patent can be accomplished easily by the inventor and the inventor realizes that that is not binding but with that in mind the inventor asks the court to apply to this patent, any obvious language and/or legal techniques and/or avoidance of mistakes that a reasonable patent attorney would provide and the inventor hereby applies that language and/or legal techniques and/or avoidance of mistakes to this patent document without limitation with the greatest of hopes that the court will never allow a patent, that is capable of ending the fossil fuel age, filed reasonably with a better than good faith effort to become the object of “I got you” by an attorney of a competitor and/or infringer and/or would be infringer. There are undoubtedly many errors and the inventor asks that all errors be interpreted in context of this entire patent, all associated material, the intent and spirit of the inventor, all 9 provisional patents, and all information that the court deems reasonable and the inventor has set up a web-site where all information is dated as to when it is entered and presently there are links to 7 animation and a link to 1 video that were all produced well prior to the filing of this filing. In this web-site there will be a document taken from an email that will be sent either a few days before or within a few days and/or perhaps a week or two of this filing, that has had the science completed but awaits time to proof read the document, and that document will hopefully be an easier reading document that will give an excellent overview of the science surrounding this patent.
